(19) United States
(12) Patent Application Publication
(10) Pub. No.: US 2025/0274711 A1
(43) Pub. Date: Aug. 28, 2025

(54) COLLIDER SYSTEM FOR THE GENERATION AND REPRODUCTION OF SIGNALS FROM TRISONIC AUDIO WITH ZERO LATENCY

(71) Applicants: Gilberto Torres Ayala, Guadalajara (MX); Sonia Gladys Luque Vela, La Molina (PE)

(72) Inventors: Gilberto Torres Ayala, Guadalajara (MX); Sonia Gladys Luque Vela, La Molina (PE)

(21) Appl. No.: 18/589,757

(22) Filed: Feb. 28, 2024

(51) Int. Cl. H04R 5/02; H04R 5/033; H04R 9/02; H04R 9/06; H04S 3/00; H04S 3/02; H04S 5/02

(52) U.S. Cl. CPC H04R 5/02; H04R 5/033; H04R 9/025; H04R 9/06; H04S 3/004; H04S 3/02; H04S 5/02

(57) ABSTRACT

A system of colliders is based on magnetic and/or electrical collisions for the generation and reproduction of channels/signals of a trisonic audio from stereophonic audio or any pair of input audio signals, with zero latency. The system is configured to collide the panning point value information corresponding to the audio signals entering the system, where such collision generates a new pan point value information that corresponds to the new signal of a resulting trisonic audio. The system is configured to collaborate directly or indirectly with an audio playback system configured to emit, reproduce and/or transmit such signals from a trisonic audio, i.e., the system is configured so that such signals from a trisonic audio are immediately reproduced through a trisonic audio playback system. This process of generating and reproducing signals from a trisonic audio is carried out with zero latency.

### FIELD OF THE INVENTION

The present invention relates to audio systems, in particular, to a system of colliders based on magnetic collisions and/or electrical collisions for the generation and playback of channels or signals of a trisonic audio with zero latency; in particular, the system of the present invention can be used to convert stereophonic audio into trisonic audio without any latency, that is, without implying in any way a time delay when performing the conversion of said stereophonic audio into a trisonic audio, where such conversion and zero latency are due to the said colliders of the present invention. In addition, the collider system of the present invention is configured so that such trisonic audio is played in a trisonic audio playback system.

### BACKGROUND OF THE INVENTION

It is known that a collision, explained from physics, can refer to any event in which two or more bodies of matter or energy exert forces on each other in a relatively short time, it can also be considered as the collision between two moving bodies, which causes an interaction and a result derived from said interaction.

Therefore, a collider can be considered any means, mechanism, device or system capable of colliding two or more bodies of matter or energy with the aim of finding or generating a specific result.

Due to the above, a magnetic collision can be considered any event in which two or more magnetic fields collide or collide with each other intentionally to obtain an expected result.

In an exemplary way, we can observe a magnetic collision in the operation of an electric motor, where this magnetic collision generates forces of attraction or repulsion to cause a certain movement.

It is important to understand that the magnetic collisions of the present invention, unlike what has been described above, cause an interaction of information to obtain a specific result.

On the other hand, an electrical collision can be considered any event in which two or more electric currents collide or collide with each other intentionally to obtain an expected result.

In an exemplary way, we can observe an electrical collision in the operation of the hadron collider, where this electrical collision causes the separation of subparticles to observe for moments the composition of subatomic elements.

It is important to understand that the electrical collisions of the present invention, unlike what has been described above, cause an interaction of information to obtain a specific result.

It is known that the processing of an audio or, in general, any sound or set of sounds involves the processing of it by electronic means, generally with the help of electronic processors; Likewise, a person with ordinary knowledge in the field will know that the aforementioned processing with the help of electronic processors implies that there will be a time difference between the moment a signal is introduced into the processing medium and the moment when said audio appears in the output, already with a certain alteration; This time difference is commonly referred to as latency.

This time difference or delay in the output signal can have several effects that are generally undesirable for both a producer or audio engineer, as well as a user or target audience. A very common case is the audio broadcast in a live event where any audio signal is generated in real time, such as in live concerts, plays, television broadcasts, audio or similar live broadcasts, among others. In these exemplary cases, the audio or audio signal is not recorded or pre-recorded and each sound is generated in real time. Latency in these cases represents an even more relevant technical problem, since the existence of latency causes a user or target audience to perceive the processed signal with a significant lag with respect to what they are observing, even being uncomfortable for the artist or performer himself.

In order to solve the latency problem mentioned above, different technologies have been described that, by means of digital processors and, mainly, by means of a combination of digital signals, have tried to carry out the treatment of audio signals, seeking to reduce the time difference between the input of the audio to be processed and the output of the same already processed.

Such is the case of U.S. Pat. No. 10,524,300 B2, published on Jun. 6, 2019, which describes a system where a first audio device exchanges control signals with a source device and, as a result, receives initial audio signals from said source device. A second audio device exchanges control signals with the first audio device, including information necessary to receive the initial audio signals from the source device. The control signals of the first device include communications via Bluetooth BR/EDR protocols, thereby establishing a first Bluetooth link for transmitting audio from the source device to the first audio device. The control signals of the second device include communications via Bluetooth Low Energy (BLE) protocols and transfer parameters of the first Bluetooth link to the second device, allowing it to receive and decode an audio stream transmitted from the source device to the first audio device through the first Bluetooth link. However, a person skilled in the field to which the invention belongs will know that the use of Bluetooth communication is a type of digital communication that involves the transmission of an input signal that must be processed and encoded to comply with the Bluetooth communication protocol, which inherently introduces a delay, thus the output audio signal will further exhibit a noticeable delay (also referred to as latency in the field to which said invention belongs) compared to the input signal. This will be clear to a person of ordinary skill in the art since digital processing-resulting from the use of Bluetooth communication technology-implies that a certain fraction of time is consumed once the input signal begins to be processed, persisting, as stated in US patent '300 itself, a latency between the input and output signals.

Although the well known state of the art technologies have made an effort to try to reduce latency and its unwanted effects, there is still a need for systems that simply do not cause a sound delay derived from the processing of the sound signals, thus achieving that the sound or output signal can be considered with zero latency and therefore, can be transmitted in real time, ensuring a high-quality experience for the user or target audience, mainly in events where the input signal is generated instantly.

This application represents the first invention of its kind in achieving the incorporation of an analog technology based on magnetic and/or electrical collisions that by its very analog nature allows the instantaneous transformation of the audio signals it receives into output signals, thus eliminating any delay derived from the processing and transformation of input audio signals, achieving zero latency.

### SUMMARY OF THE INVENTION

It is therefore an objective of the present invention to provide a system of colliders based mainly on magnetic collisions and/or electrical collisions for the generation and playback of channels or signals of trisonic audio with zero latency from stereophonic audio, where, particularly or mainly, the stereophonic audio is signals generated in real time and/or previously recorded signals, so that such trisonic audio is reproduced in a trisonic audio playback system.

Also, one of the objectives of the present invention is to provide a system of colliders capable of carrying out the generation of a trisonic audio based on stereophonic audio, so that such trisonic audio is reproduced in a trisonic audio playback system, where the generation and reproduction process is carried out with zero latency.

In the context of this application, “latency” should be understood as a time delay that is generated due to digital signal processing (DSP); A person with ordinary knowledge in the field will know that latency is a time lapse between the input signal and the output of that signal, since it takes a certain amount of time to process and provide the signal with desired characteristics.

Generally, this signal processing is usually measured in milliseconds (ms) and is carried out by technicians and/or sound engineers with the help of computing means and/or in general, processing means.

When latency is high (more than 20 ms), it can be a major technical problem, both for sound technicians/engineers as well as performers, and can even be very disconcerting since the perception given by the delay derived from signal processing could interpret which instrument (or the medium that generates the sound, in general) “does not respond” adequately in accordance with its execution.

On the other hand, a low latency (less than 5 ms) is usually not noticeable, however, there are still situations where it can cause undesirable performance for a user or target audience.

Thus, the present invention aims to provide a system of colliders that by means of magnetic or electrical collisions carries out the processing to convert stereophonic audio into trisonic audio, where such processing is carried out with latency zero or zero latency. In this sense, by “latency zero” or “zero latency” it must be understood that the processing of the signal is carried out instantaneously, and therefore, the output signal (or signal already processed) has a time delay with respect to the input signal close to zero milliseconds (ms) or even, having a time delay of zero milliseconds (ms) thus eliminating any presence of latency.

In the context of this application, “sound” should be understood as a phenomenon involving the mechanical propagation of sound waves through air or other elements, where such waves have their own characteristics of frequency, intensity, and timbre.

By “acoustic effect” it should be understood as the final result perceived by the listener in the physical space, also known as acoustic space, that is, the “acoustic effect” is the final result in which “n” number of sounds are appreciated with their characteristics of spatiality, direction, depth, location, among others, where said “acoustic effect” is different for each type of audio.

By “audio” it should be understood as one or “n” number of sounds that are perceived or heard in a physical space, where these sounds have in common the characteristics of an acoustic effect.

Therefore, in the context of the present invention, “stereophonic audio” should be understood as the linear panning acoustic effect produced by two channels or audio signals (commonly known as the left signal (L or LEFT) and right signal (R or RIGHT). However, a person skilled in the art will understand that the term “stereophonic” applies to or refers, in any of the modalities described throughout this application, to any audio comprising at least one pair and up to “n” number of channel or signal pairs; as a non-limiting example, such audio can be any selected from the group that comprises 5.1-channel, 7.1-channel, 9.1-channel audio, among others; therefore, in the context of this invention, “stereophonic audio” should also be understood as any pair of channels or audio signals of type L and R that are part of any type of multichannel audio.

In the context of the present invention “Trisonic audio” is to be understood as the acoustic effect of spatial panning produced by three channels or audio signals (in this description, characterized as signal X, signal Y, and signal Z).

In addition, in the context of the present invention, “processing of stereophonic audio into trisonic audio” is to be understood as the processing medium being configured to perform a fusion of panning values, thereby generating new panning points, where such processing medium uses colliders capable of magnetic collisions or electrical collisions.

A main objective of the present invention is to provide a system of colliders for the generation of a trisonic audio from a stereophonic audio, being said stereophonic audio generated in real time or previously recorded, solving the still existing problem that the processed signal is also transmitted, emitted or reproduced in real time derived from the absence of latency; in addition, by “real time” it should be understood that the signals resulting X, Y, Z from a trisonic audio are generated immediately as soon as the generator of the signals L and R of a stereophonic audio produces them; Non-limiting examples of real-time generated audio signals are commonly observed in concerts, plays, live television, among others.

Another objective of the present invention is to provide a system of colliders for the generation of a trisonic audio from a stereophonic audio, and that, in particular, such a system can perform the processing of the signals and reduce and even eliminate any presence of latency by means of a magnetic collision system.

As will become clearer on the basis of the teachings described later in this application, the magnetic collision system is configured to receive the L and R signals from stereophonic audio at the input, convert those signals into a plurality of magnetic fields, and generate a magnetic field resulting from the collision of such a plurality of magnetic fields.

Without being limited to theory, and as will become clearer later, the input signals converted into a plurality of magnetic fields collide, therefore, when these magnetic fields collide they give rise to a resulting magnetic field, which will correspond precisely to one of the three output audio signals that make up a trisonic audio.

An additional objective of the present invention is to provide a system of colliders for the generation of a trisonic audio from stereophonic audio, and that, in particular, such a system can perform signal processing and reduce and even eliminate any presence of latency by means of an electrical collision system.

As will become clearer on the basis of the lessons described later in this application, the electrical collision system is configured to receive the L and R signals of a stereophonic audio from the input, converting these signals into a plurality of electric currents; Thus, the different electric currents collide with each other (since they will be in the same circuit), causing a controlled short circuit and in turn, generating a third electric current resulting from said controlled short circuit.

Without being limited to theory, and as will become clearer later, by causing a controlled short circuit using the audio signals transformed into electric currents, they give rise to a resulting electric current, which will correspond precisely to one of the three output audio signals that make up a trisonic audio.

In the context of the present invention, “transmitted, emitted or reproduced” is to be understood as the collider system of the present invention being configured to process the signals L and R of stereophonic audio and, once transformed and characterized as the X, Y, Z signals of a trisonic audio, these are transmitted by a specialized audio playback system for signals of a trisonic audio, allowing a user or target audience to perceive the already processed audio in real time.

### BRIEF DESCRIPTION OF THE DRAWINGS

FIG. 1 is a schematic view of the operation of a first generating coil and a second generating coil, configured to generate a first and second magnetic field respectively according to a modality of the present invention;

FIG. 2 is a schematic view, showing the magnetic collision between the first and second magnetic fields in FIG. 1;

FIG. 3 shows a schematic view, illustrating the magnetic collision between the first and second magnetic fields in FIG. 2, where said collision generates a resulting third magnetic field.

FIG. 4 is a schematic view showing a receiver coil configured to pick up the third magnetic field resulting from FIG. 3;

FIG. 5 illustrates a schematic view of a coil subsystem or set of coils, arranged on a core;

FIG. 6 shows a schematic view where the coil subsystems or coil assemblies of the magnetic collision system are arranged monolithically forming a delta, according to a modality of the present invention;

FIG. 7 is a schematic view of the processing subsystem and its interaction with three coil subsystems (coil assemblies or colliders) of the magnetic collision system, according to a modality of the present invention;

FIG. 8 is a schematic view of the processing subsystem and its interaction with six coil subsystems (coil assemblies or colliders) of the magnetic collision system, according to a modality of the present invention;

FIG. 9 is a schematic view of the operation of a first generating coil, configured to capture a first magnetic field and convert that field into a first electric current, according to an additional modality of the present invention;

FIG. 10 is a schematic view of the operation of a second generating coil, configured to pick up a second magnetic field and convert that field into a second electric current, according to an additional modality of the present invention;

FIG. 11 illustrates a schematic view, showing the electrical collision between the first and second electric currents generated in FIGS. 9 and 10, by the first and second generating coils respectively, where such collision occurs in the crashing coil, according to an additional modality of the present invention;

FIG. 12 shows a schematic view, where the electrical collision between the first and second electric currents occurring in the crashing coil causes a controlled short circuit, generating a third electric current, and where the crashing coil is configured to convert the third electric current into a resulting magnetic field, according to an additional modality of the present invention;

FIG. 13 shows a schematic view where the coil subsystems or coil assemblies of the electric collision system are arranged monolithically in a delta pattern, according to an additional modality of the present invention;

FIG. 14 is a schematic view of the processing subsystem and its interaction with three coil subsystems (coil assemblies or colliders) of the electric collision system, according to an additional modality of the present invention;

FIG. 15 is a schematic view of the processing subsystem and its interaction with six coil subsystems (coil assemblies or colliders) of the electrical collision system, according to an additional modality of the present invention;

FIG. 16 shows a schematic view of the placement of 3 mono audio playback systems in the acoustic space and in relation to the listener, according to the triangular reproduction system modality of the present invention;

FIG. 17 shows a formula for modifying the distance of the mono-front audio playback system from the listener, according to the triangular playback system modality of the present invention;

FIG. 18 shows a schematic view of the appreciation of the 5 main panning points A, D, C, E, B in the acoustic space formed by the placement of the 3 mono audio playback systems, according to the triangular playback system modality of the present invention;

FIG. 19a shows a schematic view of the X2, Y2, Z2 audio signals emitted by their corresponding mono audio playback systems, according to the triangular playback system modality of the present invention;

FIG. 19b shows a schematic view of the interaction in acoustic space between the X2, Y2, Z2 audio signals emitted by their corresponding mono audio playback systems to achieve an acoustic result, according to the triangular playback system modality of the present invention;

FIG. 20a shows a schematic view of the X3, Y3, Z3 audio signals emitted by their corresponding mono audio playback systems, according to the triangular playback system modality of the present invention;

FIG. 20b shows a schematic view of the interaction in acoustic space between the X3, Y3, Z3 audio signals emitted by their corresponding mono audio playback systems to achieve another acoustic result, according to the triangular playback system modality of the present invention;

FIG. 21 shows a schematic view of the placement of 4 mono audio playback systems in the acoustic space and in relation to the listener, according to the dynamic playback system modality of the present invention;

FIG. 22 shows a schematic view of the appreciation of the 5 main panning points A, D, C, E, B in the acoustic space formed by the placement of the 4 mono audio playback systems, according to the dynamic playback system modality of the present invention;

FIG. 23 shows a schematic view of the interaction in acoustic space between the X2, Y2, Z2 audio signals emitted correspondingly by the four mono audio playback systems to obtain an acoustic result, according to the dynamic playback system modality of the present invention;

FIG. 24 shows a schematic view of the acoustic result perceived by the listener due to the interaction shown in FIG. 23, according to the modality of the dynamic playback system of the present invention;

FIG. 25 shows a schematic view of the interaction in acoustic space between the X3, Y3, Z3 audio signals emitted correspondingly by the four mono audio playback systems to obtain another acoustic result, according to the dynamic playback system modality of the present invention;

FIG. 26 shows a schematic view of the acoustic result perceived by the listener due to the interaction shown in FIG. 25, according to the modality of the dynamic playback system of the present invention;

FIG. 27 shows a schematic view of the placement of 4 mono audio playback systems in the acoustic space and in relation to the listener, according to the modality of the quadraphonic playback system of the present invention;

FIG. 28 shows a schematic view of the appreciation of the 5 main panning points A, D, C, E, B in the acoustic space formed by the placement of the 4 mono audio playback systems, according to the modality of the quadraphonic playback system of the present invention;

FIG. 29 shows a schematic view of the interaction in acoustic space between the X2, Y2, Z2 audio signals emitted correspondingly by the four mono audio playback systems to obtain an acoustic result, according to the quadraphonic playback system modality of the present invention;

FIG. 30 shows a schematic view of the acoustic result perceived by the listener due to the interaction shown in FIG. 29, according to the modality of the quadraphonic playback system of the present invention;

FIG. 31 shows a schematic view of the interaction in acoustic space between the X3, Y3, Z3 audio signals emitted correspondingly by the four mono audio playback systems to obtain another acoustic result, according to the quadraphonic playback system modality of the present invention;

FIG. 32 shows a schematic view of the acoustic result perceived by the listener due to the interaction shown in FIG. 31, according to the modality of the quadraphonic playback system of the present invention;

FIG. 33 shows a schematic view of 2 over-ear headphones and 4 auricular mono systems arranged within the said pair of over-ear headphones or auriculars, according to the modality of the auricular playback system of the present invention;

FIG. 34 shows a schematic view of the appreciation of the 5 main panning points A, D, C, E, B in the simulation of the acoustic space created by means of the said two auriculars, according to the modality of the auricular playback system of the present invention;

FIG. 35 shows a schematic view of the interaction inside the said two auriculars between the X2, Y2, Z2 audio signals emitted correspondingly by the four auricular mono systems to obtain a result in the simulation of the acoustic space, according to the modality of the auricular playback system of the present invention;

FIG. 36 shows a schematic view of the result perceived by the listener in the simulation of the acoustic space due to the interaction shown in FIG. 35, according to the modality of the auricular playback system of the present invention;

FIG. 37 shows a schematic view of the interaction inside the said two auriculars between the X3, Y3, Z3 audio signals emitted correspondingly by the four auricular mono systems to obtain another result in the simulation of the acoustic space, according to the modality of the auricular playback system of the present invention;

FIG. 38 shows a schematic view of the result perceived by the listener in the simulation of the acoustic space due to the interaction shown in FIG. 37, according to the modality of the auricular reproduction system of the present invention;

FIG. 39 shows a schematic view of the placement of 6 mono audio playback systems in the acoustic space and in relation to the listener, according to the modality of the vector playback system of the present invention;

FIG. 40 shows a more detailed schematic view of the same placement of the said 6 mono audio playback systems in the acoustic space and in relation to the listener, according to the vectorial playback system modality of the present invention;

FIG. 41 shows an exemplary schematic view of the acoustic result and effect caused by the placement of the said 6 mono audio playback systems in the acoustic space and in relation to the listener, according to the modality of the vector playback system of the present invention;

FIG. 42A is a schematic view showing the procedure used to check the generation of a zero-latency trisonic audio signal when using the magnetic collision system of the present invention;

FIG. 42B is a schematic view showing the procedure used to check the generation of a zero-latency trisonic audio signal when using the electrical collision system of the present invention;

FIG. 43A is a schematic view showing the initial detection point of the audio input that was injected directly (without the use of the collision system of the present invention);

FIG. 43B is a schematic view showing the initial detection point of the audio input that was injected into the magnetic collision system of the present invention; and

FIG. 43C is a schematic view showing the initial detection point of the audio input that was injected into the electrical collision system of the present invention;

### DETAILED DESCRIPTION OF THE INVENTION

The essence of the innovation described in this application lies in a disruptive technology for the transformation and generation of information, which is characterized by its ability to achieve latency-free interaction and data processing.

Contrary to conventional methods that rely on the superimposition of signals, the present invention introduces a unique and totally novel way to achieve such transformation and generation of electrical signals containing data of an unlimited nature, based on the use of a collision system.

This system, which will be described in detail later in this application, allows the controlled collision of signals containing data, generating a resulting signal that contains its own information and is dependent on the information present in the initial signals, achieving the previously referred to without any delay; More specifically, when one compares the input time at which the incoming signals are injected into the system according to the present invention with respect to the resulting signal, it is clearly observed that there is no delay or difference in the input and output times.

It is crucial to note that the specific application of collision for the transformation and generation of information proposed by the present invention is unparalleled in the prior art. Unlike traditional methods that focus on the superposition of electromagnetic phenomena, the current literature has in no way addressed the use of a magnetic and/or electrical collision to merge, transform and generate new information from one or more primary information sources, without any latency. This absence of precedents in the state of the art underlines the uniqueness and transcendence of the present invention, denoting it as the first of its kind in describing a method and a device to merge, transform and generate resulting information from any source of information, in a disruptive and novel way; And what's more, without any latency.

In this context, it is necessary to recognize that the known state of the art certainly contains applications for the use of magnetic and/or electrical forces, but all of them aimed at exploring traditional applications such as the impartation of electromotive forces or the transfer of energy. The absence of focus on the transformation and generation of information further underscores the gap that the present invention seeks to fill.

In summary, the invention described throughout this application is an unparalleled technological breakthrough that redefines the frontiers of information transformation and generation, challenging existing conventions and setting a new standard in the field of latency-free communication, generation and transmission of information.

Examples of possible fields of application for the technology described in this application range from analogue or digital signal processing in fields such as telecommunications, to the processing of complex signals containing information within the fields of medicine, genetics, chemistry, biotechnology, audio, etc.

Some aspects of the present invention will now be described in more detail with reference to the accompanying drawings showing some of the modalities and advantages of the present invention.

It will be obvious to a technician in the field that various modes of invention may be expressed in different ways and should not be construed as limited to the modalities described here; rather, these exemplary modalities are provided so that this invention is clear and complete, and fully conveys the scope of the invention to experts in the field. For example, unless otherwise stated, something that is described as first, second, or similar should not be construed as a particular order. As used in the description and accompanying claims, the singular forms “a, one”, “a”, “the” include plural referents unless the context clearly indicates otherwise.

It should also be borne in mind that similar numerals refer to similar and/or corresponding components and/or elements used in one or more of the modalities of this invention.

The different aspects of the present invention relate to a system for generating the X, Y, Z signals of a trisonic audio from the L and R signals of a stereophonic audio. In particular, the present invention is configured to process and convert stereophonic audio into trisonic audio by incorporating a magnetic collision system and/or an electrical collision system achieving such processing and/or conversion with zero latency.

In the context of the present invention, as has been briefly explained in the present application, by “stereophonic audio”, a person skilled in the art will understand that it is audio composed of at least a pair of audio channels or signals; In a non-limiting example, said two audio channels or signals are different from each other, which are identified as left channel or signal (LEFT or L) and right channel or signal (RIGHT or R) which are usually played through a separate audio emitting device. Furthermore, the present invention is intended to process said L and R signals of stereophonic audio, which could be generated live. Throughout this description, when referring to “live” or, as in this case, “generated live,” it must be understood that said stereophonic audio signals are generated instantly and therefore, their sound is not an element pre-recorded or pre-generated; However, the present invention can also be used with previously recorded audio signals.

The present invention is configured with the purpose of processing and converting the stereophonic audio signals generated live and to do so with zero latency, since, at present, the technology used to perform almost any type of processing or conversion has the disadvantage that, once the signal of stereophonic audio or any other type of audio enters the processing medium for processing, an unwanted delay is generated between the input and output of the signal. This delay, as mentioned above, is known as latency.

In a live event, latency is a very unfavorable factor, since its effects can cause confusion for performers, as well as discomfort for the target audience or spectator. Therefore, the present invention describes a system capable of processing the L and R signals of a stereophonic audio to convert them into the X, Y, Z signals of a trisonic audio using a magnetic collision system or an electrical collision system, advantageously managing to reduce and even completely cancel the presence of a time delay or latency during the processing and/or conversion of the signals, thus overcoming the current technical problem present in the known audio signal processing means within the state of the technique, which, no matter how minimal, there is still latency between the input signal (signal to be processed) and the output signal (resulting processed signal). The present invention, therefore, solves this problem in a practical, efficient and innovative way by means of the collision system that is described below within the present application.

With the above, one of the applications of the present invention is in events or in general, where the signal to be processed is generated live, since the advantages of the present invention, which will be evident after a holistic reading of this description, allow the resulting processed signal, once it is transmitted in a trisonic audio playback system, is heard without delay with respect to the source of the audio signal output.

In addition, the present invention makes it possible to process and convert stereophonic audio into trisonic audio. A person with ordinary knowledge in the field may know that a stereophonic audio contains 5 perfectly balanced and homogeneous panning points, which are known as points A, D, C, E, and B, where these panning points are generated by making a stereophonic audio mix in, for example, a recording studio, specifically in the panning process.

Thus, each channel or audio signal (LEFT and RIGHT) must contain a specific percentage of these pan points that, when emitted in a stereophonic audio playback system, interact at the same time and with each other within a physical space, resulting in the total appreciation of the said 5 panning points in a balanced and homogeneous way. In the context of the present invention, “audio playback system” is to be understood as any means configured to receive an audio signal (processed or not), and which can transform it into sound so that a user, target audience or general viewer and/or listener can perceive the audio.

Therefore, stereophonic audio, once the process commonly known as stereophonic mixing or panning has been carried out, contains, in a balanced and homogeneous way, the following values of each panning point, that is:

The LEFT audio signal contains pan point A at 100%, point D at 75%, point C at 50%, point E at 25%, and point B at 0%.

The RIGHT audio signal, on the other hand, contains pan point B at 100%, point E at 75%, point C at 50%, point D at 25%, and point A at 0%.

In such a way that:

L=(A100/D75/C50/E25/B0)

R=(A0/D25/C50/E75/B100)

On the other hand, a trisonic audio is composed of 3 channels or audio signals (in the context of the present invention named as signal X, signal Y, signal Z); A trisonic audio also contains the same 5 perfectly balanced and homogeneous pan points A, D, C, E, and B, where those pan points correspond to the same ones that were generated when doing the stereophonic audio mix.

Additionally, it is important to understand that there are two trisonic audio modes composed of the X, Y, Z signals, where the first trisonic audio mode is composed of the X2, Y2, Z2 signals wherein the second trisonic audio mode is composed of the X3, Y3, Z3 signals.

Thus, based on the above, it must be understood that each of the new 3 audio signals (X2, Y2, Z2) that make up the first trisonic audio modality, which are generated after the processing and conversion carried out by the system of the present invention, must contain a specific percentage of these panning points achieving that when emitted and/or transmitted by the corresponding trisonic audio playback system (e.g., but not limited through mono audio playback systems) and interact at the same time with each other and in the acoustic physical space, as previously described, they result in the total appreciation of the 5 perfectly balanced and homogeneous panning points, so that: the X2 audio signal contains pan point A at 100%, point D at 50%, point C at 0%, point E at −50%, and point B at −100%; audio signal Y2 contains pan point B at 100%, point E at 50%, point C at 0%, point D at −50%, and point A at −100%; and the Z2 audio signal contains pan point A at 100%, point D at 100%, point C at 100%, point E at 100%, and point B at 100%.

That is to say;

X2=(A100/D50/−E50/−B100)

Y2=(−A100/−D50/E50/B100)

Z2=(A100/D100/C100/E100/B100)

Thus, based on the above, it must also be understood that each of the new 3 audio signals (X3, Y3, Z3) that make up the second trisonic audio mode, which are generated after the processing and conversion carried out by the system of the present invention, must contain a specific percentage of said panning points, achieving that when they are emitted and/or transmitted by the corresponding trisonic audio playback system (for example, but not limited through mono audio playback systems) and interact at the same time with each other and within the physical space, as previously described, they result in the appreciation of the 5 perfectly balanced and homogeneous panning points, so that: the X3 audio signal contains pan point A at 200%, point D at 125%, point C at 50%, point E at −25%, and point B at −100%; audio signal Y3 contains pan point B at 200%, point E at 125%, point C at 50%, point D at −25%, and point A at −100%; and the Z3 audio signal also contains pan point A at 100%, point D at 100%, point C at 100%, point E at 100%, and point B at 100%.

That is to say;

X3=(A200/D125/C50/−E25/−B100)

Y3=(−A100/−D25/C50/E125/B200)

Z3=(A100/D100/C100/E100/B100)

Likewise, according to a preferred modality, a trisonic audio playback system may be, and is not limited to, any selected from the group comprising a triangular playback system, a dynamic playback system, a quadraphonic playback system, an earphone playback system, a vector playback system, combinations thereof, or the like. In general, the playback system for signals generated in accordance with the subject matter of the present invention may also be any currently known and/or disclosed playback system capable of reproducing trisonic audio.

In this sense, in the context of the present application, although the Figures accompanying this application show that the trisonic audio playback system is characterized by comprising “n” speakers, a person with knowledge in the field to whom The invention belongs to it, it will be understood that the present invention is not necessarily limited to this number of speakers, on the contrary, this represents only some examples of modalities of the Trisonic audio playback system. With this, said playback system can comprise from at least one and up to “n” number of speakers, again, without necessarily being limited to what is illustrated in the Figures that accompany this document.

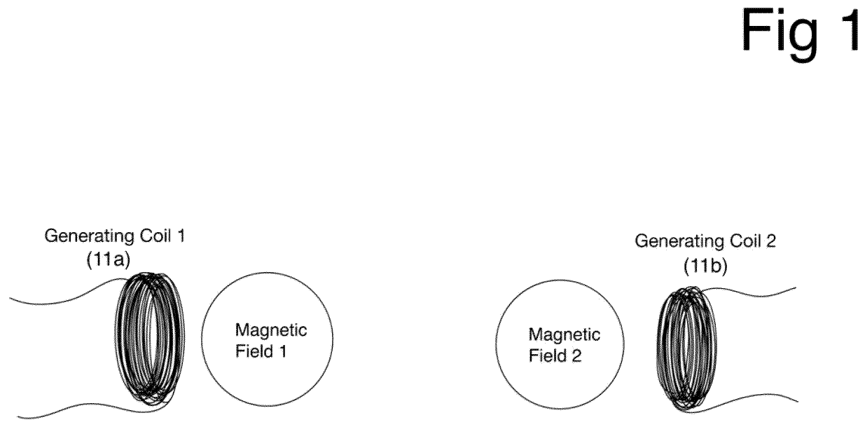

Thus, the present invention comprises two modes for the generation of trisonic audio, according to a first modality of the present invention and as can be seen in FIGS. 1 to 7, the magnetic collision system of the present invention is described as follows:
A) A magnetic collision system to generate trisonic audio with zero latency (10), such a magnetic collision system is composed of at least two subsystems: (i) at least one coil subsystem or coil assembly and (ii) at least one processing subsystem (20). In addition, the magnetic collision system (10) collaborates directly with at least one trisonic audio playback system, which will be described in greater detail later in this application. It should be noted that, in the context of the present invention, a coil subsystem is the same as a coil assembly and vice versa, therefore, it must be understood that, in the context of the present invention, such coil subsystem and such coil assembly represent the same thing and are therefore used in the same way to refer to the same elements of the present invention.

The magnetic collision system (10) of the present invention, without necessarily being limited in theory, is designed and configured in such a way that, based on the interaction of the supplied signals, it fuses these signals by the collision of magnetic fields.

A person with ordinary knowledge in the field will be able to conclude from the teachings of this application, that when the two or more magnetic fields interact with each other, for example, by colliding or colliding with each other, the signals from them merge.

Therefore, the present invention, according to one modality, uses this principle to convert an input signal or signals (signal to be processed) into an output signal or signals (processed resultant signal), based on the collision of magnetic fields.

In order to improve the clarity of the physical concept of magnetic collision previously indicated, FIGS. 1 to 4 are taken as a reference, which show an example of a modality illustrating a first subsystem of coils (set of coils), where the effect of a first coil (11a) which generates a first magnetic field and the effect of a second coil (11b) which generates, In turn, a second magnetic field, as well as the effect of a third coil (11c) can also be observed, which captures a third magnetic field resulting from the magnetic collision between the first magnetic field and the second magnetic field and converts it into an electric current.

In the context of this explanation of the concept of magnetic collision and throughout the description of the magnetic collision system in this application, “first coil”, “second coil”, “generating coil” and/or “magnetic field generating coil” is to be understood as an element capable of generating a magnetic field when an electric current is circulated through it.

In addition, “third coil”, “receiving coil” or “magnetic field receiving coil” should be understood as an element capable of capturing a magnetic field and in turn converting it into an electric current.

Typically, such coils are made by winding a conductive wire over a ferromagnetic material core or in the air. Coils in accordance with the present invention may be made of any suitable conductive material, the most commonly used material being enamelled copper wire; However, it must be understood that such coils are not limited to this particular material and that other appropriate materials may be used without departing from the teachings of the present invention.

Also, in the context of the present invention it should be understood that coils may be at least three and up to “n” number of coils and is not necessarily limited to the number of coils illustrated in the Figures accompanying this invention.

As previously mentioned, the first magnetic field generating coil (11a) generates a first magnetic field; To achieve this task, a first electric current is passed through the first coil (11a).

Similarly, the second magnetic field-generating coil (11b) generates a second magnetic field; To accomplish this task, a second electric current is passed through the second coil (11b). As can be seen from FIG. 1, these first and second coils (11a, 11b) are independent from each other and therefore, the first electric current is totally independent and different from the second electric current.

Consequently, the first magnetic field generated by the first coil (11a) is also different from the second magnetic field generated by the second coil (11b). By “different” in this case, the content of the electrical signal injected into the first coil must be interpreted as different from the content of the electrical signal injected into the second coil, so that, when converted into magnetic fields, each magnetic field will contain different signals from each other.

It should be noted that in the context of the present invention, “signal content”, “content characteristics”, “signal characteristics” and/or the like, should be understood to refer to the information of pan point values that are part of an audio signal.

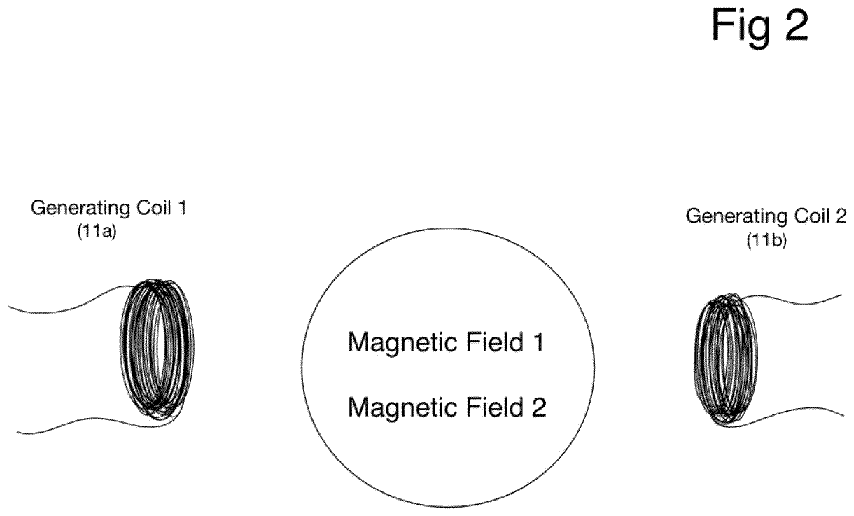

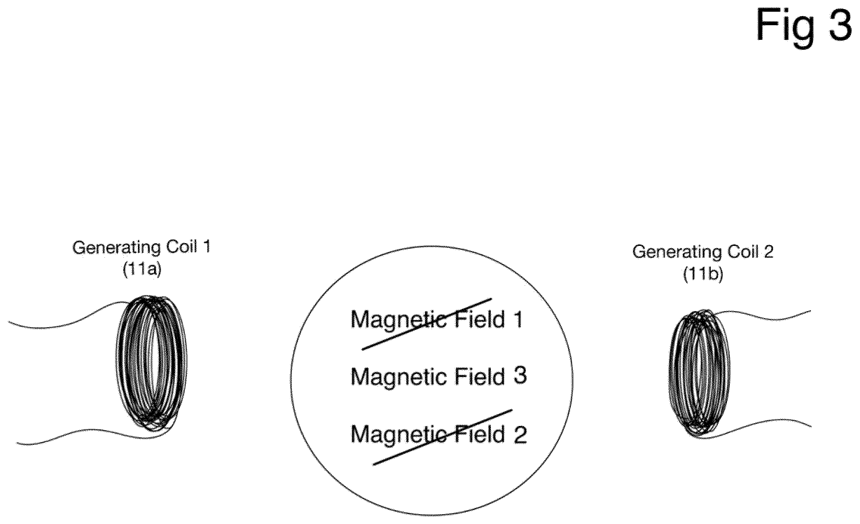

Once the first and second magnetic fields, emitted respectively by the first and second coils (11a, 11b) enter the physical space, they collide with each other, as shown in FIG. 2. Again, without necessarily being limited by the physics involved, when these first and second magnetic fields collide in physical space, a third magnetic field is generated or gives rise, as shown in FIG. 3.

The collision of the signals contained in the first and second magnetic fields causes the information of these signals to merge, thus achieving that the third magnetic field has a totally different signal from the signal of the first and second magnetic fields.

It will be clear from reading this portion of the present invention that the third magnetic field and/or more specifically, the signal resulting from the third field will be achieved on the basis of the characteristics of the content of the magnetic fields generated by the first and second coils (11a, 11b) so that, after the collision between these magnetic fields, The signal of the third field is in accordance with the desired parameters and therefore, the signal processing is achieved in a direct way.

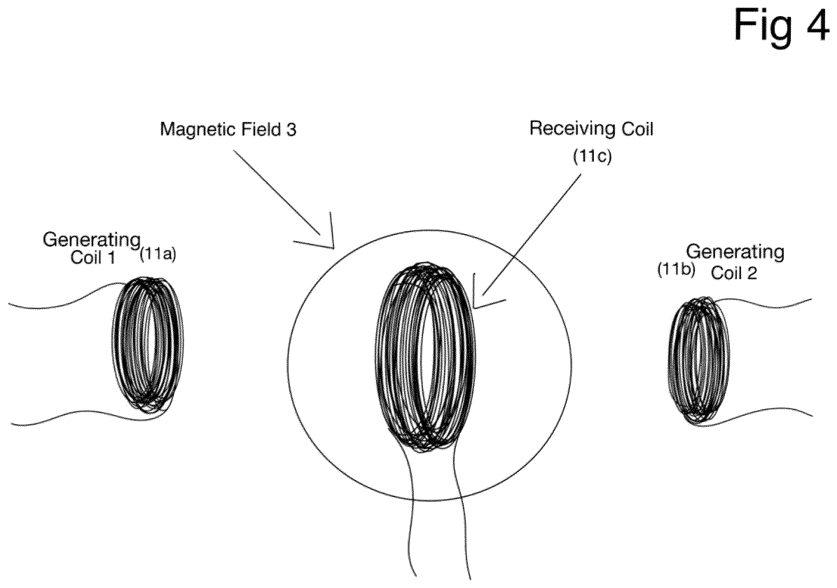

The third magnetic field present in physical space, as explained so far, is subsequently captured by a magnetic field receiving coil (11c) as shown in FIG. 4. Therefore, the receiving coil (11c) captures the signal contained in the third magnetic field, and in addition, the receiving coil (11c) is configured to convert the third magnetic field into an electric current, preserving the content of the signal achieved after the magnetic collision between the first and second magnetic fields.

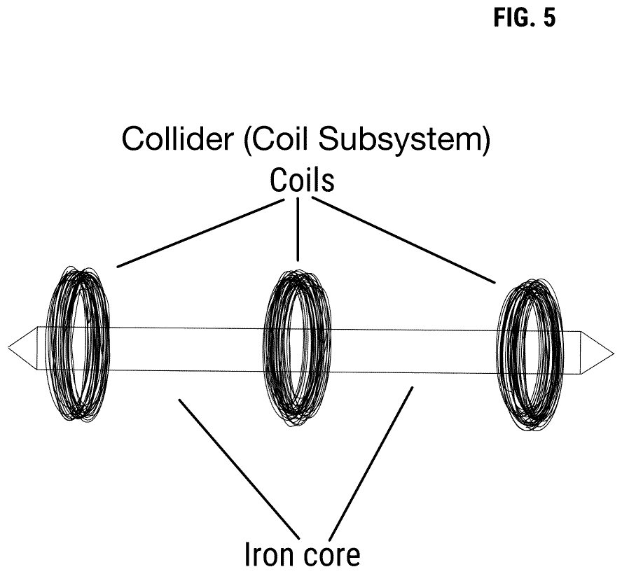

It is important to understand that, according to the context of the present invention, a collider (coil subsystem, coil assembly) is characterized by being composed of a set of 3 independent and separate coils that in turn are mounted on the same iron core, that is, these 3 coils are in direct contact with said core but are not intertwined with each other, in addition, these coils may or may not be interconnected with each other, This will depend on its magnetic or electrical function. See FIG. 5.

The first (11a), the second (11b) and the third (11c) coil, according to this mode of the present invention, are not electrically connected to each other; In other words, these coils are independent from each other. As described throughout this application, the fusion of signals takes place in physical space as they are magnetic fields generated by the respective first and second coils (11a, 11b); Therefore, electric currents do not come into contact with each other.

In one modality, the first, second, and third coils (11a, 11b, 11c) are arranged on a core. In a preferential mode, the coils (11a, 11b. 11c) are arranged in an aligned manner in the core and, more particularly, the core may be arranged in such a way that it passes through the center of the coils (11a, 11b. 11c) as shown in FIG. 5.

Based on the theory of magnetic field induction, it is known that nuclei are used so that a magnetic field produced by coils generating magnetic fields circulates through it; the characteristics and properties of the nucleus fulfill or allow to fulfill the function of maintaining the magnetic flux produced by the generating coils, avoiding to a large extent the losses produced by eddy currents or Foucault's current; in other words, the nucleus can be seen as a controlled pathway for the Magnetic Flux generated, by the first and second coils (11a, 11b).

Thus, the core allows the magnetic flux generated by the first and second coils (11a, 11b) to travel through it, without significant losses and with it, the respective signals embedded in the first and second magnetic fields generated by the coils (11a, 11b) reach the physical space with their information intact and ready for interaction or collision as previously mentioned.

In one modality, the core can be any core commonly used in magnetic induction applications, such core, in a preferred mode, can be a solid bar with a cross-section that can be any selected from the group comprising circular, square, rectangular, oval, polygonal, regular, irregular section areas, combinations thereof and/or the like. It should be understood that such a core is not limited to any particular material and that different types of appropriate materials may be used without departing from the teachings of the present invention.

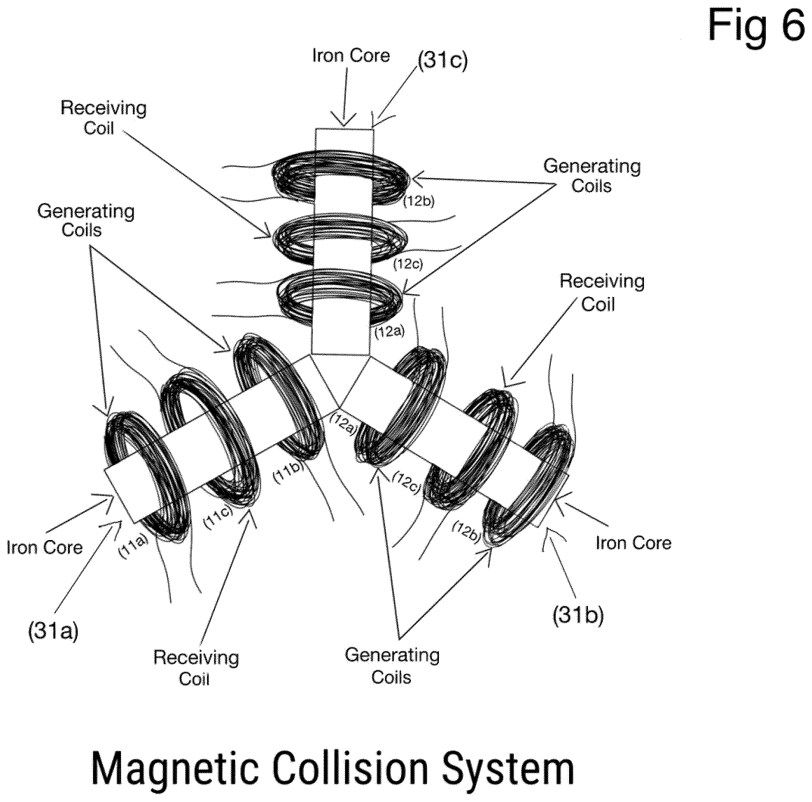

Likewise, the core can be a bar composed of several layers or laminations, in addition, the core can adopt any selected shape from the group comprising a straight bar, a U-shaped, E-shaped, Y-shapped, T-shaped structure, it can have a continuous or discontinuous shape, it can be open or closed, combinations of the same or in general, any other form and dimension without necessarily being limited to the forms and provisions referred to above. In a preferred modality, the core is star-shaped or delta-shaped, with the different portions of it being separated by 120°, as shown, by way of non-limiting example, in FIG. 6.

The core, in accordance with the present invention, may be made of any material selected from the group comprising solid iron, silicon steel, amorphous steel, iron carbonyl, ferrite ceramic, combinations thereof and/or materials with similar properties, in particular, which favour the passage of magnetic flux through it.

The first and second coils (11a, 11b), which, according to the present invention, are designed to convert, respectively, the first and second signal or electric current passing through them, into different and independent magnetic fields, and the third coil (11c) is designed to capture the fused magnetic field derived from the interaction of the first and second magnetic field, In addition, these coils are configured to be arranged in an aligned manner, preferably concentrically with the core in the center, and so that the third coil is arranged between the first and second coils; However, the foregoing should not be interpreted to mean that the present invention is limited to the arrangement or arrangement referred to above, on the contrary, the previous arrangement favors that the magnetic fields generated by both the first and second coils (11a, 11b) can collide in physical space and the third coil (11c) can more efficiently capture the magnetic field generated after the interaction, That is, the third magnetic field, however, other configurations, arrangements and/or arrangements can be used without departing from the teachings and spirit of the present invention.

Taking FIG. 6 as a reference again, in this example of a modality, the nucleus is configured in a monolithic way, forming a delta; This nucleus, according to this example of a modality, is made up of three portions (31a, 31b, 31c). In addition, a set of coils that are completely independent from each other are shown in each portion of the core.

According to this example of a modality, the system of the present invention comprises a first set of coils (11a, 11b, 11c) arranged on a first portion of the nucleus (31a); a second set of coils (12a, 12b, 12c) arranged on a second portion of the core (31b); and a third set of coils (13a, 13b, 13c) arranged on a third portion of core (31c).

The first set of coils (11a, 11b, 11c), arranged on the first core portion (31a) consists of a first generating coil (11a), a second generating coil (11b) and a third coil, also called the receiving coil (11c). In this modality example, the receiving coil (11c) is arranged between the first and second coils (11a, 11b), as shown in FIG. 6 referred to above.

The second set of coils (12a, 12b, 12c), arranged on the second core portion (31b) consists of a first generating coil (12a), a second generating coil (12b) and a third coil, also called the receiving coil (12c). In this modality example, the receiving coil (12c) is arranged between the first and second coils (12a, 12b), as shown in FIG. 6 referred to above.

The third set of coils (13a, 13b, 13c), arranged on the third core portion (31c) consists of a first generating coil (13a), a second generating coil (13b) and a third coil, also called the receiving coil (13c). In this modality example, the receiving coil (13c) is arranged between the first and second coils (13a, 13b), as shown in FIG. 6 referred to above.

It is important to understand that in an exemplary but not limited way, all the coils referenced so far are those necessary to generate the signals (X2, Y2, Z2) of the first mode of a trisonic audio, however, it is clear to understand that 3 other sets of coils configured in the same way could be used to generate the signals (X3, Y3, Z3) of the second mode of a trisonic audio.

Again, each and every one of the configurations or arrangements of the generating and receiving coils referred to above are examples of the modalities and other configurations may be used without departing from the teachings and spirit of the present invention.

As previously mentioned, the coil sets are completely independent from each other, that is to say, the first set of coils does not interfere either electrically or magnetically with the second or third set of coils, and the same applies to the second and third sets of coils; That is, each set of coils should ideally be considered as closed systems, i.e. sets that are totally isolated from each other.

As mentioned above, there are two modes of trisonic audio, one composed of the X2, Y2, Z2 signals and one composed of the X3, Y3, Z3 signals.

It should be noted that the magnetic collision system of the present invention is capable of generating both the X2, Y2 and Z2 signals as well as the X3, Y3 and Z3 signals. Below is the generation of the X2, Y2, Z2 signals.

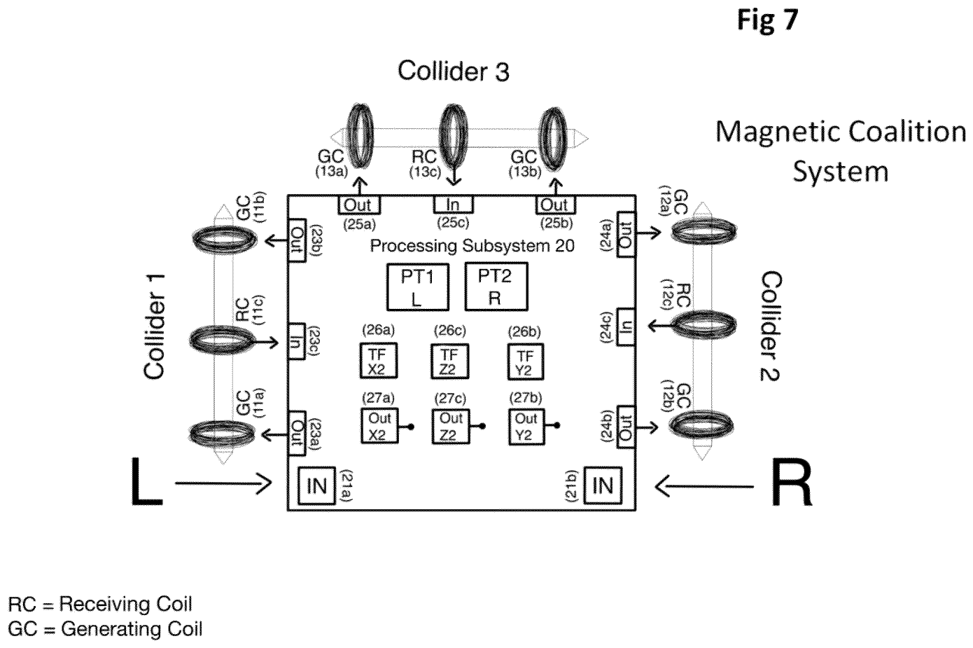

Operation of the Magnetic Collision System to Generate the Signals X2, Y2, Z2 of a trisonic audio (FIG. 7)

It is important to understand that, as mentioned previously, stereophonic audio is composed of two channels or audio signals (commonly known as the left signal (L or LEFT) and the right signal (R or RIGHT). However, a person skilled in the art will understand that the term “stereophonic” applies or refers, in any of the modalities described throughout this application, to any audio comprising at least one pair and up to “n” number of pairs of channels or signals; By way of non-limiting example, such audio can be any selected from the group that comprises 5.1-channel, 7.1-channel, 9.1-channel audio, among others; therefore, in the context of this invention, “stereophonic audio” should also be understood as any pair of channels or audio signals of type L and R that are part of any type of multichannel audio. Therefore, the magnetic collision system of the present invention is capable of receiving from input any pair of channels or audio signals of type L and R, and also any pair of channels or signals of any type.

It should be mentioned that the outputs, inputs and other elements that are part of the processing subsystem and that will be referred to below, are only an example of a modality that allows to clearly and concisely illustrate the operation of said processing subsystem, therefore, it must be understood that the processing subsystem according to this invention can comprise up to “n” number of outputs, inputs or other elements and is not necessarily limited to the example of modality referred to in FIG. 7 accompanying this description.

Generation of the X2 Signal of a Trisonic Audio from the Physical Operation;

Thus, for the first set of coils (11a, 11b, 11c), the first coil (11a) is configured to circulate through it, a first electric current, which corresponds to the previously treated channel or signal LEFT or L of a stereophonic audio; consequently, the magnetic field generated by that first coil (11a) also contains the same content characteristics of the previously processed LEFT signal; On the other hand, the second coil (11b) is configured to circulate through it, a second electric current, which corresponds to the previously treated channel or signal RIGHT or R of a stereophonic audio; consequently, the magnetic field generated by that second coil (11b) also contains the same content characteristics of the previously processed RIGHT signal.

It is clear that the electric current of both the first and second coils (11a, 11b) are different from each other.

According to one modality, the L and R signals of stereophonic audio are driven by the action of the processing subsystem (20), which will be described in more detail later. The processing subsystem (20) receives the signals of such stereophonic audio, one at the input (21a) for the LEFT channel or signal and one at the input (21b) for the RIGHT channel or signal, each converting respectively into the first and second pre-treated electrical currents. Subsequently, the processing subsystem directs these first and second pretreated electric currents to the first and second coils (11a, 11b) respectively, through the outputs (23a) and (23b) as previously mentioned and illustrated.

Once the first and second pretreated electric currents are converted into the first and second magnetic fields and that the collision has been carried out to generate the third magnetic field, the third magnetic field is captured by the third receiving coil (11c). As previously mentioned, this third magnetic field is the result of the magnetic collision between the previously processed LEFT and RIGHT audio signals.

Thus, once the receiving coil (11c) picks up the third magnetic field, the receiving coil (11c) is configured to convert the magnetic field into an electric current; This current is called the third electric current, which corresponds to the new X2 signal of a trisonic audio. Again, the third electric current or X2 contains the same characteristics as the contents of the third magnetic field.

The third electric current is then conducted from the receiving coil (11c) to the processing subsystem (20) through (23c); once inside the processing subsystem, this third electrical current X2 receives a final treatment prior to its output.

Generation of the Y2 Signal of a Trisonic Audio from Physical Operation;

For the second set of coils (12a, 12b, 12c), the first coil (12a) is configured to circulate through it, a first electric current, which corresponds to the previously treated channel or signal LEFT or L of a stereophonic audio; consequently, the magnetic field generated by that first coil (12a) also contains the same content characteristics of the previously treated LEFT signal; On the other hand, the second coil (12b) is configured to circulate through it, a second electric current, which corresponds to the previously treated channel or signal RIGHT or R of a stereophonic audio; consequently, the magnetic field generated by the second coil (12b) also contains the same content characteristics of the previously processed RIGHT signal.

It is clear that the electric current of both the first and second coils (12a, 12b) are different from each other. On the other hand, it is important to clarify that the LEFT and RIGHT input signals are introduced in the first set of coils as well as in the second set of coils; however, these LEFT and RIGHT signals are pre-treated differently and introduced individually into each set of coils.

According to one modality, the L and R signals of stereophonic audio are driven by the action of the processing subsystem (20), which will be described in more detail later. The processing subsystem (20) receives the signals of such stereophonic audio, one at the input (21a) for the LEFT channel or signal and one at the input (21b) for the RIGHT channel or signal, each converting respectively into the first and second pre-treated electrical currents. Subsequently, the processing subsystem directs these first and second pretreated electrical currents to the first and second coils (12a, 12b) respectively, through the outputs (24a) and (24b) as previously mentioned and illustrated.

Once the first and second pretreated electric currents are converted into the first and second magnetic fields and they have collided to generate the third magnetic field, the third magnetic field is captured by the third receiving coil (12c). As previously mentioned, this third magnetic field is the result of the magnetic collision between the previously processed LEFT and RIGHT audio signals.

Thus, once the receiving coil (12c) picks up the third magnetic field, the receiving coil (12c) is configured to convert the magnetic field into an electric current; This current is called the third electric current, which corresponds to the new Y2 signal of a trisonic audio. Again, the third electric current or Y2 contains the same characteristics as the content of the third magnetic field.

The third electric current is then conducted from the receiving coil (12c) to the processing subsystem (20) through (24c); once inside the processing subsystem, this third electric current Y2 receives a final treatment prior to its output.

Generation of the Z2 Signal of a Trisonic Audio from Physical Operation;

For the third set of coils (13a, 13b, 13c), the first coil (13a) is configured to circulate through it, a first electric current, which corresponds to the previously treated channel or signal LEFT or L of a stereophonic audio; consequently, the magnetic field generated by that first coil (13a) also contains the same content characteristics of the previously treated LEFT signal; On the other hand, the second coil (13b) is configured to circulate through it, a second electric current, which corresponds to the previously treated channel or signal RIGHT or R of a stereophonic audio; consequently, the magnetic field generated by that second coil (13b) also contains the same content characteristics of the previously processed RIGHT signal.

It is clear that the electric current of both the first and second coils (13a, 13b) are different from each other. On the other hand, it is important to clarify that the LEFT and RIGHT input signal are introduced in the first set of coils as well as in the second set of coils and in the third set of coils; however, these LEFT and RIGHT signals are pre-treated differently and introduced individually into each set of coils.

According to one modality, the L and R signals of stereophonic audio are driven by the action of the processing subsystem (20), which will be described in more detail later. The processing subsystem (20) receives the signals of such stereophonic audio, one at the input (21a) for the LEFT channel or signal and one at the input (21b) for the RIGHT channel or signal, each converting respectively into the first and second pre-treated electrical currents. Subsequently, the processing subsystem directs these first and second pre-treated electric currents to the first and second coils (13a, 13b) respectively, through the outputs (25a) and (25b) as previously mentioned and illustrated.

Once the first and second pretreated electric currents are converted into the first and second magnetic fields and they have collided to generate the third magnetic field, the third magnetic field is captured by the third receiving coil (13c). As previously mentioned, this third magnetic field is the result of the magnetic collision between the previously processed LEFT and RIGHT audio signals.

Thus, once the receiving coil (13c) picks up the third magnetic field, the receiving coil (13c) is configured to convert the magnetic field into an electric current; This current is called the third electric current, which corresponds to the new Z2 signal of a trisonic audio. Again, the third electric current or Z2 contains the same characteristics as the contents of the third magnetic field.

The third electric current is then conducted from the receiving coil (13c) to the processing subsystem (20) through (25c); once inside the processing subsystem, this third electric current Z2 receives a final treatment prior to its output.

However, it should be noted that the concept of pretreatment as previously and/or throughout this application, in accordance with a modality of the present invention, the performance of this action is imperative, especially when applied to the IN audio signals before they enter the coils of the invention being filed. This need is based on the premise that pretreatment is a critical step to ensure optimal system performance. The term “primarily” emphasizes that while pretreatment may have other applications, its priority application should target the IN audio signals in this specific context.

The reason behind this priority is that the IN audio signals play a fundamental role in the overall operation of the invention, and their pre-treatment helps to optimize their quality and characteristics before they are processed by the subsystems or coil assembles. This ensures that the signals entering the coils are in the ideal condition to obtain the desired results in terms of system performance and functionality.

It is also important to note that a person with ordinary knowledge in the field would understand that the generation of a third magnetic field, as used in the present invention, should not be interpreted as a pre-treatment process aimed at the subsequent creation of X, Y or Z signals. In reality, this third magnetic field already intrinsically contains the information and content of the definitive X, Y, or Z signals.

This nuance is fundamental to understanding the functioning and nature of this third magnetic field. Rather than being a preliminary step in the production of X, Y, or Z signals, this magnetic field itself represents the manifestation of those signals. Therefore, it is not a pre-processing phase aimed at preparing the signals for their subsequent generation, but at its origin it already incorporates the essential information for the formation of the desired signals.

This distinction is of great importance, as it highlights that the third magnetic field is not an intermediary, but the end product itself. Its content and characteristics are directly related to the X, Y, or Z signals that are sought to be generated, suggesting an intrinsic relationship between the third magnetic field and the final signals. Therefore, it should not be considered as a preliminary stage, but as the complete and definitive outcome of the process, which has significant implications for understanding and effectively using this phenomenon in practice.

Also, despite the fact that the third magnetic field already intrinsically incorporates the information related to the X, Y or Z signals, it is valid to say that it undergoes a final treatment before the output signals are delivered. This process should not be confused with a pre-treatment, since, as previously explained, the third magnetic field is essentially the desired end result.

The processing subsystem plays a critical role in further enhancing and tuning the characteristics of X, Y, or Z signals. During this phase, specific modifications are applied to ensure that the output signals meet the required standards in terms of quality, accuracy, or other necessary parameters. This final processing in the processing subsystem is carried out in order to refine the signals before they are delivered.

Consequently, it could be said that the third magnetic field constitutes the final result or the resulting signal X, Y or Z, and the processing subsystem is responsible for optimizing and adjusting the said X, Y or Z output signals according to the particular needs and specifications. This differentiation between the third magnetic field and the processing subsystem is of vital importance to understand how the generation of X, Y, or Z signals is achieved with the highest accuracy and quality. The incorporation of this final treatment into the process underlines the sophistication and controllability of the system, ensuring that the output signals are optimal in terms of performance and utility.

Regarding the generation of the X2 signal of a trisonic audio from the previously referred physical operation and with continuous reference to FIG. 7, it is important to highlight that, taking into account again the first set of coils (11a, 11b, 11c), the process of generating this X2 signal of a trisonic audio will be explained in detail below.

As mentioned earlier in this document, stereo audio is composed of two different audio signals: LEFT and RIGHT, where the LEFT signal contains the pan point values (A100/D75/C50/E25/B0) and the RIGHT signal contains the pan point values (A0/D25/C50/E75/B100); According to the present invention, the X2 signal of a trisonic audio is generated after the fusion of the audio signal R at 180° (−A0/−D25/−C50/−E75/−B100) with the audio signal L (A100/D75/C50/E25/B0), that is to say, the X2 audio signal is generated by causing a deletion and/or incorporation between the values of pan points of R at 180° with the values of L. Panning

It will be clear at this point that such removal and/or incorporation of panning point values from the said LEFT and RIGHT signals at 180° is carried out in the interaction and collision of magnetic fields in physical space, as previously described.

To generate the X2 signal of a trisonic audio, the RIGHT audio signal with all its 180° pan point values (−A0/−D25/−C50/−E75/−B100) is first injected into one of the generating coils; specifically, such RIGHT audio signal at 180° must be injected into the second generator coil (11b).

These panning values of the audio signal R at 180° are contained in an independent magnetic field and generated by the generating coil of the first set of coils.

At a second point, the LEFT audio signal with all its pan point values (A100/D75/C50/E25/B0) is injected into one of the generating coils; specifically, such a LEFT audio signal must be injected into the first generating coil (11a).

These panning values of the LEFT audio signal are contained in another independent magnetic field generated by the other generating coil of the first set of coils, making it evident that this magnetic field is different and independent of the magnetic field that contains the panning values of the RIGHT audio signal at 180°.

The independent magnetic fields, generated by the generating coils of the first set of coils (11a, 11b), collide with each other to generate a third magnetic field independent of and different from the first two fields previously described.

As described throughout this application, the collision or crashing between these magnetic fields causes a deletion and/or incorporation of the values of panning points contained in those magnetic fields generated by those generating coils, generating a third magnetic field with new values of panning points, These (A100/D50/−E50/−B100), correspond to the new X2 audio signal of a trisonic audio.

Consequently, the receiving coil (11c) of said first set of coils is configured to capture and convert the third magnetic field into an electric current called the third electric current, which must contain the said new X2 audio signal, whose panning values are (A100/D50/−E50/−B100), which are necessary to form said first channel or signal of a trisonic audio.

Finally, according to a modality, the third electric current or the new X2 signal will be conducted to a final treatment (26a) within the processing subsystem (20) so that the X2 signal will be consecutively connected to a subsequent playback system; the output of the said X2 audio signal after passing through the final processing (26a) is done through (27a).

Regarding the generation of the Y2 signal of a trisonic audio from the previously referred physical operation and with continuous reference to FIG. 7, it is important to highlight that, taking into account again the second set of coils (12a, 12b, 12c), the process of generating said Y2 signal of a trisonic audio will be explained in detail below.

As mentioned earlier in this document, stereo audio is composed of two different audio signals: LEFT and RIGHT, where the LEFT signal contains the pan point values (A100/D75/C50/E25/B0) and the RIGHT signal contains the pan point values (A0/D25/C50/E75/B100); According to the present invention, the Y2 signal of a trisonic audio is generated by the fusion between the audio signal L at 180° (−A100/−D75/−C50/−E25/−B0) with the audio signal R (A0/D25/C50/E75/B100), that is to say, the audio signal Y2 is generated by causing a deletion and/or incorporation between the values of pan points of L at 180° with the values of R. panning.

It will be clear at this point that such removal and/or incorporation of pan point values from the LEFT to 180° and RIGHT signals takes place in the interaction and collision of magnetic fields in physical space, as previously described.

To generate the Y2 signal of a trisonic audio, the LEFT audio signal with all its 180° pan point values (−A100/−D75/−C50/−E25/−B0) is first injected into one of the generating coils; specifically, such a LEFT audio signal at 180° should be injected into the second generator coil (12b).

These pan values of the audio signal L at 180° are contained in an independent magnetic field generated by the generating coil of the second set of coils.

At a second point, the RIGHT audio signal with all its pan point values (A0/D25/C50/E75/B100) is injected into one of the generating coils; specifically, such a RIGHT audio signal must be injected into the first generating coil (12a).

These panning values of the RIGHT audio signal are contained in another independent magnetic field generated by the other generating coil of the second set of coils, making it evident that this magnetic field is different and independent from the magnetic field containing the panning values of the LEFT audio signal at 180°.

The independent magnetic fields, generated by the generating coils of the second set of coils (12a, 12b), collide with each other to generate a third magnetic field independent and different from the first two fields previously described.

As described throughout this application, the collision or crashing between these magnetic fields causes a deletion and/or incorporation of the values of panning points contained in those magnetic fields generated by those generating coils, generating a third magnetic field with new values of panning points, These (−A100/−D50/E50/B100), which correspond to the new Y2 audio signal of a trisonic audio.

Consequently, the receiving coil (12c) of said second set of coils is configured to capture and convert the third magnetic field into an electric current called the third electric current, which must contain the said new audio signal Y2, whose pan values are (−A100/−D50/E50/B100), which are necessary to form said second channel or signal of a trisonic audio.

Finally, according to a modality, the third electric current or new signal Y2 will be conducted to a final treatment (26b) within the processing subsystem (20) so that the signal Y2 will be consecutively connected to a subsequent playback system; the output of the said audio signal Y2 after passing through the final treatment (26b) is done through (27b).

Regarding the generation of the Z2 signal of a trisonic audio from the previously referred physical operation and with continuous reference to FIG. 7, it is important to highlight that, taking into account again the third set of coils (13a, 13b, 13c), the process of generating this Z2 signal of a trisonic audio will be explained in detail below.

As mentioned earlier in this document, stereo audio is composed of two different audio signals: LEFT and RIGHT, where the LEFT signal contains the pan point values (A100/D75/C50/E25/B0) and the RIGHT signal contains the pan point values (A0/D25/C50/E75/B100); According to the present invention, the Z2 signal of a trisonic audio is generated after the fusion of the audio signal R (A0/D25/C50/E75/B100) with the audio signal L (A100/D75/C50/E25/B0), that is to say, the audio signal Z2 is generated by causing a deletion and/or incorporation between the pan point values of R and the pan point values of L.

It will be clear at this point that such removal and/or incorporation of panning point values from the LEFT and RIGHT signals takes place in the interaction and collision of magnetic fields in physical space, as previously described.

To generate the Z2 signal of a trisonic audio, the RIGHT audio signal with all its pan point values (A0/D25/C50/E75/B100) is first injected into one of the generating coils; specifically, such a RIGHT audio signal must be injected into the second generating coil (13b).

These panning values of the audio signal R are contained in an independent magnetic field generated by the generator coil of the third set of coils.

At a second point, the LEFT audio signal with all its pan point values (A100/D75/C50/E25/B0) is injected into one of the generating coils; specifically, such a LEFT audio signal must be injected into the first generator coil (13a).

These panning values of the LEFT audio signal are contained in another independent magnetic field generated by the other generating coil of the third set of coils, and it is evident that this magnetic field is different and independent of the magnetic field that contains the panning values of the RIGHT audio signal.

The independent magnetic fields, generated by the generating coils of the third set of coils (13a, 13b), collide with each other to generate a third electromagnetic field independent of and different from the first two fields previously described.

As described throughout this application, the collision or crashing between these magnetic fields causes a deletion and/or incorporation of the values of panning points contained in those magnetic fields generated by those generating coils, generating a third magnetic field with new values of panning points, these (A100/D100/C100/E100/B100), which correspond to the new Z2 audio signal of a trisonic audio.

Consequently, the receiving coil (13c) of said third set of coils is configured to capture and convert the third magnetic field into an electric current called the third electric current, which must contain the said new audio signal Z2, whose panning values are (A100/D100/C100/E100/B100), which are necessary to form said third channel or signal of a trisonic audio.

Finally, according to a modality, the third electric current or new signal Z2 will be conducted to a final treatment (26c) within the processing subsystem (20) so that the Z2 signal is consecutively connected to a subsequent playback system; the output of the said audio signal Z2 after passing through the final treatment (26c) is done through (27c).

Below is the generation of the X3, Y3, Z3 signals.

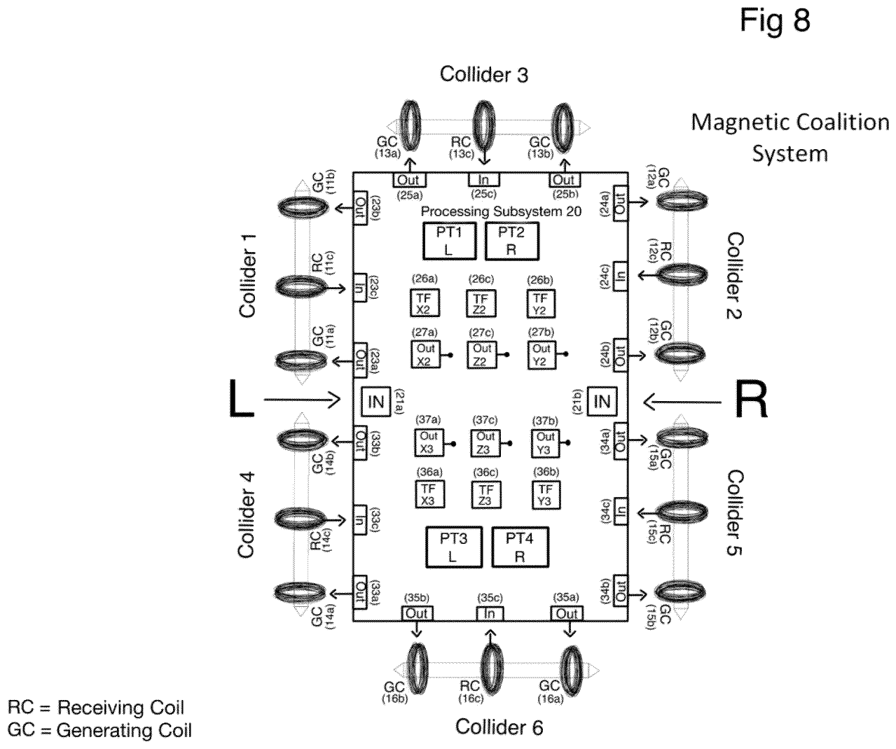

### How the Magnetic Collision System Works to Generate the X3, Y3, Z3 Signals of a Trisonic Audio (FIG. 8)

It is important to understand that in order to generate the X3, Y3, Z3 signals of a trisonic audio it is necessary to use the L and R signals of a stereophonic audio but it is also necessary to use the previously generated X2, Y2, Z2 signals, therefore, FIG. 8 is shown as a reference in which the sets of coils used to generate these X2, Y2, Z2 however, it should be understood that these FIGS. 7 and 8 are shown in an exemplary but not limited way with the intention of facilitating the understanding of the generation of the signals of a trisonic audio in any of its modalities.

It should be mentioned that the outputs, inputs and other elements that are part of the processing subsystem and that will be referred to below, are only an example of a modality that allows to clearly and concisely illustrate the operation of said processing subsystem, therefore, it must be understood that the processing subsystem according to this invention can comprise up to “n” number of outputs, inputs or other elements and is not necessarily limited to the example of modality referred to in FIGS. 7 and 8 accompanying this description.

Generation of the X3 Signal of a Trisonic Audio from the Physical Operation;

Thus, for the fourth set of coils (14a, 14b, 14c), the first coil (14a) is configured to circulate through it, a first electric current, which corresponds to the previously treated channel or signal LEFT or L of a stereophonic audio; consequently, the magnetic field generated by that first coil (14a) also contains the same content characteristics of the previously treated LEFT signal; On the other hand, the second coil (14b) is configured to circulate through it, a second electric current, which corresponds to the previously treated channel or signal X2 of a trisonic audio; consequently, the magnetic field generated by that second coil (14b) also contains the same content characteristics of the previously processed signal X2.

It is clear that the electric current of both the first and second coils (14a, 14b) are different from each other.

According to one modality, these audio signals L and X2 are driven by the action of the processing subsystem (20), which will be described in greater detail later. The processing subsystem (20) receives these signals, one from the input (21a) for the LEFT channel or signal and one from the output (27a) for the X2 channel or signal, each converting respectively into the first and second pre-treated electrical currents. Subsequently, the processing subsystem directs these first and second pre-treated electrical currents to the first and second coils (14a, 14b) respectively, through the outputs (33a) and (33b) as previously mentioned and illustrated.

Once the first and second pretreated electric currents are converted into the first and second magnetic fields and they have been collided to generate the third magnetic field, the third magnetic field is captured by the third coil or receiving coil (14c). As previously mentioned, this third magnetic field is the result of the magnetic collision between the previously processed LEFT and X2 audio signals.

Thus, once the receiving coil (14c) picks up the third magnetic field, the receiving coil (14c) is configured to convert the magnetic field into an electric current; This current is called the third electric current, which corresponds to the new X3 signal of a trisonic audio. Again, the third electric current or X3 contains the same characteristics as the contents of the third magnetic field.

The third electric current is then conducted from the receiving coil (14c) to the processing subsystem (20) through (33c); once inside the processing subsystem, this third X3 electric current receives a final treatment prior to its output.

Generation of the Y3 Signal of a Trisonic Audio from Physical Operation;

For the fifth set of coils (15a, 15b, 15c), the first coil (15a) is configured to circulate through it, a first electric current, which corresponds to the previously treated channel or signal RIGHT or R of a stereophonic audio; consequently, the magnetic field generated by that first coil (15a) also contains the same content characteristics of the previously processed RIGHT signal; On the other hand, the second coil (15b) is configured to circulate through it, a second electric current, which corresponds to the previously treated channel or signal Y2 of a trisonic audio; consequently, the magnetic field generated by that second coil (15b) also contains the same content characteristics of the previously processed signal Y2.

It is clear that the electric current of both the first and second coils (15a, 15b) are different from each other.

According to one modality, these audio signals R and Y2 are driven by the action of the processing subsystem (20), which will be described in more detail later. The processing subsystem (20) receives these signals, one from the input (21b) for the RIGHT channel or signal and one from the output (27b) for the channel or signal Y2, each converting respectively the first and second pre-treated electrical currents. Subsequently, the processing subsystem directs these first and second pre-treated electrical currents to the first and second coils (15a, 15b) respectively, through the outputs (34a) and (34b) as previously mentioned and illustrated.

Once the first and second pretreated electric currents are converted into the first and second magnetic fields and they have been collided to generate the third magnetic field, the third magnetic field is captured by the third coil or receiving coil (15c). As previously mentioned, this third magnetic field is the result of the magnetic collision between the previously processed RIGHT and Y2 audio signals.

Thus, once the receiving coil (15c) captures this third magnetic field, the receiving coil (15c) is configured to convert the magnetic field into an electric current; This current is called the third electric current, which corresponds to the new Y3 signal of a trisonic audio. Again, the third electric current or Y3 contains the same characteristics as the contents of the third magnetic field.

The third electric current is then conducted from the receiving coil (15c) to the processing subsystem (20) through (34c); once inside the processing subsystem, this third electric current Y3 receives a final treatment prior to its output.

Generation of the Z3 Signal of a Trisonic Audio from the Physical Operation;

For the sixth set of coils (16a, 16b, 16c), the first coil (16a) is configured to circulate through it, a first electric current, which corresponds to the previously treated channel or signal X3 of a trisonic audio; consequently, the magnetic field generated by that first coil (16a) also contains the same content characteristics of the previously processed signal X3; On the other hand, the second coil (16b) is configured to circulate through it, a second electric current, which corresponds to the previously treated channel or signal Y3 of a trisonic audio; consequently, the magnetic field generated by the second coil (16b) also contains the same content characteristics of the previously processed signal Y3.

It is clear that the electric current of both the first and second coils (16a, 16b) are different from each other.

According to one modality, these X3 and Y3 audio signals are driven by the action of the processing subsystem (20), which will be described in more detail later. The processing subsystem (20) receives these signals, one from the output (37a) for channel or signal X3 and one from the output (37b) for channel or signal Y3, each converting respectively into the first and second pre-treated electrical currents. Subsequently, the processing subsystem directs these first and second pre-treated electric currents to the first and second coils (16a, 16b) respectively, through the outputs (35a) and (35b) as previously mentioned and illustrated.

Once the first and second pretreated electric currents are converted into the first and second magnetic fields and they have been collided to generate the third magnetic field, the third magnetic field is captured by the third coil or receiving coil (16c). As previously mentioned, this third magnetic field is the result of the magnetic collision between the previously processed X3 and Y3 audio signals.

Thus, once the receiving coil (16c) picks up the third magnetic field, the receiving coil (16c) is configured to convert the magnetic field into an electric current; This current is called the third electric current, which corresponds to the new Z3 signal of a trisonic audio. Again, the third electric current or Z3 contains the same characteristics as the contents of the third magnetic field.

The third electric current is then conducted from the receiving coil (16c) to the processing subsystem (20) through (35c); once inside the processing subsystem, this third electric current Z3 receives a final treatment prior to its output.

However, it should be noted that the concept of pretreatment as previously and/or throughout the present application, in accordance with a modality of the present invention, the performance of this action is imperative, especially when applied to the input audio signals before they enter the coils of the invention being filed. This need is based on the premise that pretreatment is a critical step to ensure optimal system performance. The term “primarily” emphasizes that while pretreatment may have other applications, its priority application should target input audio signals in this specific context.

The reason behind this priority is that the input audio signals play a fundamental role in the overall operation of the invention, and their pre-treatment helps to optimize its quality and characteristics before they are processed by the subsystems or coil assemblies. This ensures that the signals entering the coils are in the ideal condition to obtain the desired results in terms of system performance and functionality.

It is also important to note that a person with ordinary knowledge in the field would understand that the generation of a third magnetic field, as used in the present invention, should not be interpreted as a pre-treatment process aimed at the subsequent creation of X, Y or Z signals. In reality, this third magnetic field already intrinsically contains the information and content of the definitive X, Y, or Z signals.

This nuance is fundamental to understanding the functioning and nature of this third magnetic field. Rather than being a preliminary step in the production of X, Y, or Z signals, this magnetic field itself represents the manifestation of those signals. Therefore, it is not a pre-processing phase aimed at preparing the signals for their subsequent generation, but at its origin it already incorporates the essential information for the formation of the desired signals.

This distinction is of great importance, as it highlights that the third magnetic field is not an intermediary, but the end product itself. Its content and characteristics are directly related to the X, Y, or Z signals that are sought to be generated, suggesting an intrinsic relationship between the third magnetic field and the final signals. Therefore, it should not be considered as a preliminary stage, but as the complete and definitive outcome of the process, which has significant implications for understanding and effectively using this phenomenon in practice.

Also, despite the fact that the third magnetic field already intrinsically incorporates the information related to the X, Y or Z signals, it is valid to say that it undergoes a final treatment in the processing subsystem before the output signals are delivered. This process should not be confused with a pre-treatment, since, as previously explained, the third magnetic field is essentially the desired end result.

The processing subsystem plays a critical role in further enhancing and tuning the characteristics of X, Y, or Z signals. During this phase, specific modifications are applied to ensure that the output signals meet the required standards in terms of quality, accuracy, or other necessary parameters. This final processing in the processing subsystem is carried out in order to refine the signals before they are delivered.

Consequently, it could be said that the third magnetic field constitutes the final result or the resulting signal X, Y or Z, and the processing subsystem is responsible for optimizing and adjusting the said output signals according to the particular needs and specifications. This differentiation between the third magnetic field and the processing subsystem is of vital importance to understand how the generation of X, Y, or Z signals is achieved with the highest accuracy and quality. The incorporation of this final treatment into the process underlines the sophistication and controllability of the system, ensuring that the output signals are optimal in terms of performance and utility.

Regarding the generation of the X3 signal of a trisonic audio from the physical operation previously referred to and with continuous reference to FIG. 8, it is important to highlight that, taking into account again the fourth set of coils (14a, 14b, 14c), the process of generating this X3 signal of a trisonic audio will be explained in detail below.

According to the present invention, the X3 signal of a trisonic audio is generated after the fusion of the X2 audio signal (A100/D50/−E50/−B100) with the L audio signal (A100/D75/C50/E25/B0), that is to say, the X3 audio signal is generated by causing a deletion and/or incorporation between the panning point values of X2 with the pan point values of L.

It will be clear at this point that such removal and/or incorporation of panning point values from the said X2 and LEFT signals is carried out in the interaction and collision of magnetic fields in physical space, as previously described.

To generate the X3 signal of a trisonic audio, the X2 audio signal with all its pan point values (A100/D50/−E50/−B100) is first injected into one of the generating coils; specifically, such X2 audio signal must be injected into the second generating coil (14b).

These panning values of the X2 audio signal are contained in an independent magnetic field and generated by the generator coil of the fourth set of coils.

At a second point, the LEFT audio signal with all its pan point values (A100/D75/C50/E25/B0) is injected into one of the generating coils; specifically, such a LEFT audio signal must be injected into the first generating coil (14a).

These panning values of the LEFT audio signal are contained in another independent magnetic field generated by the other generating coil of the fourth set of coils, and it is evident that this magnetic field is different and independent from the magnetic field that contains the panning values of the X2 audio signal.

The independent magnetic fields, generated by the generating coils of the fourth set of coils (14a, 14b), collide with each other to generate a third magnetic field that is independent and different from the first two fields previously described.

As described throughout this application, the collision or crashing between these magnetic fields causes a deletion and/or incorporation of the values of panning points contained in those magnetic fields generated by those generating coils, generating a third magnetic field with new values of panning points, these (A200/D125/C50/−E25/−B100), which correspond to the new X3 audio signal of a trisonic audio.

Consequently, the receiving coil (14c) of said fourth set of coils is configured to capture and convert the third magnetic field into an electric current called the third electric current, which must contain the said new X3 audio signal, whose panning values are (A200/D125/C50/−E25/−B100), which are necessary to form said first channel or signal of a trisonic audio.

Finally, according to a modality, the third electric current or new signal X3 will be conducted to a final treatment (36a) within the processing subsystem (20) so that the signal X3 will be consecutively connected to a subsequent playback system; the output of the said X3 audio signal after passing through the final treatment (36a) is done through (37a).

Regarding the generation of the Y3 signal of a trisonic audio from the previously referred physical operation and with continuous reference to FIG. 8, it is important to highlight that, taking into account again the fifth set of coils (15a, 15b, 15c), the process of generating said Y3 signal of a trisonic audio will be explained in detail below.

According to the present invention, the Y3 signal of a trisonic audio is generated after the fusion of the audio signal Y2 (−A100/−D50/E50/B100) with the audio signal R (A0/D25/C50/E75/B100), that is to say, the audio signal Y3 is generated by causing a deletion and/or incorporation between the pan point values of Y2 with the pan point values of R.

It will be clear at this point that such removal and/or incorporation of panning point values of the Y2 and RIGHT signals takes place in the interaction and collision of magnetic fields in physical space, as previously described.

To generate the Y3 signal of a trisonic audio, the Y2 audio signal with all its pan point values (−A100/−D50/E50/B100) is first injected into one of the generating coils; specifically, such an audio signal Y2 must be injected into the second generator coil (15b).

These panning values of the Y2 audio signal are contained in an independent magnetic field generated by the generator coil of the fifth set of coils.

At a second point, the RIGHT audio signal with all its pan point values (A0/D25/C50/E75/B100) is injected into one of the generating coils; specifically, such a RIGHT audio signal must be injected into the first generating coil (15a).

These panning values of the RIGHT audio signal are contained in another independent magnetic field generated by the other generating coil of the fifth set of coils, making it evident that this magnetic field is different and independent of the magnetic field containing the panning values of the audio signal Y2.

The independent magnetic fields, generated by the generating coils of the fifth set of coils (15a, 15b), collide with each other to generate a third magnetic field that is independent and different from the first two fields previously described.

As described throughout this application, the collision or crashing between these magnetic fields causes a deletion and/or incorporation of the values of panning points contained in those magnetic fields generated by those generating coils, generating a third magnetic field with new values of panning points, these (−A100/−D25/C50/E125/B200), which correspond to the new Y3 audio signal of a trisonic audio.

Consequently, the receiving coil (15c) of said fifth set of coils is configured to capture and convert the third magnetic field into an electric current called the third electric current, which must contain the said new audio signal Y3, whose panning values are (−A100/−D25/C50/E125/B200), which are necessary to form said second channel or signal of a trisonic audio.

Finally, according to a modality, the third electric current or new signal Y3 will be conducted to a final treatment (36b) within the processing subsystem (20) so that the signal Y3 will be consecutively connected to a subsequent playback system; the output of the said audio signal Y3 after passing through the final processing (36b) is done through (37b).

Regarding the generation of the Z3 signal of a trisonic audio from the previously mentioned physical operation and with continuous reference to FIG. 8, it is important to highlight that, taking into account again the sixth set of coils (16a, 16b, 16c), the process of generating this Z3 signal of a trisonic audio will be explained in detail below.

According to the present invention, the Z3 signal of a trisonic audio is generated after the fusion of the X3 audio signal (A200/D125/C50/−E25/−B100) with the Y3 audio signal (−A100/−D25/C50/E125/B200), that is to say, the Z3 audio signal is generated by causing a deletion and/or incorporation between the pan point values of X3 with the pan point values of Y3.

It will be clear at this point that such removal and/or incorporation of panning point values from X3 and Y3 signals takes place in the interaction and collision of magnetic fields in physical space, as previously described.

To generate the Z3 signal of a trisonic audio, the X3 audio signal with all its pan point values (A200/D125/C50/−E25/−B100) is first injected into one of the generating coils; specifically, such X3 audio signal must be injected into the first generating coil (16a).

These panning values of the X3 audio signal are contained in an independent magnetic field generated by the generator coil of the sixth set of coils.

At a second point, the Y3 audio signal with all its pan point values (−A100/−D25/C50/E125/B200) is injected into one of the generating coils; specifically, such an Y3 audio signal must be injected into the second generating coil (16b).

These panning values of the audio signal Y3 are contained in another independent magnetic field generated by the other generating coil of the sixth set of coils, making it clear that this magnetic field is different and independent of the magnetic field containing the panning values of the X3 audio signal.

The independent magnetic fields, generated by the generating coils of the sixth set of coils (16a, 16b), collide with each other to generate a third magnetic field independent of and different from the first two fields previously described.

As described throughout this application, the collision or crashing between these magnetic fields causes a deletion and/or incorporation of the values of panning points contained in those magnetic fields generated by those generating coils, generating a third magnetic field with new values of panning points, these (A100/D100/C100/E100/B100), which correspond to the new Z3 audio signal of a trisonic audio.

Consequently, the receiving coil (16c) of said sixth set of coils is configured to capture and convert the third magnetic field into an electric current called the third electric current, which must contain the said new Z3 audio signal, whose panning values are (A100/D100/C100/E100/B100), which are necessary to form said third channel or signal of a trisonic audio.

Finally, according to a modality, the third electric current or new signal Z3 will be conducted to a final treatment (36c) within the processing subsystem (20) so that the Z3 signal will be consecutively connected to a subsequent playback system; the output of the said Z3 audio signal after passing through the final treatment (36c) is done through (37c).

On the basis of the above, the process of generating a trisonic audio from stereophonic audio in accordance with the present invention describes a system capable of carrying out the processing, treatment and conversion of such stereophonic audio immediately, without delay between the input and output of the signal, and therefore, completely eliminating any presence of latency; This is achieved based on the aforementioned magnetic collision generated from the crashing between the magnetic fields, which generates a subsequent signal with panning values removed and/or incorporated.

Therefore, without necessarily being limited to the physics and theory involved, it has been demonstrated to obtain X, Y, Z channels or signals from a trisonic audio (one channel or signal for each set of coils) without latency or delay with respect to the input time of the audio signal.

In an optional modality, there may be from three to “n” number of coils for each coil subsystem or coil assembly (collider) with the characteristics described throughout this application, consequently generating from one to “n” number of collisions in each set of coils and therefore, consequently generating from one to “n” number of channels or signals of a trisonic audio in each set of coils, where the input signals to each set of coils (collider) are not limited to being signals of type L and R but could be 2 signals of any type, which may or may not be pre-treated.

According to one modality, the processing subsystem (20) is a processing medium configured to receive, first, the input audio signal, which according to the present invention, is stereophonic or two-channel audio referred to throughout this application as LEFT and RIGHT; on the other hand, that processing subsystem (20) is configured to receive the X, Y, Z signals of a trisonic audio once the coil subsystem or coil sets have performed the removal and/or incorporation of pan point values respectively, and finally, drive the resulting X, Y, Z signals to a subsequent trisonic audio playback system.

In this sense, the present invention can comprise from one to “n” processing subsystems; In one modality, such as the example of a modality illustrated in this application, this invention may comprise a processing subsystem (20) electrically connected to all three sets of coils, in addition, the outputs of such processing subsystem are or may be connected to a trisonic audio playback system; In an additional mode, each set of coils may comprise a processing subsystem (20) and is therefore not limited to the mode previously described or illustrated. On the contrary, it must be understood that the essence of this component is to distribute the input currents (LEFT, RIGHT) to the corresponding set of coils for the processing and conversion of such signals and subsequently, to receive the resulting signals already converted into a channel or signal X, Y, Z of a trisonic audio, as previously described. This processing subsystem, in an exemplary but not limited manner, comprises at least one selected component of at least one signal multiplier, one signal phaser, one signal splitter, one signal mixer, among others, and any configuration and/or combination thereof.

A subject matter expert may understand that such components of such a processing subsystem may be variable in terms of their nature, quantity, configuration, etc., as long as they fulfill the functions necessary to perform the pre-processing of the input signals and the final processing of the resulting signals.

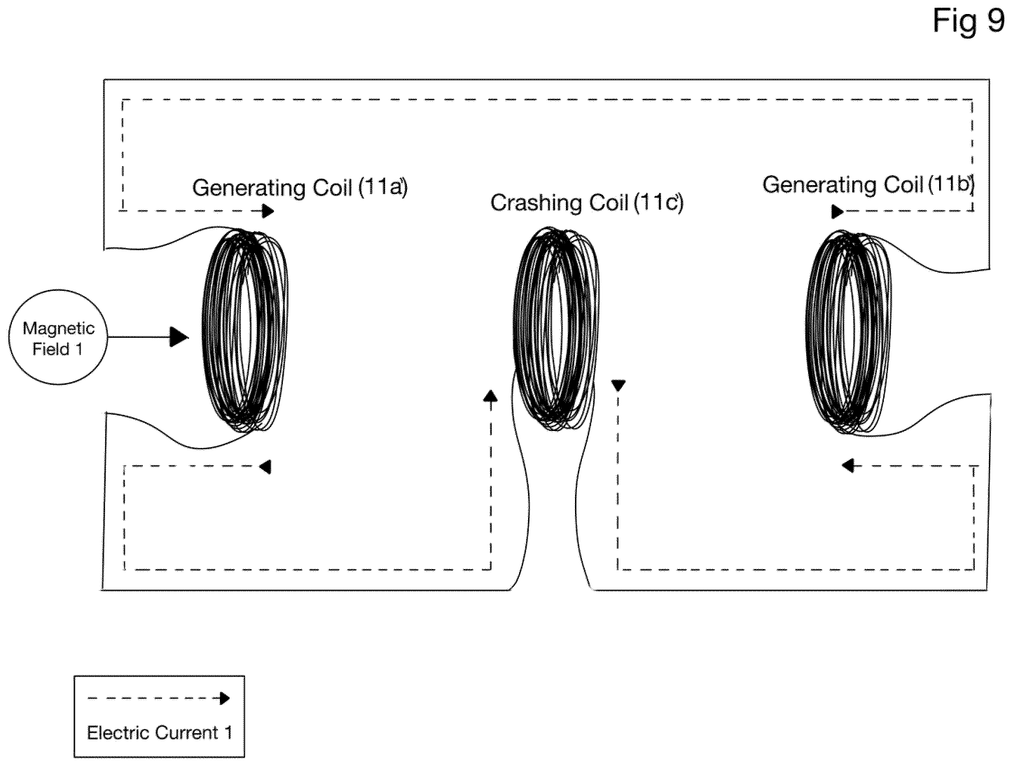

On the other hand, the present invention comprises two modalities for the generation of trisonic audio; According to a second modality of the present invention and as can be seen in FIGS. 9 to 12, the electrical collision system of the present invention is described as follows:

B) An electrical collision system to generate trisonic audio with zero latency (10′), such an electrical collision system is composed of at least two subsystems: (i) at least one coil subsystem or coil assembly and (ii) at least one processing subsystem (20′). In addition, the electric collision system (10′) collaborates directly with at least one trisonic audio playback system, which will be described in more detail later in this application. It should be noted that, in the context of the present invention, a coil subsystem is the same as a coil assembly and vice versa, therefore, it must be understood that, in the context of the present invention, such coil subsystem and such coil assembly represent the same thing and are therefore used in the same way to refer to the same elements of the present invention.

The electrical collision system (10′) of the present invention, without necessarily being limited in theory, is designed and configured in such a way that, based on the interaction of the supplied signals, it fuses by means of a collision or shock of electric currents of these signals.

A person with ordinary knowledge in the field may conclude from the teachings of this application that when two or more electrical currents interact with each other, for example, by colliding or crashing with each other in a controlled short circuit, the signals from them merge.

Therefore, the present invention, according to one modality, uses this principle to convert an input signal or signals (signal to be processed) into an output signal or signals (resultant signal processed), based on the collision of electric currents.

In order to improve the clarity of the physical concept of the electrical collision previously indicated, FIGS. 9 to 12 are taken as a reference, which show an example of a modality illustrating a first subsystem of coils (set of coils), where the effect of a first coil (11a′) can be observed, which captures a first magnetic field and transforms it into a first electric current and the effect of a second coil (11b′) which in turn captures a second magnetic field and transforms it into a second electric current, as well as the effect of a third coil (11c′) which generates a magnetic field resulting from the electric collision between the first electric current and the second electric current.

In the context of this explanation of the concept of electrical collision and in the entire description of the electrical collision system in this application, “first coil”, “second coil”, “generating coil” and/or “electric current generating coil” is to be understood as an element capable of capturing a magnetic field present within the physical space and converting or transforming that magnetic field into an electric current through it.

In addition, “third coil”, “crashing” or “crash coil of electric currents” is to be understood as an element capable of causing such electric currents to collide and generating a magnetic field resulting from such collision.

Such coils are usually made by winding a conductive wire over a core of ferromagnetic material or in the air. Coils in accordance with the present invention may be made of any suitable conductive material, the most commonly used material being enamelled copper wire; However, it must be understood that such coils are not limited to this particular material and that other appropriate materials may be used without departing from the teachings of the present invention.

Also, in the context of the present invention it should be understood that the coils may be at least three and up to “n” number of coils and is not necessarily limited to the number of coils illustrated in the Figures accompanying this invention.

As previously mentioned, the first electric current-generating coil (11a′) is configured to capture a first magnetic field and transform it into a first electric current; To achieve this task, a first magnetic field is generated by means of a first additional coil (not shown), and this first magnetic field comes into contact with said first coil (11a′), which will generate inside (in the winding of said first coil) a first electric current, which will leave the generating coil and return through the circuit path, as shown in FIG. 9.

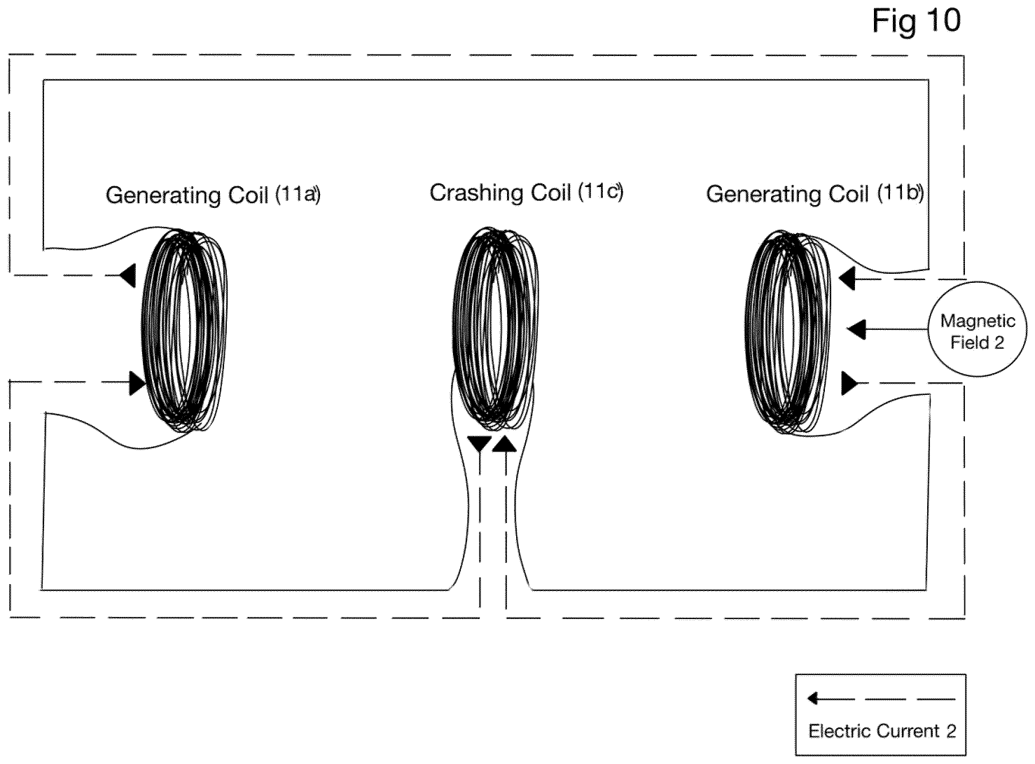

Similarly, the second electric current-generating coil (11b′) is configured to capture a second magnetic field and transform it into a second electric current; To achieve this task, a second magnetic field is generated by means of a second additional coil (not shown), and this second magnetic field comes into contact with said second coil (11b′), which will generate inside (in the winding of said second coil) a second electric current, which will leave the generating coil and return through the circuit path, as shown in FIG. 10.

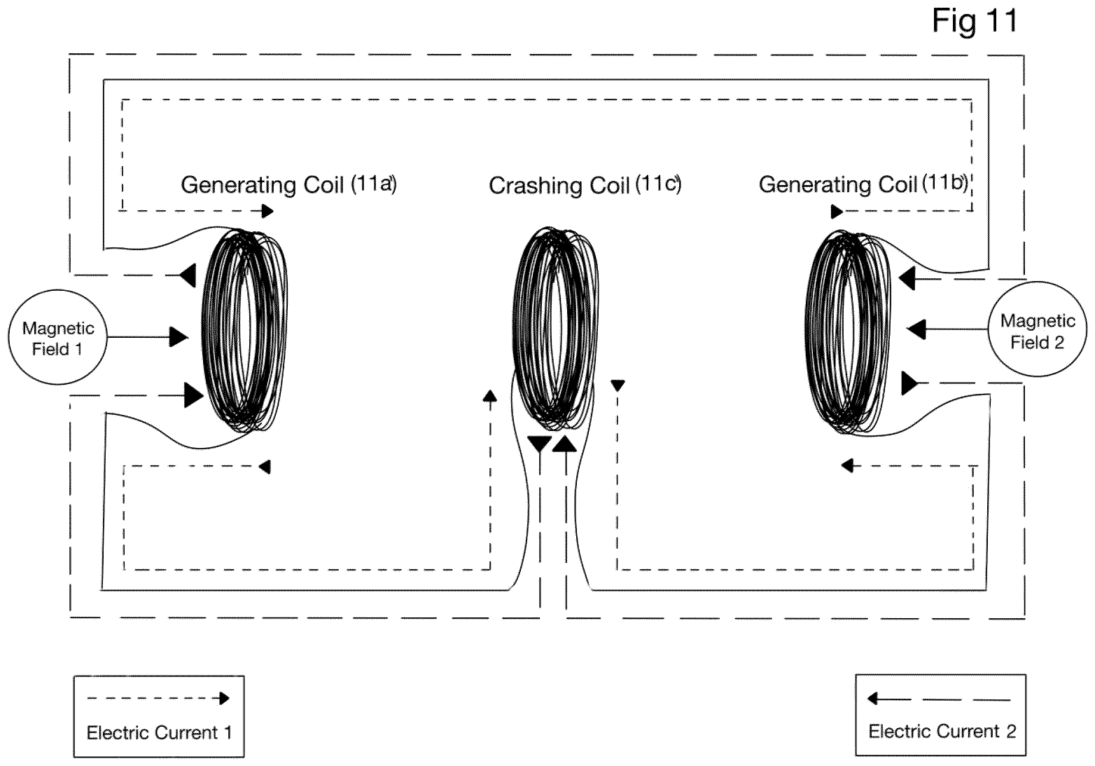

As can be seen in FIG. 11, these first and second generating coils (11a′, 11b′) are electrically connected to each other and to the crashing coil (11c′) and therefore the first electric current interacts with the second electric current throughout the circuit after they have collided with each other.

As will be clear, the first magnetic field generated by the first auxiliary coil (not shown) is different from the second magnetic field generated by the second auxiliary coil (not shown By “different” in this case, the content of the signal contained within the first magnetic field must be interpreted as different from the signal contained within the second magnetic field, so that each magnetic field will contain signals distinct from each other and the first and second electric currents converted by the first and second coil (11a′, 11b′) respectively will also contain signals that are different from each other.

It should be noted that in the context of the present invention, “signal content”, “content characteristics”, “signal characteristics” and/or the like, should be understood to refer to the information of pan point values that are part of an audio signal.

Once the first and second electric currents are generated respectively by the first and second coils (11a′, 11b′), they interact after they have collided with each other as shown in FIG. 11. Again, without necessarily being limited by the physics involved, a collision of electric currents is generated in the shock coil (11c′) causing a controlled short circuit, as shown in FIG. 11.

In the context of the present invention, “short circuit” is a condition where the electrical flow (electric current) completes its journey over a very short distance and particularly through a path or path of low resistance and/or null, since it does not pass through a resistive element, causing a very large increase in the intensity that circulates through the collision circuit;

Based on the above, being that the circuit according to a modality of the present invention, is composed only of the set of coils, the resistance of the circuit is very low, and therefore, once the first and second electric currents are generated as previously described, it gives rise to a short circuit along and/or within the referred circuit, which, in the context of invention, can also be referred to as a “collision circuit”.

However, by “controlled short circuit” the short circuit as described above is meant to be a desired effect of the present invention. Although a person with ordinary knowledge in the field will know that a short circuit is an undesired effect on an circuit, since it can cause unwanted and/or irreparable damage to it and/or to the electrically connected components in the circuit. For the present invention, the short circuit caused by the electric collision between the first and second electric currents in the third crashing coil is a totally beneficial and controlled effect because it will increase the intensity of the electric current that collides in said third coil, this increase in electric current is used to generate a third magnetic field in order to fulfill the object of the invention.

Once the first and second currents are generated by the first and second coils (11a′, 11b′) respectively, these first and second electric currents come into contact with each other by means of the crashing coil (11c′), generating or giving rise to a third electric current.

The collision of the signals contained in the first and second electric currents causes the information of these signals to be fused by means of the crashing coil (11c′), thus achieving that the third electric current has a totally different signal from the signal of the first and second electric currents.

It will be clear once reading this portion of the present invention that the third electric current and/or more specifically, the signal resulting from said third current will be achieved based on the characteristics of the content of the electric currents generated by the first and second coils. (11a′, 11b′) so that, after the collision between said currents, the signal of the third current is in accordance with the desired parameters and therefore, signal processing is achieved in a direct manner.

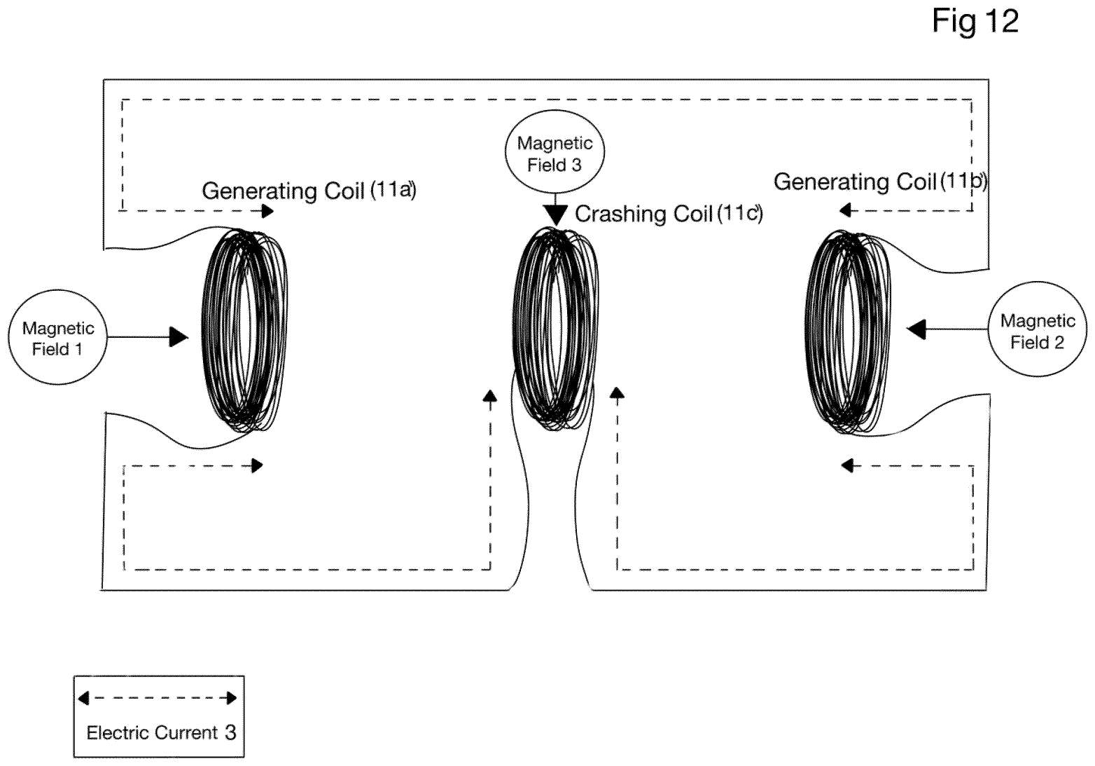

The crashing coil (11c′) is configured to circulate or conduct within it the third electric current and therefore the signal contained therein, and in addition, the said crashing coil (11c′) is configured to convert said third electric current into a magnetic field, preserving the content of the signal achieved after the electrical collision between the first and second electric currents, as shown in FIG. 12.

It is important to understand that according with the context of the present invention, a collider (coil subsystem, coil assembly) is characterized by being composed by a set of 3 independent and separate coils that in turn are mounted on the same iron core, that is, these 3 coils are in direct contact with said core but are not intertwined with each other, in addition, these coils may or may not be interconnected with each other, This will depend on its magnetic or electrical function. See FIG. 5.

The first (11a′), the second (11b′) and the third (11c′) coil, according to this mode of the present invention if they are electrically connected to each other; In other words, these coils are related to each other. As described throughout this application, signal fusion takes place in the collision circuit, in particular, through the interaction of the first and second electric currents generated by the respective first and second coils (11a′, 11b′); Therefore, the electric currents come into contact with each other by means of the crashing coil (11c′) once they reside in the circuit, causing a controlled short circuit.

In one mode, the first, second, and third coils (11a′, 11b′, 11c′) are arranged on a core. In a preferential mode, the coils (11a′, 11b′, 11c′) are arranged in an aligned manner in the nucleus and, more particularly, the nucleus can be arranged in such a way that it passes through the center of the coils (11a′, 11b′, 11c′), as shown in FIG. 5

Based on the theory of magnetic field induction, it is known that nuclei are used so that a magnetic field produced by magnetic field generating coils circulates through it; the characteristics and properties of the nucleus fulfill or allow to fulfill the function of maintaining the magnetic flux produced by the generating coils, avoiding to a large extent the losses produced by eddy currents; in other words, the core can be seen as a controlled pathway for the Magnetic Flux generated by the auxiliary coils (not shown) and picked up respectively by the first and second coils (11a′, 11b′).

Thus, the core allows the magnetic flux generated by the auxiliary coils (not shown) to travel through it, without significant losses and with it, the respective signals embedded in the first and second magnetic fields generated by the auxiliary coils (not shown) reach the physical space with their information intact and interact with the first and second coils (11a′, 11b′) to be subsequently transformed into electric currents as explained above.

In one modality, the core can be any core commonly used in electromagnetic induction applications, such core, in a preferred mode, can be a solid bar with a cross-section that can be any selected from the group comprising circular, square, rectangular, oval, polygonal, regular, irregular section areas, combinations thereof and/or similar. It should be understood that such a core is not limited to any particular material and that different types of appropriate materials may be used without departing from the teachings of the present invention.

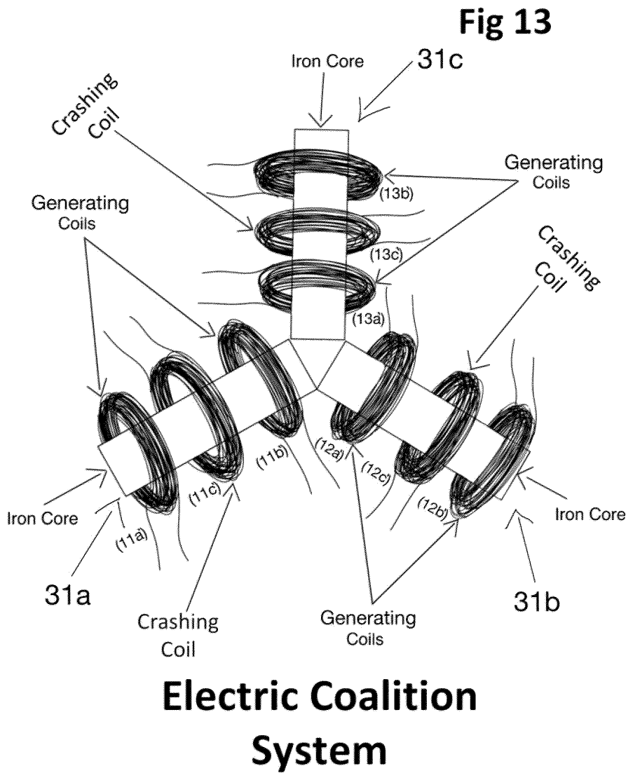

In addition, the core can take any selected shape from the group comprising a straight bar, a U-shaped, Y-shapped, E-shaped, T-shaped structure, it can have a continuous or discontinuous shape, it can be open or closed, combinations of the same or in general, any other form and dimension without necessarily the forms and provisions referred to above. In a preferred modality, the core is star-shaped or delta-shaped, with the different portions of the core being separated by 120°, as shown in FIG. 13 as a non-limiting example.

The core, in accordance with the present invention, may be made of any material selected from the group comprising solid iron, silicon steel, amorphous steel, iron carbonyl, ferrite ceramic, combinations thereof and/or materials with similar properties, in particular, which favour the passage of magnetic flux through it.

The first and second coils (11a′, 11b′), which, according to the present invention, are designed to capture, respectively, the first and second magnetic fields and convert them into the first and second electric currents in order to generate a third electric current resulting from the interaction of these first and second electric currents, which occurs in said third coil (11c′), In addition, these coils are configured to be arranged in an aligned manner, preferably concentrically with the core in the center, and so that the third coil is arranged between the first and second coils; However, the foregoing should not be interpreted to mean that the present invention is limited to the arrangement or arrangement referred to above, on the contrary, the foregoing arrangement favors that the magnetic field generated by the auxiliary coils (not shown) can be efficiently captured by said first and second coils (11a′, 11b′) and the third coil (11c′) can subsequently generate the magnetic field generated after the short circuit generated, However, other configurations, arrangements and/or arrangements may be used without departing from the teachings and spirit of this Invention.

Taking FIG. 13 as a reference again, in this example of a modality, the nucleus is configured in a monolithic way, forming a delta; According to this example of a modality, this nucleus is made up of three portions (31a′, 31b′, 31c′). In addition, a set of coils that are completely independent from each other are shown in each portion of the core.

According to this example of a modality, the system of the present invention comprises a first set of coils (11a′, 11b′, 11c′) arranged on a first portion of the core (31a′); a second set of coils (12a′, 12b′, 12c′) arranged on a second portion of core (31b′); and a third set of coils (13a′, 13b′, 13c′) arranged on a third portion of the core (31c′).

The first set of coils (11a′, 11b′, 11c′), arranged on the first portion of the core (31a′) consists of a first generating coil (11a′), a second generating coil (11b′) and a third coil, also called a crashing coil (11c′). In this example of modality, the crashing coil (11c′) is arranged between the first and second coils (11a′, 11b′), as shown in FIG. 13 referred to above.

The second set of coils (12a′, 12b′, 12c′), arranged on the second core portion (31b′) consists of a first generating coil (12a′), a second generating coil (12b′) and a third coil, also called a crashing coil (12c′). In this modality example, the crashing coil (12c′) is arranged between the first and second coils (12a′, 12b′), as shown in FIG. 13 referred to above.

The third set of coils (13a′, 13b′, 13c′), arranged on the third core portion (31c′) consists of a first generating coil (13a′), a second generating coil (13b′) and a third coil, also called a crashing coil (13c′). In this modality example, the crashing coil (13c′) is arranged between the first and second coils (13a′, 13b′), as shown in FIG. 13 referred to above.

It is important to understand that in an exemplary but not limited way, all the coils referenced so far are those necessary to generate the signals (X2, Y2, Z2) of the first mode of a trisonic audio, however, it is clear to understand that 3 other sets of coils configured in the same way could be used to generate the signals (X3, Y3, Z3) of the second mode of a trisonic audio.

Again, each and every one of the configurations or arrangements of the generating and crashing coils referred to above are examples of the modalities and other configurations may be used without departing from the teachings and spirit of the present invention.

As previously mentioned, the coil sets are completely independent from each other, that is to say, the first set of coils does not interfere either electrically or magnetically with the second or third set of coils, and the same applies to the second and third sets of coils; That is, each set of coils should ideally be considered as closed systems, that is to say, sets that are totally isolated from each other.

However, as previously mentioned, in this modality example, the generating coils (first and second coils) are electrically connected to their respective crashing coil (third coil), within each set of coils.

As mentioned above, there are two modes of trisonic audio, one composed of the X2, Y2, Z2 signals and one composed of the X3, Y3, Z3 signals.

It should be noted that the electrical collision system of the present invention is capable of generating both the X2, Y2 and Z2 signals as well as the X3, Y3 and Z3 signals. Below is the generation of the X2, Y2, Z2 signals.

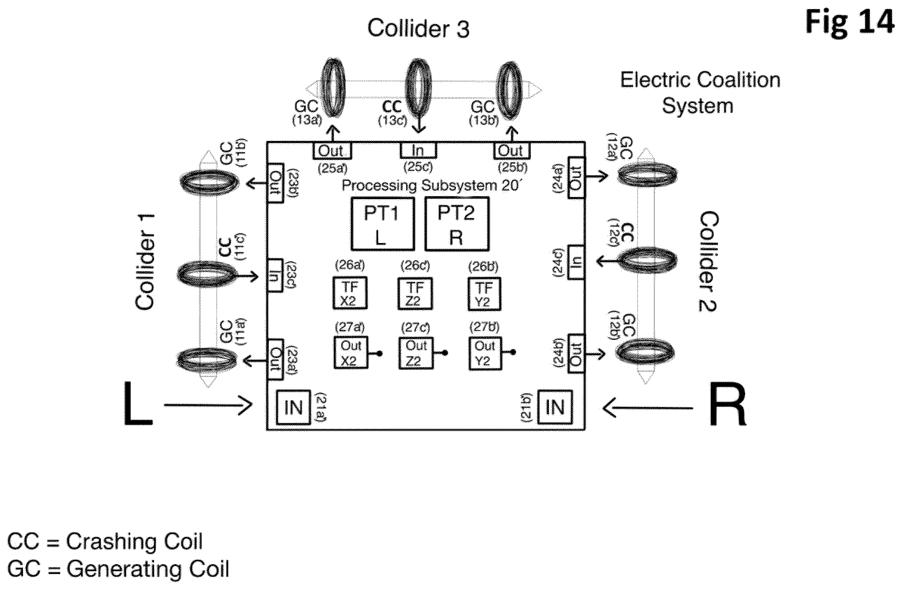

### Operation of the Electrical Collision System to Generate the Signals X2, Y2, Z2 of a Trisonic Audio (FIG. 14)

It is important to understand that, as mentioned previously, stereophonic audio is composed of two channels or audio signals (commonly known as the left signal (L or LEFT) and the right signal (R or RIGHT). However, a person skilled in the art will understand that the term “stereophonic” applies or refers in any of the modalities described throughout this application, to any audio comprising at least one pair and up to “n” number of pairs of channels or signals, by way of example, such audio may be any selected from the group comprising a 5.1 channel audio, 7.1 channels, 9.1 channels, among others; therefore, in the context of this invention, “stereophonic audio” should also be understood as any pair of channels or audio signals of type L and R that are part of any type of multichannel audio. Therefore, the electrical collision system of the present invention is capable of receiving from input any pair of channels or audio signals of type L and R, and also any pair of channels or signals of any type.

It should be mentioned that the outputs, inputs and other elements that are part of the processing subsystem and that will be referred to below, are only an example of a modality that allows to clearly and concisely illustrate the operation of said processing subsystem, therefore, it must be understood that the processing subsystem according to this invention can comprise up to “n” number of outputs, inputs or other elements and is not necessarily limited to the example of modality referred to in FIG. 14 accompanying this description.

Generation of the X2 Signal of a Trisonic Audio from the Physical Operation;

Thus, for the first set of coils (11a′, 11b′, 11c′), the first coil (11a′) is configured to capture a first magnetic field, generated by an auxiliary coil (not shown) and subsequently convert this first magnetic field into a first electric current, which can circulate through it (11a′); the signal embedded and/or injected into the first magnetic field generated by the auxiliary coil (not shown) corresponds to the previously treated LEFT or L channel or signal of a stereophonic audio; consequently, the magnetic field generated by the auxiliary coil (not shown), and more particularly, the electric current generated by the first generating coil (11a′) also contains the same characteristics of the content of the previously treated LEFT signal; On the other hand, the second coil (11b′) is configured to capture a second magnetic field, generated by an auxiliary coil (not shown) and subsequently convert this second magnetic field into a second electric current, which can circulate through it (11b′); the signal embedded and/or injected into the second magnetic field generated by the auxiliary coil (not shown) corresponds to the previously treated channel or signal RIGHT or R of a stereophonic audio; consequently, the magnetic field generated by the auxiliary coil (not shown), and more particularly, the electric current generated by the second generating coil (11b′) also contains the same characteristics of the content of the previously treated RIGHT signal.

It is clear that the first and second magnetic fields generated by the auxiliary coils (not shown) and more particularly, the electric current generated by both the first and second coils (11a′, 11b′) are different from each other.

According to one modality, the L and R signals of the stereophonic audio are driven by the action of the processing subsystem (20′), which will be described in more detail later. The processing subsystem (20′) receives the signals of this stereophonic audio, one at the input (21a′) for the LEFT channel or signal and one at the input (21b′) for the RIGHT channel or signal, each converting respectively into the first and second pre-treated electrical currents. Subsequently, the processing subsystem directs these first and second pre-treated electric currents to the first and second auxiliary coil (not shown) respectively, through the outputs (23a′) and (23b′) as previously mentioned and illustrated.

The first and second auxiliary coils (not shown) convert the stereophonic audio signals into magnetic fields, more particularly, into the first and second magnetic field, said first and second magnetic field being captured by the first and second generating coils (11a′, 11b′) which, as previously described, convert said fields into the first and second electric currents respectively. The first and second electric currents interact within the circuit shown that joins the three coils of the first set of coils (11a′, 11b′, 11c′), causing a controlled short circuit generated by the crashing coil (11c′), where Said controlled short circuit causes the interaction and fusion of the signals contained in the first and second currents previously referred to to generate a third electric current, which happens in the third coil or crashing coil (11c′). As previously mentioned, said third electrical current is the result of the electrical collision between the previously treated LEFT and RIGHT audio signals.

Thus, this choke coil (11c′) is configured to convert the third electric current into a magnetic field; This magnetic field is called the third magnetic field, which corresponds to the new X2 signal of a trisonic audio. Again, the third magnetic field or X2 contains the same characteristics as the content of the third electric current.

The third magnetic field is then generated by the choke coil (11c′), where, the third magnetic field enters the physical space of the processing subsystem (20′); According to this example of a modality, the processing subsystem (20′) comprises a receiver coil (not shown) configured to capture the third magnetic field and convert it into an electric current, which is conducted into the processing subsystem (20′) through (23c′); It will be clear that the receiving coil (not shown) of the processing subsystem (20′) is configured to capture and convert the third magnetic field into an electric current, which can be referred to as a fourth electric current, which corresponds to the new signal X2 wherein this fourth electric current or X2 contains the same characteristics as the content of the third electric current. Once inside the processing subsystem, the fourth stream or X2 receives a final treatment prior to its output.

Generation of Y2 Signal of a Trisonic Audio from Physical Operation;

For the second set of coils (12a′, 12b′, 12c′), the first coil (12a′) is configured to capture a first magnetic field, generated by an auxiliary coil (not shown) and subsequently, convert said first magnetic field in a first electric current, which can circulate through it (12a′); the signal embedded and/or injected in said first magnetic field generated by the auxiliary coil (not shown) corresponds to the channel or previously treated signal LEFT or L of a stereophonic audio; consequently, the magnetic field generated by the auxiliary coil (not shown), and more particularly, the electric current generated by the first generating coil (12a′) also contains the same characteristics of the content of the previously processed signal LEFT; On the other hand, the second coil (12b′) is configured to capture a second magnetic field, generated by an auxiliary coil (not shown) and subsequently, convert said second magnetic field into a second electric current, which can circulate through the same (12b′); The signal embedded and/or injected into said second magnetic field generated by the auxiliary coil (not shown) corresponds to the previously treated RIGHT or R channel or signal of stereophonic audio; Consequently, the magnetic field generated by the auxiliary coil (not shown), and more particularly, the electric current generated by the second generating coil (12b′) also contains the same characteristics of the content of the previously processed signal RIGHT.

It is clear that the first and second magnetic fields generated by the auxiliary coils (not shown) and more particularly, the electric current generated by both the first and second coils (12a′, 12b′) are different from each other.

According to one modality, the L and R signals of the stereophonic audio are driven by the action of the processing subsystem (20′), which will be described in more detail later. The processing subsystem (20′) receives the signals of this stereophonic audio, one at the input (21a′) for the LEFT channel or signal and one at the input (21b′) for the RIGHT channel or signal, each converting respectively into the first and second pre-treated electrical currents. Subsequently, the processing subsystem directs these first and second pre-treated electrical currents to the first and second auxiliary coil (not shown) respectively, through the outputs (24a′) and (24b′) as previously mentioned and illustrated.

The first and second auxiliary coils (not shown) convert the stereophonic audio signals into magnetic fields, more particularly, into the first and second magnetic field, said first and second magnetic field being captured by the first and second generating coils (12a′, 12b′) which, as previously described, convert said fields into the first and second electric currents respectively. The first and second electric currents interact within the circuit shown that joins the three coils of the second set of coils (12a′, 12b′, 12c′), causing a controlled short circuit generated by the crashing coil (12c′), where Said controlled short circuit causes the interaction and fusion of the signals contained in the first and second currents previously referred to to generate a third electric current, which happens in the third coil or crashing coil (12c′). As previously mentioned, said third electrical current is the result of the electrical collision between the previously treated LEFT and RIGHT audio signals.

Thus, this crashing coil (12c′) is configured to convert this third electric current into a magnetic field; This magnetic field is called the third magnetic field, which corresponds to the new Y2 signal of a trisonic audio. Again, the third magnetic field or Y2 contains the same characteristics as the content of the third electric current.

The third magnetic field is then generated by the crashing coil (12c′), wherein, the third magnetic field enters the physical space of the processing subsystem (20′); According to this example of a modality, the processing subsystem (20′) comprises a receiver coil (not shown) configured to capture the third magnetic field, and convert it into an electric current, which is conducted into the processing subsystem (20′) through (24c′); It will be clear that the receiving coil (not shown) of the processing subsystem (20′) is configured to capture and convert the third magnetic field into an electric current, which can be referred to as a fourth electric current, which corresponds to the new signal Y2 wherein this fourth electric current or Y2 contains the same characteristics as the content of the third electric current. Once inside the processing subsystem, the fourth electric current or Y2 receives a final treatment prior to its output.

Generation of the Z2 Signal of a Trisonic Audio from Physical Operation;

For the third set of coils (13a′, 13b′, 13c′), the first coil (13a′) is configured to capture a first magnetic field, generated by an auxiliary coil (not shown) and subsequently, convert said first magnetic field in a first electric current, which can circulate through it (13a′); the signal embedded and/or injected in said first magnetic field generated by the auxiliary coil (not shown) corresponds to the channel or previously treated signal LEFT or L of a stereophonic audio; consequently, the magnetic field generated by the auxiliary coil (not shown), and more particularly, the electric current generated by the first generating coil (13a′) also contains the same characteristics of the content of the previously processed signal LEFT; On the other hand, the second coil (13b′) is configured to capture a second magnetic field, generated by an auxiliary coil (not shown) and subsequently, convert said second magnetic field into a second electric current, which can circulate through it (13b′); The signal embedded and/or injected into said second magnetic field generated by the auxiliary coil (not shown) corresponds to the previously treated RIGHT or R channel or signal of stereophonic audio; Consequently, the magnetic field generated by the auxiliary coil (not shown), and more particularly, the electric current generated by the second generating coil (13b′) also contains the same characteristics of the content of the previously processed signal RIGHT.

It is clear that the first and second magnetic fields generated by the auxiliary coils (not shown) and more particularly, the electric current generated by both the first and second coils (13a′, 13b′) are different from each other.

According to one modality, the L and R signals of the stereophonic audio are driven by the action of the processing subsystem (20′), which will be described in more detail later. The processing subsystem (20′) receives the signals of this stereophonic audio, one at the input (21a′) for the LEFT channel or signal and one at the input (21b′) for the RIGHT channel or signal, each converting respectively into the first and second pre-treated electrical currents. Subsequently, the processing subsystem directs these first and second pre-treated electrical currents to the first and second auxiliary coil (not shown) respectively, through the outputs (25a′) and (25b′) as previously mentioned and illustrated.

The first and second auxiliary coils (not shown) convert the stereophonic audio signals into magnetic fields, more particularly, into the first and second magnetic field, said first and second magnetic field being captured by the first and second generating coils (13a′, 13b′) which, as previously described, convert said fields into the first and second electric currents respectively. The first and second electric currents interact within the circuit shown that joins the three coils of the third set of coils (13a′, 13b′, 13c′), causing a controlled short circuit generated by the crashing coil (13c′), where Said controlled short circuit causes the interaction and fusion of the signals contained in the first and second currents previously referred to to generate a third electric current, which happens in the third coil or crashing coil (13c′). As previously mentioned, said third electrical current is the result of the electrical collision between the previously treated LEFT and RIGHT audio signals.

Thus, this crashing coil (13c′) is configured to convert this third electric current into a magnetic field; This magnetic field is called the third magnetic field, which corresponds to the new Z2 signal of a trisonic audio. Again, the third magnetic field or Z2 contains the same characteristics as the content of the third electric current.

The third magnetic field is then generated by the crashing coil (13c′), wherein, the third magnetic field enters the physical space of the processing subsystem (20′); According to this example of a modality, the processing subsystem (20′) comprises a receiver coil (not shown) configured to capture the third magnetic field, and convert it into an electric current, which is conducted into the processing subsystem (20′) through (25c′); It will be clear that the receiving coil (not shown) of the processing subsystem (20′) is configured to capture and convert the third magnetic field into an electric current, which can be referred to as a fourth electric current, which corresponds to the new signal Z2 wherein this fourth electric current or Z2 has the same characteristics as the content of the third electric current. Once inside the processing subsystem, the fourth stream or Z2 receives a final treatment prior to its output.

However, it should be noted that the concept of pretreatment as previously and/or throughout this application, in accordance with a modality of the present invention, the performance of this action is imperative, especially when applied to the IN audio signals before they enter the coils of the invention being filed. This need is based on the premise that pretreatment is a critical step to ensure optimal system performance. The term “primarily” emphasizes that while pretreatment may have other applications, its priority application should target the IN audio signals in this specific context.

The reason behind this priority is that the IN audio signals play a fundamental role in the overall operation of the invention, and their pre-treatment helps to optimize their quality and characteristics before they are processed by the subsystems or coil assemblies. This ensures that the signals entering the coils are in the ideal condition to obtain the desired results in terms of system performance and functionality.

It is also important to note that a person with ordinary knowledge in the field would understand that the generation of a third magnetic field, as used in the present invention, should not be interpreted as a pre-treatment process aimed at the subsequent creation of X, Y or Z signals. In reality, this third magnetic field already intrinsically contains the information and content of the definitive X, Y, or Z signals.

This nuance is fundamental to understanding the functioning and nature of this third magnetic field. Rather than being a preliminary step in the production of X, Y, or Z signals, this magnetic field itself represents the manifestation of those signals. Therefore, it is not a pre-processing phase aimed at preparing the signals for their subsequent generation, but at its origin it already incorporates the essential information for the formation of the desired signals.

This distinction is of great importance, as it highlights that the third magnetic field is not an intermediary, but the end product itself. Its content and characteristics are directly related to the X, Y, or Z signals that are sought to be generated, suggesting an intrinsic relationship between the third magnetic field and the final signals. Therefore, it should not be considered as a preliminary stage, but as the complete and definitive outcome of the process, which has significant implications for understanding and effectively using this phenomenon in practice.

Also, despite the fact that the third magnetic field already intrinsically incorporates the information related to the X, Y or Z signals, it is valid to say that it undergoes a final treatment in the processing subsystem before the output signals are delivered. This process should not be confused with a pre-treatment, since, as previously explained, the third magnetic field is essentially the desired end result.

The processing subsystem plays a critical role in further enhancing and tuning the characteristics of X, Y, or Z signals. During this phase, specific modifications are applied to ensure that the output signals meet the required standards in terms of quality, accuracy, or other necessary parameters. This final processing in the processing subsystem is carried out in order to refine the signals before they are delivered.

Consequently, it could be said that the third magnetic field constitutes the final result or the resulting signal X, Y or Z, and the processing subsystem is responsible for optimizing and adjusting the said X, Y or Z output signals according to the particular needs and specifications. This differentiation between the third magnetic field and the processing subsystem is of vital importance to understand how the generation of X, Y, or Z signals is achieved with the highest accuracy and quality. The incorporation of this final treatment into the process underlines the sophistication and controllability of the system, ensuring that the output signals are optimal in terms of performance and utility.

Regarding the generation of the X2 signal of a trisonic audio from the previously referred physical operation and with continuous reference to FIG. 14, it is important to highlight that, taking into account again the first set of coils (11a′, 11b′, 11c′), the process of generating this X2 signal of a trisonic audio will be explained in detail below.

As mentioned earlier in this document, stereo audio is composed of two different audio signals: LEFT and RIGHT, where the LEFT signal contains the pan point values (A100/D75/C50/E25/B0) and the RIGHT signal contains the pan point values (A0/D25/C50/E75/B100); According to the present invention, the X2 signal of a trisonic audio is generated by the fusion between the audio signal R at 180° (−A0/−D25/−C50/−E75/−B100) with the audio signal L (A100/D75/C50/E25/B0), that is to say, the X2 signal of a trisonic audio is generated by causing a deletion and/or incorporation between the values of pan points of R at 180° with the values of L. panning points.

It will be clear at this point that said elimination and/or incorporation of panning point values of the said LEFT and RIGHT signals at 180° is carried out in the interaction and collision of electric currents due to the action or effect of the controlled short circuit carried out. carried out in the collision circuit, as previously described.

To generate the X2 signal of a trisonic audio, the RIGHT audio signal with all its values of pan points at 180° (−A0/−D25/−C50/−E75/−B100) is injected into one of the auxiliary coils (not shown), where subsequently, said auxiliary coil converts the electric current into a magnetic field containing the RIGHT signal at 180°; additionally, the magnetic field generated by one of the auxiliary coils (not shown) is captured by one of the generating coils; Specifically, this magnetic field must be picked up by the second generating coil (11b′).

At a second point, the LEFT audio signal with all its pan point values (A100/D75/C50/E25/B0) is injected into one of the auxiliary coils (not shown), where the auxiliary coil then converts the electric current into a magnetic field containing the LEFT signal; additionally, the magnetic field generated by one of the auxiliary coils (not shown) is captured by one of the generating coils; Specifically, this magnetic field must be picked up by the first generating coil (11A′).

As described throughout this description and according to this example of a modality, these panning values of LEFT and RIGHT at 180° are respectively and independently contained in each magnetic field generated by the auxiliary coils, each containing the panning values of its respective signal.

Similarly, once the first and second magnetic fields are captured by the first and second generating coils (11a′, 11b′), the first and second generating coils (11a′, 11b′) are configured to convert the first and second magnetic fields into a first and second electric currents respectively.

The first electric current L is or can be present inside the first generating coil (11a′) while the second electric current R a 180° is or can be present inside the second generating coil (11b′).

The first and second electric currents, independent from each other at the instants where they are generated by the first and second generating coils (11a′, 11b′) then circulate to the collision circuit, where they collide with each other in the crashing coil (11c′) generating a controlled short circuit.

The controlled short circuit generated by the crashing coil (11c′), as described throughout this application and according to this example of the modality, gives rise to or generates a third electric current independent of and different from the first two electric currents previously described. The collision or shock between these first and second electric currents occurring in the shock coil (11c′) causes a removal and/or incorporation of the values of panning points contained in the first and second electric currents generated by these generating coils (11a′, 11b′), creating or giving rise to a third electric current with new values of panning points, These (A100/D50/−E50/−B100), correspond to the new X2 audio signal of a trisonic audio.

Consequently, the crashing coil (11c′) is configured to convert this third electric current into a third magnetic field; In turn, this third magnetic field enters the physical space of a receiver coil (not shown) of the processing subsystem (20′), which is configured to capture the third magnetic field and convert it into a fourth electric current.

As previously described, this fourth electric current comprises the eliminated and/or incorporated panning values derived from the controlled short circuit, contained in the third magnetic field; therefore, this fourth electric current contains the X2 audio signal, whose panning values are (A100/D50/−E50/−B100), which are necessary to form a first channel or signal of a trisonic audio.

Finally, according to a modality, said fourth electric current or signal X2 will be conducted to a final treatment (26a′) within the processing subsystem (20′) so that consecutively said signal X2 is connected to a subsequent playback system; the output of the said X2 audio signal after passing through the final treatment (26a′) is done through (27a′).

Regarding the generation of the Y2 signal of a trisonic audio from the previously referred physical operation and with continuous reference to FIG. 14, it is important to highlight that, taking into account again the second set of coils (12a′, 12b′, 12c′), the process of generating this Y2 signal of a trisonic audio will be explained in detail below.

As mentioned earlier in this document, stereo audio is composed of two different audio signals: LEFT and RIGHT, where the LEFT signal contains the pan point values (A100/D75/C50/E25/B0) and the RIGHT signal contains the pan point values (A0/D25/C50/E75/B100); According to the present invention, the Y2 signal of a trisonic audio is generated after the fusion between the audio signal L at 180° (−A100/−D75/−C50/−E25/−B0) with the audio signal R (A0/D25/C50/E75/B100), that is to say, the signal Y2 of a trisonic audio is generated by causing a deletion and/or incorporation between the values of pan points of L at 180° with the values of R panning points.

It will be clear at this point that said elimination and/or incorporation of panning point values of the said LEFT signals at 180° and RIGHT is carried out in the interaction and collision of electric currents due to the action or effect of the controlled short circuit carried out in the collision circuit, as previously described.

To generate the Y2 signal of a trisonic audio, the LEFT audio signal with all its panorama point values at 180° (−A100/−D75/−C50/−E25/−B0) is injected into one of the auxiliary coils (not shown), where the auxiliary coil then converts the electric current into a magnetic field containing the LEFT signal at 180°; additionally, the magnetic field generated by one of the auxiliary coils (not shown) is captured by one of the generating coils; Specifically, this magnetic field must be picked up by the second generating coil (12b′).

At a second point, the RIGHT audio signal with all its pan point values (A0/D25/C50/E75/B100) is injected into one of the auxiliary coils (not shown), where the auxiliary coil then converts the electric current into a magnetic field containing the RIGHT signal; additionally, the magnetic field generated by one of the auxiliary coils (not shown) is captured by one of the generating coils; Specifically, this magnetic field must be picked up by the first generating coil (12A′).

As described throughout this description and according to this example of a modality, these panning values of LEFT at 180° and RIGHT are respectively and independently contained in each magnetic field generated by the auxiliary coils, each containing the panning values of its respective signal.

Similarly, once the first and second magnetic fields are captured by the first and second generating coils (12a′, 12b′), the first and second generating coils (12a′, 12b′) are configured to convert the first and second magnetic fields into a first and second electric currents respectively.

The first electric current R will be or may be present within the first generating coil (12a′) while the second electric current L at 180° is or may be present within the second generating coil (12b′).

The first and second electric currents, independent from each other at the instants where they are generated by the first and second generating coils (12a′, 12b′) then circulate to the collision circuit, where they collide with each other in the crashing coil (12c′) generating a controlled short circuit.

The controlled short circuit generated by the crashing coil (12c′), as described throughout this application and according to this example of the modality, gives rise to or generates a third electric current independent of and different from the first two electric currents previously described. The collision or shock between these first and second electric currents occurring in the crashing coil (12c′) causes a deletion and/or incorporation of the values of panning points contained in the first and second electric currents generated by these generating coils (12a′, 12b′), creating or giving rise to a third electric current with new values of panning points, These (−A100/−D50/E50/B100), which correspond to the new Y2 audio signal of a trisonic audio.

Consequently, the crashing coil (12c′) is configured to convert this third electric current into a third magnetic field; In turn, this third magnetic field enters the physical space of a receiver coil (not shown) of the processing subsystem (20′), which is configured to capture the third magnetic field and convert it into a fourth electric current.

As previously described, this fourth electric current comprises the eliminated and/or incorporated panning values derived from the controlled short circuit, contained in the third magnetic field; therefore, this fourth electric current contains the audio signal Y2, whose panning values are (−A100/−D50/E50/B100), which are necessary to form a second channel or signal of a trisonic audio.

Finally, according to a modality, this fourth electric current or signal Y2 will be conducted to a final treatment (26b′) within the processing subsystem (20′) so that consecutively said signal Y2 is connected to a subsequent playback system; the output of the said audio signal Y2 after passing through the final treatment (26b′) is done through (27b′).

Regarding the generation of the Z2 signal of a trisonic audio from the previously referred physical operation and with continuous reference to FIG. 14, it is important to highlight that, taking into account again the third set of coils (13a′, 13b′, 13c′), the process of generating this Z2 signal of a trisonic audio will be explained in detail below.

As mentioned earlier in this document, stereo audio is composed of two different audio signals: LEFT and RIGHT, where the LEFT signal contains the pan point values (A100/D75/C50/E25/B0) and the RIGHT signal contains the pan point values (A0/D25/C50/E75/B100); According to the present invention, the Z2 signal of a trisonic audio is generated after the fusion of the audio signal R (A0/D25/C50/E75/B100) with the audio signal L (A100/D75/C50/E25/B0), that is to say, the Z2 signal of a trisonic audio is generated by causing a deletion and/or incorporation between the pan point values of R with the pan point values of L.

It will be clear at this point that such removal and/or incorporation of panning point values of the said LEFT and RIGHT signals is carried out in the interaction and shock of electric currents by the action or effect of the controlled short circuit carried out in the collision circuit, as previously described.

To generate the Z2 signal of a trisonic audio, the RIGHT audio signal with all its pan point values (A0/D25/C50/E75/B100) is first injected into one of the auxiliary coils (not shown), where the auxiliary coil then converts the electric current into a magnetic field containing the RIGHT signal; additionally, the magnetic field generated by one of the auxiliary coils (not shown) is captured by one of the generating coils; Specifically, this magnetic field must be picked up by the second generating coil (13b′).

At a second point, the LEFT audio signal with all its pan point values (A100/D75/C50/E25/B0) is injected into one of the auxiliary coils (not shown), where the auxiliary coil then converts the electric current into a magnetic field containing the LEFT signal; additionally, the magnetic field generated by one of the auxiliary coils (not shown) is captured by one of the generating coils; Specifically, this magnetic field must be picked up by the first generating coil (13A′).

As described throughout this description and according to this example of a modality, these panning values of LEFT and RIGHT are respectively and independently contained in each magnetic field generated by the auxiliary coils, each containing the panning values of its respective signal.

Similarly, once the first and second magnetic fields are captured by the first and second (13a′, 13b′) generating coils, the first and second generating coils (13a′, 13b′) are configured to convert the first and second magnetic fields into a first and second electric currents respectively.

The first electric current L will be or may be present within the first generating coil (13a′) while the second electric current R is or may be present within the second generating coil (13b′).

The first and second electric currents, independent from each other at the instants where they are generated by the first and second generating coils (13a′, 13b′) then circulate to the collision circuit, where they collide with each other in the crashing coil (13c′) generating a controlled short circuit.

The controlled short circuit generated by the crashing coil (13c′), as described throughout this application and in accordance with this example of the modality, gives rise to or generates a third electric current independent of and different from the first two electric currents previously described. The collision or shock between these first and second electric currents occurring in the crashing coil (13c′) causes a removal and/or incorporation of the values of panning points contained in the first and second electric currents generated by these generating coils (13a′, 13b′), creating or giving rise to a third electric current with new values of panning points, these (A100/D100/C100/E100/B100), which correspond to the new Z2 audio signal of a trisonic audio.

Consequently, the crashing coil (13c′) is configured to convert this third electric current into a third magnetic field; In turn, this third magnetic field enters the physical space of a receiver coil (not shown) of the processing subsystem (20′), which is configured to capture the third magnetic field and convert it into a fourth electric current.

As previously described, this fourth electric current comprises the eliminated and/or incorporated panning values derived from the controlled short circuit, injected into the third magnetic field; therefore, this fourth electric current contains the Z2 audio signal, whose panning values are (A100/D100/C100/E100/B100), which are necessary to form a third channel or signal of a trisonic audio.

Finally, according to a modality, this fourth electric current or Z2 signal will be conducted to a final treatment (26c′) within the processing subsystem (20′) so that the Z2 signal is consecutively connected to a subsequent playback system; the output of the said Z2 audio signal after passing through the preamplifier (26c′) is done through (27c′).

Below is the generation of the X3, Y3, Z3 signals.

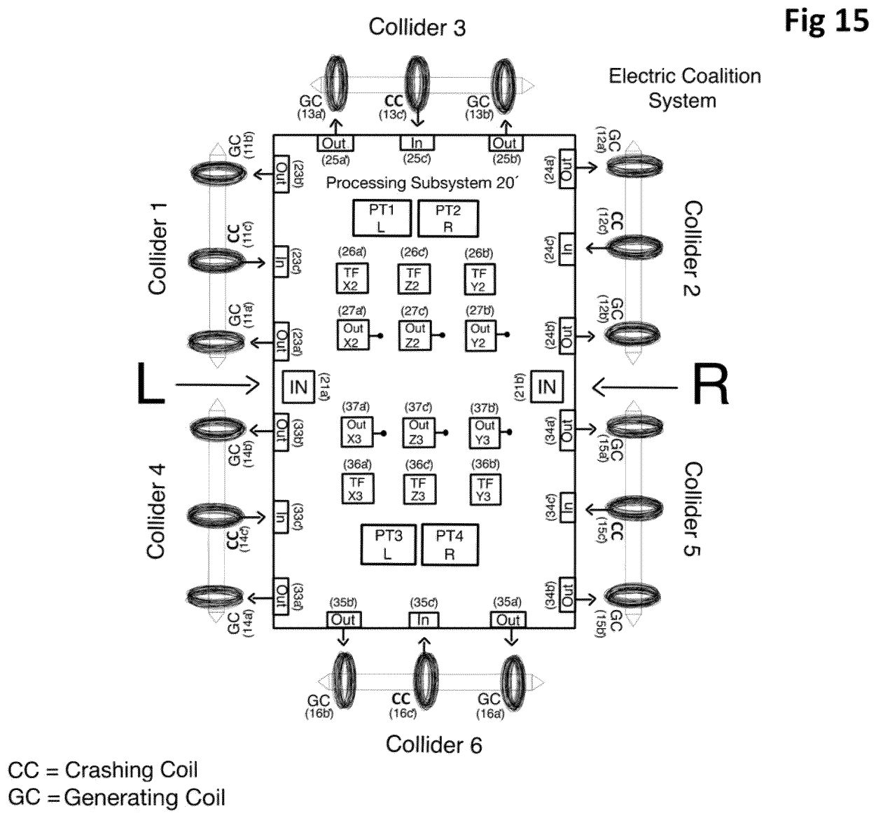

### Operation of the Electrical Collision System to Generate X3, Y3, Z3 Signals of Trisonic Audio (FIG. 15)

It is important to understand that to generate the X3, Y3, Z3 signals of a trisonic audio it is necessary to use the L and R signals of a stereophonic audio but it is also necessary to use the X2, Y2, Z2 signals previously generated, therefore, FIG. 15 is shown as a reference in which the sets of coils used to generate these X2, Y2, Z2 However, it should be understood that these FIGS. 14 and 15 are shown in an exemplary but not limited way with the intention of facilitating the understanding of the generation of the signals of a trisonic audio in any of its modalities.

It should be mentioned that the outputs, inputs and other elements that are part of the processing subsystem and that will be referred to below, are only an example of a modality that allows to clearly and concisely illustrate the operation of said processing subsystem, therefore, it must be understood that the processing subsystem according to this invention can comprise up to “n” number of outputs, inputs or other elements and is not necessarily limited to the example of modality referred to in FIGS. 14 and 15 accompanying this description.

Generation of the X3 Signal of a Trisonic Audio from the Physical Operation;

Thus, for the fourth set of coils (14a′, 14b′, 14fc′), the first coil (14a′) is configured to capture a first magnetic field, generated by an auxiliary coil (not shown) and subsequently, convert said first magnetic field in a first electric current, which can circulate through it (14a′); The signal embedded and/or injected in said first magnetic field generated by the auxiliary coil (not shown) corresponds to the channel or previously treated signal LEFT or L of a stereophonic audio; consequently, the magnetic field generated by the auxiliary coil (not shown), and more particularly, the electric current generated by the first generating coil (14a′) also contains the same characteristics of the content of the previously processed signal LEFT; On the other hand, the second coil (14b′) is configured to capture a second magnetic field, generated by an auxiliary coil (not shown) and subsequently, convert said second magnetic field into a second electric current, which can circulate through it (14b′); The signal embedded and/or injected in said second magnetic field generated by the auxiliary coil (not shown) corresponds to the channel or previously treated signal X2 of a trisonic audio; Consequently, the magnetic field generated by the auxiliary coil (not shown), and more particularly, the electric current generated by the second generating coil (14b′) also contains the same characteristics of the content of the previously processed signal X2.

It is clear that the first and second magnetic fields generated by the auxiliary coils (not shown) and more particularly, the electric current generated by both the first and second coils (14a′, 14b′) are different from each other.

According to one modality, these audio signals L and X2 are driven by the action of the processing subsystem (20′), which will be described in more detail later. The processing subsystem (20′) receives these signals, one from the input (21a′) for the LEFT channel or signal and one from the output (27a′) for the X2 channel or signal, each converting respectively into the first and second pre-treated electrical currents. Subsequently, the processing subsystem directs these first and second pre-treated electrical currents to the first and second auxiliary coil (not shown) respectively, through the outputs (33a′) and (33b′) as previously mentioned and illustrated.

The first and second auxiliary coils (not shown) convert these signals L and X2 into magnetic fields, more particularly, into the first and second magnetic fields, the first and second magnetic fields being captured by the first and second generating coils (14a′, 14b′) which, as previously described, convert these fields into the first and second electric currents respectively. The first and second electric currents interact within the circuit shown, which joins the three coils of the fourth set of coils (14a′, 14b′, 14c′), causing a controlled short circuit generated by the crashing coil (14c′), where said controlled short circuit causes the interaction and fusion of the signals contained in the first and second electric currents previously referred to to generate a third electric current. This is the case with the third coil or crashing coil (14c′). As previously mentioned, this third electric current is the result of the electrical collision between the previously processed LEFT and X2 audio signals.

Thus, this crashing coil (14c′) is configured to convert this third electric current into a magnetic field; This magnetic field is called the third magnetic field, which corresponds to the new X3 signal of a trisonic audio. Again, the third magnetic field or X3 contains the same characteristics as the content of the third electric current.

The third magnetic field is then generated by the crashing coil (14c′), wherein, the third magnetic field enters the physical space of the processing subsystem (20′); According to this example of a modality, the processing subsystem (20′) comprises a receiving coil (not shown) configured to capture the third magnetic field and convert it into an electric current, which is conducted into the processing subsystem (20′) through (33c′); It will be clear that the receiving coil (not shown) of the processing subsystem (20′) is configured to capture and convert the third magnetic field into an electric current, which can be referred to as a fourth electric current, which corresponds to the new signal X3 wherein this fourth electric current or X3 contains the same characteristics as the content of the third electric current. Once inside the processing subsystem, the fourth stream or X3 receives a final treatment prior to its output.

Generation of the Y3 Signal of a Trisonic Audio from Physical Operation;

For the fifth set of coils (15a′, 15b′, 15c′), the first coil (15a′) is configured to capture a first magnetic field, generated by an auxiliary coil (not shown) and subsequently convert said first magnetic field in a first electric current, which can circulate through it (15a′); The signal embedded and/or injected in said first magnetic field generated by the auxiliary coil (not shown) corresponds to the previously treated RIGHT or R channel or signal of stereophonic audio; consequently, the magnetic field generated by the auxiliary coil (not shown), and more particularly, the electric current generated by the first generating coil (15a′) also contains the same characteristics of the content of the previously processed signal RIGHT; On the other hand, the second coil (15b′) is configured to capture a second magnetic field, generated by an auxiliary coil (not shown) and subsequently, convert said second magnetic field into a second electric current, which can circulate through the same (15b′); the signal embedded and/or injected in said second magnetic field generated by the auxiliary coil (not shown) corresponds to the channel or previously treated signal Y2 of a trisonic audio; Consequently, the magnetic field generated by the auxiliary coil (not shown), and more particularly, the electric current generated by the second generating coil (15b′) also contains the same characteristics of the content of the previously processed signal Y2.

It is clear that the first and second magnetic fields generated by the auxiliary coils (not shown) and more particularly, the electric current generated by both the first and second coils (15a′, 15b′) are different from each other.

According to one modality, these audio signals R and Y2 are driven by the action of the processing subsystem (20′), which will be described in more detail later. The processing subsystem (20′) receives these signals, one from the input (21b′) for the RIGHT channel or signal and one from the output (27b′) for the channel or signal Y2, converting each one respectively into the first and second pre-treated electrical currents. Subsequently, the processing subsystem directs these first and second pre-treated electrical currents to the first and second auxiliary coil (not shown) respectively, through the outputs (34a′) and (34b′) as previously mentioned and illustrated.

The first and second auxiliary coils (not shown) convert these signals R and Y2 into magnetic fields, more particularly, into the first and second magnetic fields, the first and second magnetic fields being captured by the first and second generating coils (15a′, 15b′) which, as previously described, convert these fields into the first and second electric currents respectively. The first and second electric currents interact within the circuit shown, which joins the three coils of the fifth set of coils (15a′, 15b′, 15c′), causing a controlled short circuit generated by the crashing coil (15c′), where said controlled short circuit causes the interaction and fusion of the signals contained in the first and second electric currents previously referred to to generate the third electric current. This happens in the third coil or crashing coil (15C′). As previously mentioned, this third electric current is the result of the electrical collision between the previously processed RIGHT and Y2 audio signals.

Thus, this crashing coil (15c′) is configured to convert this third electric current into a magnetic field; This magnetic field is called the third magnetic field, which corresponds to the new Y3 signal of a trisonic audio. Again, the third magnetic field contains the same characteristics as the contents of the third electric current.

The third magnetic field is then generated by the crashing coil (15c′), herein, the third magnetic field enters the physical space of the processing subsystem (20′); According to this example of a modality, the processing subsystem (20′) comprises a receiver coil (not shown) configured to capture the third magnetic field, and convert it into an electric current, which is conducted into the processing subsystem (20′) through (34c′); It will be clear that the receiving coil (not shown) of the processing subsystem (20′) is configured to capture and convert the third magnetic field into an electric current, which can be referred to as a fourth electric current, which corresponds to the new signal Y3 wherein this fourth electric current or Y3 contains the same characteristics as the content of the third electric current. Once inside the processing subsystem, the fourth stream or Y3 receives a final treatment prior to its output.

Generation of the Z3 Signal of a Trisonic Audio from the Physical Operation;

For the sixth set of coils (16a′, 16b′, 146c′), the first coil (16a′) is configured to capture a first magnetic field, generated by an auxiliary coil (not shown) and subsequently convert said first magnetic field in a first electric current, which can circulate through it (16a′); The signal embedded and/or injected in said first magnetic field generated by the auxiliary coil (not shown) corresponds to the channel or previously treated signal X3 of a trisonic audio; consequently, the magnetic field generated by the auxiliary coil (not shown), and more particularly, the electric current generated by the first generating coil (16a′) also contains the same characteristics of the content of the previously processed signal X3; On the other hand, the second coil (16b′) is configured to capture a second magnetic field, generated by an auxiliary coil (not shown) and subsequently, convert said second magnetic field into a second electric current, which can circulate through the same (16b′); The signal embedded and/or injected in said second magnetic field generated by the auxiliary coil (not shown) corresponds to the channel or previously treated signal Y3 of a trisonic audio; Consequently, the magnetic field generated by the auxiliary coil (not shown), and more particularly, the electric current generated by the second generating coil (16b′) also contains the same characteristics of the content of the previously processed signal Y3.

It is clear that the first and second magnetic fields generated by the auxiliary coils (not shown) and more particularly, the electric current generated by both the first and second coils (16a′, 16b′) are different from each other.

According to one modality, these X3 and Y3 audio signals are driven by the action of the processing subsystem (20′), which will be described in more detail later. The processing subsystem (20′) receives these signals, one from the output (37a′) for channel or signal X3 and one from the output (37b′) for channel or signal Y3, each converting respectively into the first and second pre-treated electric currents. Subsequently, the processing subsystem directs these first and second pre-treated electric currents to the first and second auxiliary coil (not shown) respectively, through the outputs (35a′) and (35b′) as previously mentioned and illustrated.

The first and second auxiliary coils (not shown) convert these X3 and Y3 signals into magnetic fields, more particularly, into the first and second magnetic fields, the first and second magnetic fields being captured by the first and second generating coils (16a′, 16b′) which, as previously described, convert these fields into the first and second electric currents respectively. The first and second electric currents interact within the circuit shown, which joins the three coils of the sixth set of coils (16a′, 16b′, 16c′), causing a controlled short circuit generated by the crashing coil (16c′), where said controlled short circuit causes the interaction and fusion of the signals contained in the first and second electric currents previously referred to to generate a third electric current. which happens in the third coil or crashing coil (16c′). As previously mentioned, this third electric current is the result of the electrical collision between the previously processed X3 and Y3 audio signals.

Thus, this crashing coil (16c′) is configured to convert this third electric current into a magnetic field; This magnetic field is called the third magnetic field, which corresponds to the new Z3 signal of a trisonic audio. Again, the third magnetic field or Z3 contains the same characteristics as the content of the third electric current.

The third magnetic field is then generated by the crashing coil (16c′), wherein, the third magnetic field enters the physical space of the processing subsystem (20′); According to this example of a modality, the processing subsystem (20′) comprises a receiver coil (not shown) configured to capture the third magnetic field and convert it into an electric current, which is conducted into the processing subsystem (20′) through (35c′); It will be clear that the receiving coil (not shown) of the processing subsystem (20′) is configured to capture and convert the third magnetic field into an electric current, which can be termed as a fourth electric current, which corresponds to the new signal Z3 wherein this fourth electric current or Z3 contains the same characteristics as the content of the third electric current. Once inside the processing subsystem, the fourth stream or Z3 receives a final treatment prior to its output.

However, it should be noted that the concept of pretreatment as previously and/or throughout the present application, in accordance with a modality of the present invention, the performance of this action is imperative, especially when applied to the input audio signals before they enter the coils of the invention being filed. This need is based on the premise that pretreatment is a critical step to ensure optimal system performance. The term “primarily” emphasizes that while pretreatment may have other applications, its priority application should target input audio signals in this specific context.

The reason behind this priority is that the input audio signals play a fundamental role in the overall operation of the invention, and their pre-treatment helps to optimize its quality and characteristics before they are processed by the subsystems or coil assemblies. This ensures that the signals entering the coils are in the ideal condition to obtain the desired results in terms of system performance and functionality.

It is also important to note that a person with ordinary knowledge in the field would understand that the generation of a third magnetic field, as used in the present invention, should not be interpreted as a pre-treatment process aimed at the subsequent creation of X, Y or Z signals. In reality, this third magnetic field already intrinsically contains the information and content of the definitive X, Y, or Z signals.

This nuance is fundamental to understanding the functioning and nature of this third magnetic field. Rather than being a preliminary step in the production of X, Y, or Z signals, this magnetic field itself represents the manifestation of those signals. Therefore, it is not a pre-processing phase aimed at preparing the signals for their subsequent generation, but at its origin it already incorporates the essential information for the formation of the desired signals.

This distinction is of great importance, as it highlights that the third magnetic field is not an intermediary, but the end product itself. Its content and characteristics are directly related to the X, Y, or Z signals that are sought to be generated, suggesting an intrinsic relationship between the third magnetic field and the final signals. Therefore, it should not be considered as a preliminary stage, but as the complete and definitive outcome of the process, which has significant implications for understanding and effectively using this phenomenon in practice.

Also, despite the fact that the third magnetic field already intrinsically incorporates the information related to the X, Y or Z signals, it is valid to say that it undergoes a final treatment in the processing subsystem before the output signals are delivered. This process should not be confused with a pre-treatment, since, as previously explained, the third magnetic field is essentially the desired end result.

The processing subsystem plays a critical role in further enhancing and tuning the characteristics of X, Y, or Z signals. During this phase, specific modifications are applied to ensure that the output signals meet the required standards in terms of quality, accuracy, or other necessary parameters. This final processing in the processing subsystem is carried out in order to refine the signals before they are delivered.

Consequently, it could be said that the third magnetic field constitutes the final result or the resulting signal X, Y or Z, and the processing subsystem is responsible for optimizing and adjusting the said X, Y or Z output signals according to the particular needs and specifications. This differentiation between the third magnetic field and the processing subsystem is of vital importance to understand how the generation of X, Y, or Z signals is achieved with the highest accuracy and quality. The incorporation of this final treatment into the process underlines the sophistication and controllability of the system, ensuring that the output signals are optimal in terms of performance and utility.

Regarding the generation of the X3 signal of a trisonic audio from the previously mentioned physical operation and with continuous reference to FIG. 15, it is important to highlight that, taking into account again the fourth set of coils (14a′, 14b′, 14c′), the process of generating this X3 signal of a trisonic audio will be explained in detail below.

According to the present invention, the X3 signal of a trisonic audio is generated after the fusion of the X2 audio signal (A100/D50/−E50/−B100) with the L audio signal (A100/D75/C50/E25/B0), that is to say, the X3 audio signal is generated by causing a deletion and/or incorporation between the panning point values of X2 with the pan point values of L.

It will be clear at this point that the removal and/or incorporation of panning point values of the said LEFT and X2 signals is carried out in the collision or crash of electric currents by the action or effect of the controlled short circuit carried out in the collision circuit, as previously described.

To generate the X3 signal of a trisonic audio, the X2 audio signal with all its pan point values (A100/D50/−E50/−B100) is injected into one of the auxiliary coils (not shown), where subsequently, the auxiliary coil converts the electric current into a magnetic field containing the X2 audio signal; additionally, the magnetic field generated by one of the auxiliary coils (not shown) is captured by one of the generating coils; Specifically, this magnetic field must be picked up by the second generating coil (14b′).

At a second point, the LEFT audio signal with all its pan point values (A100/D75/C50/E25/B0) is injected into one of the auxiliary coils (not shown), where the auxiliary coil then converts the electric current into a magnetic field containing the LEFT signal; additionally, the magnetic field generated by one of the auxiliary coils (not shown) is captured by one of the generating coils; specifically, this magnetic field must be picked up by the first generating coil (14A′).

As described throughout this description and according to this example of a modality, these panning values of X2 and LEFT are respectively and independently contained in each magnetic field generated by the auxiliary coils, each containing the panning values of its respective signal.

Similarly, once these first and second magnetic fields are captured by the first and second generating coils (14a′, 14b′), these first and second generating coils (14a′, 14b′) are configured to convert the first and second magnetic fields into a first and second electric currents respectively.

The first electric current L will be or may be present within the first generating coil (14a′) while the second electric current X2 is or may be present within the second generating coil (14b′).

The first and second electric currents, independent from each other at the instants where they are generated by the first and second generating coils (14a′, 14b′) then circulate to the collision circuit, where they collide with each other in the crashing coil (14c′) generating a controlled short circuit.

The controlled short circuit generated by the crashing coil (14c′), as described throughout this application and in accordance with this example of the modality, gives rise to or generates a third electric current independent of and different from the first two electric currents previously described. The collision or shock between these first and second electric currents occurring in the crashing coil (14c′) causes a removal and/or incorporation of the values of panning points contained in the first and second electric currents generated by these generating coils (14a′, 14b′), creating or giving rise to a third electric current with new values of panning points, these (A200/D125/C50/−E25/−B100), which correspond to the new X3 audio signal of a trisonic audio.

Consequently, the crashing coil (14c′) is configured to convert this third electric current into a third magnetic field; In turn, this third magnetic field enters the physical space of a receiver coil (not shown) of the processing subsystem (20′), which is configured to capture the third magnetic field and convert it into a fourth electric current.

As previously described, this fourth electric current comprises the eliminated and/or incorporated panning values derived from the controlled short circuit, contained in the third magnetic field; therefore, this fourth electric current contains the X3 audio signal, whose panning values are (A200/D125/C50/−E25/−B100), which are necessary to form a first channel or signal of a trisonic audio.

Finally, according to a modality, said fourth electric current or signal X3 will be conducted to a final treatment (36a′) within the processing subsystem (20′) so that consecutively said signal X3 is connected to a subsequent playback system; the output of the X3 audio signal after passing through the final treatment (36a′) is done through (37a′).

Regarding the generation of the Y3 signal of a trisonic audio from the previously referred physical operation and with continuous reference to FIG. 15, it is important to highlight that, taking into account again the fifth set of coils (15a′, 15b′, 15c′), the process of generating this Y3 signal of a trisonic audio will be explained in detail below.

According to the present invention, the Y3 signal of a trisonic audio is generated after the fusion of the audio signal Y2 (−A100/−D50/E50/B100) with the audio signal R (A0/D25/C50/E75/B100), that is to say, the audio signal Y3 is generated by causing a deletion and/or incorporation between the pan point values of Y2 with the pan point values of R.

It will be clear at this point that the removal and/or incorporation of panning point values of the said RIGHT and Y2 signals is carried out in the collision or crash of electric currents by the action or effect of the controlled short circuit carried out in the collision circuit, as previously described.

To generate the Y3 signal of a trisonic audio, the Y2 audio signal with all its pan point values (−A100/−D50/E50/B100) is injected into one of the auxiliary coils (not shown), where the auxiliary coil then converts the electric current into a magnetic field containing the Y2 audio signal; additionally, the magnetic field generated by one of the auxiliary coils (not shown) is captured by one of the generating coils; specifically, this magnetic field must be picked up by the second generating coil (15b′).

At a second point, the RIGHT audio signal with all its pan point values (A0/D25/C50/E75/B100) is injected into one of the auxiliary coils (not shown), wherein the auxiliary coil then converts the electric current into a magnetic field containing the RIGHT signal; additionally, the magnetic field generated by one of the auxiliary coils (not shown) is captured by one of the generating coils; specifically, this magnetic field must be picked up by the first generating coil (15A′).

As described throughout this description and according to this example of a modality, the panning values of Y2 and RIGHT are respectively and independently contained in each magnetic field generated by the auxiliary coils, each containing the panning values of its respective signal.

Similarly, once these first and second magnetic fields are captured by the first and second generating coils (15a′, 15b′), these first and second generating coils (15a′, 15b′) are configured to convert the first and second magnetic fields into a first and second electric currents respectively.

The first electric current R will be or may be present within the first generating coil (15a′) while the second electric current Y2 is or may be present within the second generating coil (15b′).

The first and second electric currents, independent from each other at the instants where they are generated by the first and second generating coils (15a′, 15b′) then circulate to the collision circuit, where they collide with each other in the crashing coil (15c′) generating a controlled short circuit.

The controlled short circuit generated by the crashing coil (15c′), as described throughout this application and according to this example of the modality, gives rise to or generates a third electric current independent of and different from the first two electric currents previously described. The collision or shock between these first and second electric currents occurring in the crashing coil (15c′) causes a removal and/or incorporation of the values of panning points contained in the first and second electric currents generated by these generating coils (15a′, 15b′), creating or giving rise to a third electric current with new values of panning points, these (−A100/−D25/C50/E125/B200), which correspond to the new Y3 audio signal of a trisonic audio.

Consequently, the crashing coil (15c′) is configured to convert this third electric current into a third magnetic field; In turn, this third magnetic field enters the physical space of a receiver coil (not shown) of the processing subsystem (20′), which is configured to capture the third magnetic field and convert it into a fourth electric current.

As previously described, this fourth electric current comprises the eliminated and/or incorporated panning values derived from the controlled short circuit, contained in the third magnetic field; therefore, this fourth electric current contains the audio signal Y3, whose panning values are (−A100/−D25/C50/E125/B200), which are necessary to form a second channel or signal of a trisonic audio.

Finally, according to a modality, this fourth electric current or signal Y3 will be conducted to a final treatment (36b′) within the processing subsystem (20′) so that consecutively said signal Y3 is connected to a subsequent playback system; the output of the audio signal Y3 after passing through the final treatment (36b′) is made through (37b′).

Regarding the generation of the Z3 signal of a trisonic audio from the previously referred physical operation and with continuous reference to FIG. 15, it is important to highlight that, taking into account again the sixth set of coils (16a′, 16b′, 16c′), the process of generating this Z3 signal of a trisonic audio will be explained in detail below.

According to the present invention, the Z3 signal of a trisonic audio is generated after the fusion of the X3 audio signal (A200/D125/C50/−E25/−B100) with the Y3 audio signal (−A100/−D25/C50/E125/B200), that is to say, the Z3 audio signal is generated by causing a deletion and/or incorporation between the pan point values of X3 with the pan point values of Y3.

It will be clear at this point that such removal and/or incorporation of panning point values of the said X3 and Y3 signals is carried out in the collision or crash of electric currents by the action or effect of the controlled short circuit carried out in the collision circuit, as previously described.

To generate the Z3 signal of a trisonic audio, the X3 audio signal with all its pan point values (A200/D125/C50/−E25/−B100) is injected into one of the auxiliary coils (not shown), where subsequently, the auxiliary coil converts the electric current into a magnetic field containing the X3 audio signal; additionally, the magnetic field generated by one of the auxiliary coils (not shown) is captured by one of the generating coils; specifically, this magnetic field must be picked up by the first generating coil (16A′).

At a second point, the audio signal Y3 with all its pan point values (−A100/−D25/C50/E125/B200) is injected into one of the auxiliary coils (not shown), where the auxiliary coil then converts the electric current into a magnetic field containing the Y3 signal; additionally, the magnetic field generated by one of the auxiliary coils (not shown) is captured by one of the generating coils; specifically, this magnetic field must be picked up by the second generating coil (16b′).

As described throughout this description and according to this example of a modality, these panning values of X3 and Y3 are respectively and independently contained in each magnetic field generated by the auxiliary coils, each containing the panning values of its respective signal.

Similarly, once these first and second magnetic fields are captured by the first and second generating coils (16a′, 16b′), these first and second generating coils (16a′, 16b′) are configured to convert the first and second magnetic fields into a first and second electric currents respectively.

The first electric current X3 will be or may be present within the first generating coil (16a′) while the second electric current Y3 is or may be present within the second generating coil (16b′).

The first and second electric currents, independent of each other at the instants where they are generated by the first and second generating coils (16a′, 16b′) then circulate to the collision circuit, where they collide with each other in the crashing coil (16c′) generating a controlled short circuit.

The controlled short circuit generated by the crashing coil (16c′), as described throughout this application and in accordance with this example of the modality, gives rise to or generates a third electric current independent of and different from the first two electric currents previously described. The collision or shock between these first and second electric currents occurring in the shock coil (16c′) causes a removal and/or incorporation of the values of panning points contained in the first and second electric currents generated by these generating coils (16a′, 16b′), creating or giving rise to a third electric current with new values of panning points, these (A100/D100/C100/E100/B100), which correspond to the new Z3 audio signal of a trisonic audio.

Consequently, the crashing coil (16c′) is configured to convert said third electric current into a third magnetic field; In turn, said third magnetic field enters the physical space of a receiving coil (not shown) of the processing subsystem (20′), which is configured to capture the third magnetic field and convert it into a fourth electric current.

As previously described, this fourth electric current comprises the eliminated and/or incorporated panning values derived from the controlled short circuit, contained in the third magnetic field; therefore, this fourth electric current contains the Z3 audio signal, whose panning values are (A100/D100/C100/E100/B100), which are necessary to form a third channel or signal of a trisonic audio.

Finally, according to a modality, this fourth electric current or Z3 signal will be conducted to a final treatment (36c′) within the processing subsystem (20′) so that the Z3 signal will be consecutively connected to a subsequent playback system; the output of the said Z3 audio signal after passing through the final treatment (36c′) is done through (37c′).

On the basis of the above, the process of generating a trisonic audio from stereophonic audio in accordance with the present invention describes a system capable of carrying out the processing, treatment and conversion of such stereophonic audio immediately, without delay between the input and output of the signal and therefore, completely eliminating any presence of latency; this is achieved based on the aforementioned electrical collision generated from the collision of electric currents within the collision circuit, which generates a subsequent signal with panning values eliminated and/or incorporated.

Therefore, without necessarily being limited to the physics and theory involved, it has been demonstrated to obtain X, Y, Z channels or signals from a trisonic audio (one channel or signal for each set of coils) without latency or delay with respect to the input time of the audio signal.

In an optional modality, there may be from three to “n” number of coils for each coil subsystem or set of coils (collider) with the characteristics that have been described throughout this application, there can also be from one and to “n” number of sets of coils with the characteristics that have been described throughout this application, consequently generating from one to “n” number of collisions in each set of coils and therefore, consequently generating from one to “n” number of channels or signals of a trisonic audio in each set of coils, where the input signals to each set of coils (collider) are not limited to being signals of type L and R but could be 2 signals of any type, which may or may not be pre-treated.

According to one modality, the processing subsystem (20′) is a processing medium configured to receive, first, the input audio signal, which according to the present invention, is a stereophonic or two-channel audio referred to throughout this application as LEFT and RIGHT; On the other hand, this processing subsystem (20′) is configured to receive the X, Y, Z signals of a trisonic audio once the coil subsystem or coil sets have performed the removal and/or incorporation of pan point values respectively, and finally, drive the resulting X, Y, Z signals to a subsequent trisonic audio playback system.

In this sense, the present invention can comprise from one to “n” processing subsystems; In one embodiment, such as the example of an embodiment illustrated in the present application, the present invention may comprise a processing subsystem (20′) connected to the three sets of coils, furthermore, the outputs of said processing subsystem are or may be connected to a trisonic audio playback system; In a further embodiment, each set of coils may comprise a processing subsystem (20′) and therefore is not limited to the embodiment previously described or illustrated. On the contrary, it should be understood that the essence of this component is to distribute the input currents (LEFT, RIGHT) towards the corresponding set of coils for the processing and conversion of said signals and subsequently, receive the resulting signals already converted into a channel or signal X, Y, Z of a trisonic audio, as previously described. This processing subsystem, in an exemplary but not limited manner, comprises at least one selected component of at least one signal multiplier, one signal phaser, one signal splitter, one signal mixer, among others, and any configuration and/or combination thereof.

A subject matter expert may understand that such components of such a processing subsystem may be variable in terms of their nature, quantity, configuration, etc., as long as they fulfill the functions necessary to perform the pre-processing of the input signals and the final processing of the resulting signals.

Many modifications and other embodiments of the invention will come to mind to one skilled in the art to which the invention pertains, who has the benefit of the teachings presented in the foregoing descriptions and the associated drawings. Therefore, it should be understood that the invention is not to be limited to the specific and exemplary embodiments described, but rather that modifications and other embodiments are intended to be included within the scope of the appended claims. Although specific terms are used herein, they are used only in a generic and descriptive sense and not for limiting purposes. Likewise, it must be understood that the materials with which the different components comprising the invention described in this document can be manufactured, the geometries, dimensions, arrangements and other elements may vary without departing from the scope and spirit of the invention and therefore, the aforementioned modalities should not be considered limiting.

### Modes for Trisonic Audio Playback;

On the other hand, and by way of examples of use where this invention can be applied or reproduced in any of its modalities as described throughout this technical report, it should be taken into account that for the reproduction of trisonic audio, different types of playback systems can be used and it is not necessarily limited to the examples given below. Exemplary trisonic audio playback systems can be fully functional and independent of each other, and therefore, there may not necessarily be any dependency between them, however, the possibility of finding a satisfactory result for the listener is not ruled out if any of the different trisonic audio playback modes were used together or in any combination simultaneously, These different modes of trisonic audio playback are any selected from the group comprising a triangular playback system, a dynamic playback system, a quadraphonic playback system, an auricular playback system, a vector playback system, combinations of the same and/or the like.

As mentioned earlier in this document, the present invention generates a trisonic audio from a stereophonic audio, that is, it uses any type of stereophonic audio to convert it into a trisonic audio, in addition, it performs this procedure in real time, that is, with zero latency.

A subject matter expert can recognize that the world's standard for audio is stereophonic audio, which turns out to be a major advantage for the technology of the present invention.

As mentioned above, the present invention generates a trisonic audio from a stereophonic audio, however, it is important to understand that, there are two modes of trisonic audio where the first mode is composed of the signals X2, Y2, Z2 and where the second mode is composed of the signals X3, Y3, Z3. It should be noted that each of the aforementioned trisonic audio modes contains different panning point values, therefore, the acoustic result of each mode is different.

In addition, the present invention has several modes of reproduction, which have different specific characteristics, this with the intention of offering different reproduction alternatives that can be coupled and used in the best way in any acoustic space.

It should be noted that both modes of trisonic audio, both the mode composed of the X2, Y2, Z2 signals and the mode composed of the X3, Y3, Z3 signals offer very favorable acoustic results, however, these modes of trisonic audio have better compatibility or can offer a better acoustic result if they are reproduced with one or another special playback mode. However, the choice to use one or the other trisonic audio mode with any of the playback modes described below will be up to the user's choice.

Therefore, it is important to understand that all of the different trisonic audio playback modes that will be described in detail later can reproduce both the X2, Y2, Z2 signals of one trisonic audio mode and the X3, Y3, Z3 signals of the other trisonic audio mode, as well as the Xn, Yn, Zn signals of any other possible modality according to the teachings of the present invention, where “n” is any distinctive used to represent any signal modality or combination of trisonic audio signals possible according to the teachings of the present application.

In order to facilitate the writing and understanding of the specific characteristics of each playback mode, we will use X, Y, and Z as trisonic audio signals, where these X, Y, and Z represent both the X2, Y2, Z2 signals of one trisonic audio mode and the X3, Y3, Z3 signals of the other trisonic audio mode.

### Exemplary Modality 1—Triangular Playback System

### Specifications and Placement of Playback Equipment

The triangular playback system described is composed by at least three mono audio playback systems capable of reproducing or transmitting a full range of high, mid and bass frequencies that could range from 10 Hz to 20 KHz, in addition, it is clear to understand that the characteristics of these three mono audio playback systems, such as its size, wattage, decibel calibration, etc., In a preferred modality, these characteristics may be the same, or present certain variations, provided that the signals emitted have the characteristics that allow the objective acoustic result.

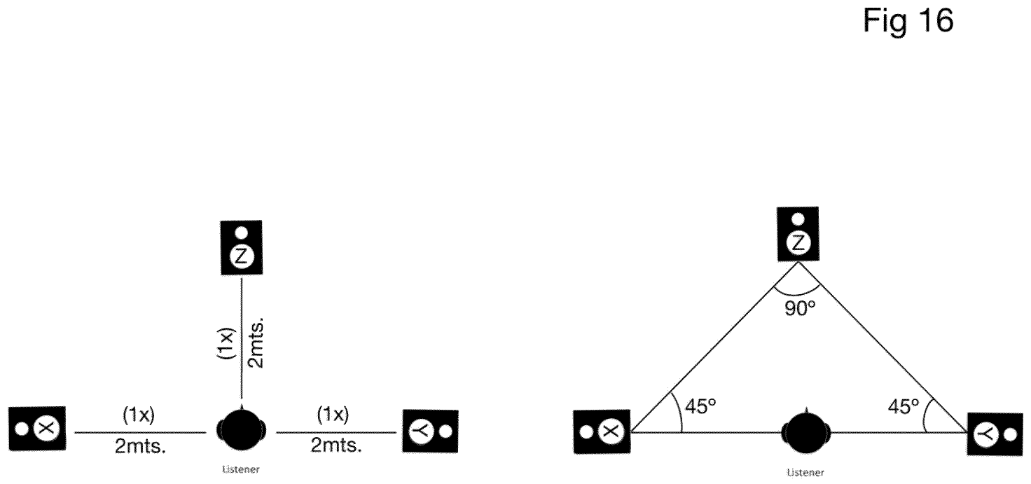

As mentioned above, the triangular playback system of this modality is composed by at least three mono audio playback systems, which must be placed strategically in the acoustic space and in relation to the listener;

Where, in a preferred modality, one is placed at the front with respect to the listener, one to the left with respect to the listener, and one to the right with respect to the listener. Preferably, mono audio playback systems for this modality are placed at the same distance (1×) between the listener and each mono audio playback system, i.e. if the listener is located 2 meters from the front mono audio playback system, the lateral mono audio reproduction systems are also aligned in relation to the listener and each would be 2 meters away from him, forming an isosceles triangle, as can be seen in FIG. 16.

When creating an isosceles triangle with the location of the mono audio playback systems, the angle range of the front corner goes from 80 to 100 degrees, preferably at 90 degrees, while the ranges of the two angles of the side corners range from 40 to 50 degrees each, preferably at 45 degrees It should be noted that in a preferred mode all three mono audio playback systems are oriented toward the listener's head, as shown in FIG. 16.

It is important to mention that the location and angles for the three mono audio playback systems of this modality describe the ideal exemplary realization, since the location and angles specified above offer the point of maximum appreciation for the listener in this modality.

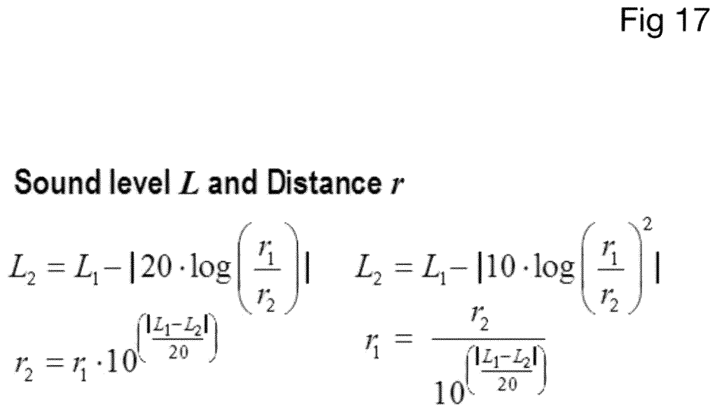

However, there is another realization in which the distance of the mono-front audio playback system from the listener can be modified when necessary due to the characteristics of the acoustic space in which the mono audio playback systems will be placed. This means that such a front-facing mono audio playback system will be able to sit closer or farther away from the listener and still remain effective. To achieve this, the formulas shown in FIG. 17 are used, which allow us to calculate the relationship between the sound level of (L) in decibels (dB) (known as the sound pressure level or sound intensity level) as a function of the distance from (R). This formula is well known in the above technique. By correctly applying the above-mentioned formula, the system of the present invention will remain effective.

The above formula allows you to modify the distance of the front mono audio playback system in relation to the listener. However, the distance of the lateral mono audio playback systems from the listener remains the same, i.e. if the left mono audio playback system is at a distance (1×) from the listener, the right mono audio playback system must be kept at the same distance (1×) from the listener.

Therefore, the distance between the front mono audio playback system and the listener can be increased or decreased as long as the aforementioned formula is applied correctly and both the right and left side mono audio system are kept at the same distance each in relation to the listener.

From the above, it is important to understand that the internal angles of the triangle formed by the three mono audio playback systems are related to the distance between the listener and each mono audio playback system. As a result, such angles will vary according to the modification of the distance between the front mono audio playback system and the listener.

It should be noted that this other modality may still be effective in those cases where it is necessary to modify the distance between the front mono audio playback system and the listener using the aforementioned formula correctly.

### Assigning Signals to Mono Systems

As mentioned throughout the present invention, a trisonic audio is made up of 3 audio signals, which, as mentioned above, we will identify as X, Y, Z.

It is important to understand that these 3 mono audio playback systems used in this playback mode reproduce the trisonic audio together, i.e., these 3 mono systems play together the 3 audio signals X, Y, Z;

Where, the left mono audio playback system is configured to receive and play the X audio signal, the front mono audio playback system is configured to receive and play the Z audio signal, and the right mono audio playback system is configured to receive and play the Y audio signal, as shown in FIG. 16.

### Triangular Spatial Panning Effect

As mentioned above, the triangular playback system of this playback mode can reproduce both the X2, Y2, Z2 signals of one trisonic audio mode and the X3, Y3, Z3 signals of another trisonic audio mode, however, the acoustic result, which we call the triangular spatial panning effect, It will have different acoustic results depending on the trisonic audio mode to be played.

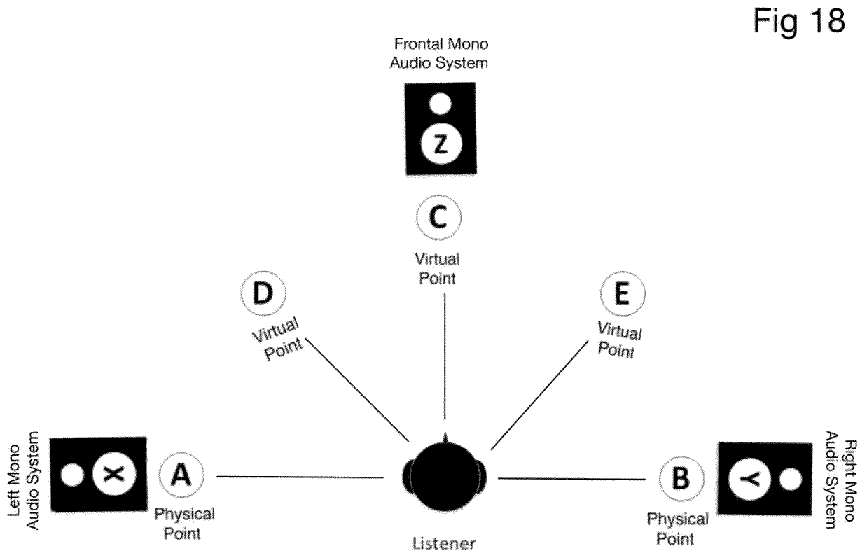

It is important to understand that this triangular spatial panning effect occurs during the appreciation of sounds in acoustic space, that is to say, during the appreciation of sounds corresponding to signals X, Y, Z; Where this effect consists of the total, balanced and homogeneous appreciation of the 5 main panning points of a stereophonic mixture A, D, C, E, B in the acoustic space formed by the placement of the 3 mono systems corresponding to the triangular playback system of the present playback modality, which forms an isosceles triangle taking as a reference the front mono system, the left mono system and the right mono system, as shown in FIG. 18.

It should be noted that 3 of the said 5 panning points can be considered as physical panning points and 2 of the said 5 panning points can be considered as virtual panning points.

It is important to note that such triangular spatial panning effect will result in the correct manner regardless of whether such X, Y, Z signals were generated with the magnetic collision system of the present invention or with the electrical collision system of the present invention.

It should be noted that each of the aforementioned X, Y, Z signals are composed of a specific percentage of each of the 5 main panning points that we call panning values, so this triangular spatial panning effect is due to the interaction between these values when these sounds are emitted in the acoustic space.

It should be noted that the interaction process that will be described below to create the triangular spatial panning effect requires the elimination and/or incorporation of the pan point values that make up each of the audio signals X, Y, Z, where said elimination and/or incorporation only happens between the values of the same letter, so, for example, the percentage or panning point values of A from signal X can be added, subtracted or maintained only with the percentage or panning point value of A from signal Y, signal Z or any other signal with which the interaction is being carried out and thus, in the same way with the other panning points D, C, E, B.

Triangular Spatial Panning Effect with X2, Y2, Z2 Signals from a Trisonic Audio

Exemplarily but not exhaustively, the X2, Y2, Z2 signals of a trisonic audio interact in the acoustic space to achieve the effect of triangular spatial panning as follows;

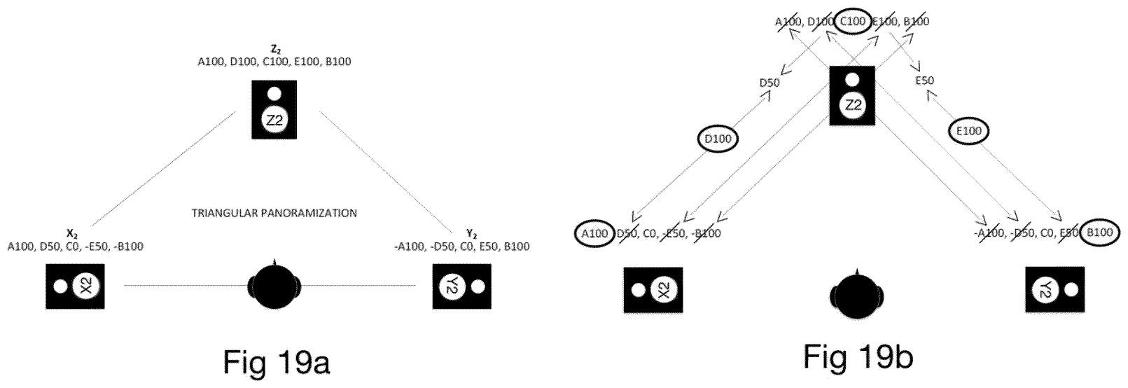

The Z2 audio signal emitted by the front mono audio playback system interacts at the same time with the X2 audio signal emitted by the left mono audio playback system and with the Y2 audio signal emitted by the right mono audio playback system, therefore; the values of Z2 (A100/D100/C100/E100/B100) interact at the same time with the values of X2 (A100/D50/−E50/−B100) and with the values of Y2 (−A100/−D50/E50/B100), resulting in the values (A100/D100/C100/E100/B100), where these values represent the acoustic result perceived by the listener, as shown in FIGS. 19a and 19b.

From the above described it can be understood that;

The −B100 value of the left side mono audio playback system is removed when interacting with the B100 of the front central mono audio playback system, completely removing both values for both mono audio playback systems in the acoustic space.

The −A100 value of the right side mono audio playback system removes the A100 value of the front center mono audio playback system, completely removing both values for both mono audio playback systems in the acoustic space.

The −E50 value of the left side mono audio playback system is removed when interacting with the E100 of the front center mono audio playback system, leaving a new value for the E50 front center mono audio playback system. This new E50 value can now interact with the E50 value of the right side mono audio playback system, being the result of a previous interaction, the positives can be added up throwing the new virtual audio point with its new E100 value in the acoustic space.

The −D50 value of the right side mono audio playback system is removed when interacting with the D100 of the front center mono audio playback system, leaving a new value for the D50 front center mono audio playback system. This new D50 value can now interact with the D50 value of the left side mono audio playback system, being the result of a previous interaction, the positives can be added up throwing the new virtual audio point with its new D100 value in the acoustic space.

The C0 value of the left side mono audio playback system cannot interact with the front center mono audio playback system because its value is 0.

The C0 value of the right side mono audio playback system cannot interact with the front center mono audio playback system because its value is 0.

The A100 value of the left side mono audio playback system cannot remove any value from the front center mono audio playback system as the A100 contained by the front center mono audio playback system has already been deleted. Now the only point that will contain the A100 value will be the left side mono audio playback system in the acoustic space.

The B100 value of the right side mono audio playback system cannot remove any values from the front center mono audio playback system as the B100 contained by the front center mono audio playback system has already been previously deleted. Now the only point that will contain the B100 value is the right side mono audio playback system in the acoustic space.

After the interaction of both side mono audio playback systems with the front center mono audio playback system, the only point where the C100 value is located is on the front center mono audio playback system in the acoustic space.

It should be noted that the way in which the interaction between the Z2 audio signal with the X2 and Y2 audio signals is described to give the location to the 5 main panning points A, D, C, E and B in the acoustic space, are shown in an exemplary but not limited way, in addition, It should also be considered that these interactions are described in relation to the perception of the listener and the interpretation of the brain when the listener is positioned at the maximum point of appreciation, also known as the sweet spot of the present mode of reproduction.

Triangular Spatial Panning Effect with X3, Y3, Z3 Signals from a Trisonic Audio

In an exemplary but non-limiting manner, the signals X3, Y3, Z3 of a trisonic audio interact in the acoustic space to achieve the triangular spatial panning effect as follows;

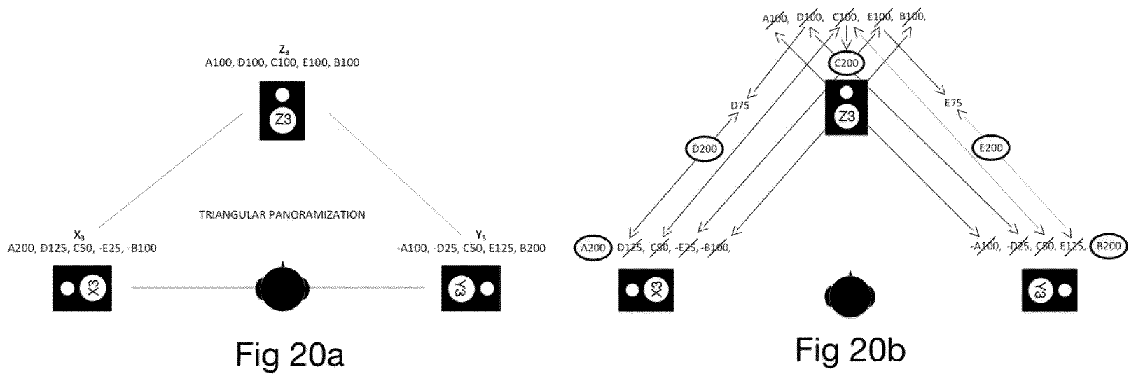

The audio signal Z3 output by the front mono audio playback system interacts at the same time with the audio signal X3 output by the left mono audio playback system and with the audio signal Y3 output by the right mono audio playback system, therefore; the values of Z3 (A100/D100/C100/E100/B100) interact at the same time with the values of C50/E125/B200), resulting in the values (A200/D200/C200/E200/B200), where these values represent the acoustic result perceived by the listener, as shown in FIGS. 20a and 20b.

From the above described it can be understood that;

The −B100 value of the left side mono audio playback system is removed when interacting with the B100 of the front center mono audio playback system, completely removing both values for both mono audio playback systems in the acoustic space.

The −A100 value of the right side mono audio playback system removes the A100 value of the front center mono audio playback system, completely removing both values for both mono audio playback systems in the acoustic space.

The −E25 value of the left side mono audio playback system is removed when interacting with the E100 of the front center mono audio playback system, leaving a new value for the E75 front center mono audio playback system. This new E75 value can now interact with the E125 value of the right side mono audio playback system, being the result of a previous interaction, the positives can be added up throwing the new virtual audio point with its new E200 value in the acoustic space.

The −D25 value of the right side mono audio playback system is removed when interacting with the D100 of the front center mono audio playback system, leaving a new value for the D75 front center mono audio playback system. This new D75 value can now interact with the D125 value of the left side mono audio playback system, being the result of a previous interaction, the positives can be added up throwing the new virtual audio point with its new D200 value into the acoustic space.

The C50 value of the left side mono audio playback system interacts with the C100 value of the front center mono audio playback system and at the same time the C50 value of the right side mono audio playback system interacts with the C100 value of the front center mono audio playback system creating a new C200 value for the center mono audio playback system in the acoustic space.

The A200 value of the left side mono audio playback system cannot remove any value from the front center mono audio playback system as the A100 contained by the front center mono audio playback system has already been previously deleted. Now the only point that will contain the A200 value will be the left side mono audio playback system in the acoustic space.

The B200 value of the right side mono audio playback system cannot remove any value from the front center mono audio playback system as the B100 contained by the front center mono audio playback system has already been previously deleted. Now the only point that will contain the B200 value is the right side mono audio playback system in the acoustic space.

It should be noted that the way in which the interaction between the Z3 audio signal with the X3 and Y3 audio signals is described to give the location to the 5 main panning points A, D, C, E and B in the acoustic space, are shown in an exemplary but not limited way, in addition, It should also be considered that these interactions are described in relation to the perception of the listener and the interpretation of the brain when the listener is positioned at the maximum point of appreciation, also known as the sweet spot of the present mode of reproduction.

On the other hand, it is important to understand that such a triangular playback system of this modality could be replicated “n” times in different planes in relation to the listener or in any other possible configuration to simultaneously reproduce any type of multichannel audio composed of “n” number of pairs of channels or signals of type L and R.

### Exemplary Mode 2—Dynamic Playback System

### Specifications and Placement of Playback Equipment

The dynamic playback system described below is composed by at least four mono audio playback systems capable of reproducing or transmitting a full range of high, mid and bass frequencies ranging from 10 Hz to 20 KHz, and it is clear to understand that the characteristics of these four mono audio playback systems, such as its size, wattage, decibel calibration, etc., In a preferred modality, these characteristics may be the same, or present certain variations, provided that the signals emitted have the characteristics that allow the objective acoustic result

As mentioned above, the dynamic playback system of this mode is composed of at least four mono audio playback systems, which, in a preferred mode, are strategically placed in the acoustic space and in relation to the listener;

Where, in a preferred modality, two mono audio playback systems are placed on the left side in relation to the listener, which we name as the left side mono system and the central lateral left mono system, in addition, two mono audio playback systems are placed on the right side in relation to the listener, which we name as the right lateral mono system and the central lateral right mono system.

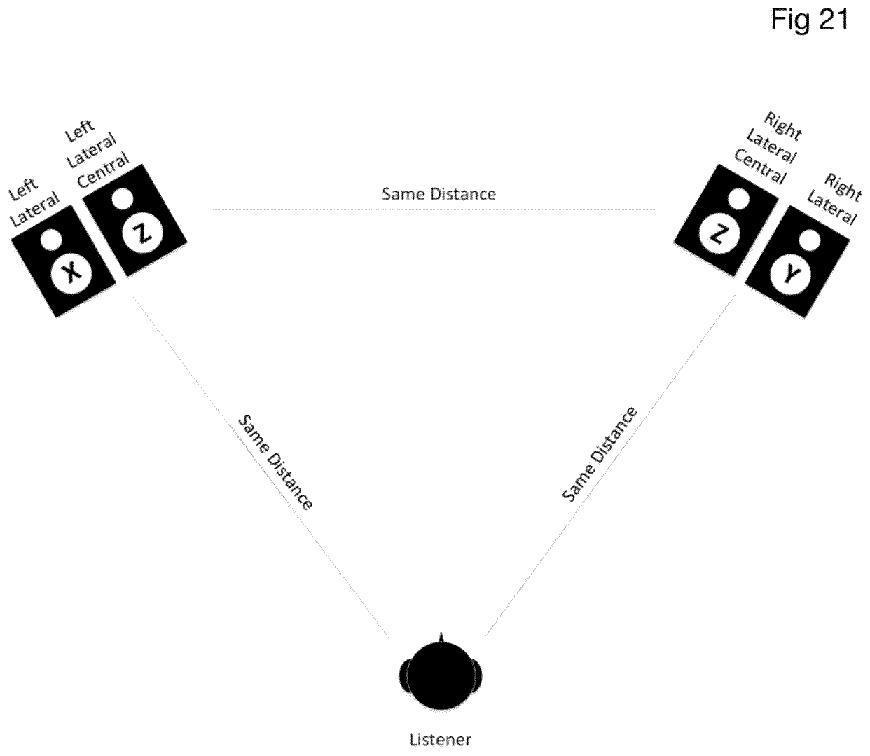

It should be noted that in a preferred mode the distance between the listener and the two mono audio playback systems that are placed on the left side is the same distance between the listener and the two mono audio playback systems that are placed on the right side, in addition, in a preferred mode an equilateral triangle is formed considering the listener as a first vertex, the pair of left mono systems as a second vertex and the pair of right mono systems as a third vertex, as shown in FIG. 21.

It should be noted that such mono audio playback systems that are placed on the left side in relation to the listener, in a preferred mode are placed together and in aligned orientation towards the listener's head, in the same way, mono audio playback systems that are placed on the right side in relation to the listener are placed together and in aligned orientation towards the listener's head, as shown in FIG. 21.

It is important to understand that in a preferred mode, the height of these four mono audio playback systems is the same and that the optimal height is delimited by the listener's head, however, a subject matter expert can understand that this height may vary if the necessary adjustments are made so that the orientation angle of these four mono systems is oriented towards the listener's head.

The above described is necessary so that in a preferred modality the listener can enjoy the maximum point of appreciation, also known as sweet spot, however, the distance between the two mono-left systems in relation to the two mono-right systems can decrease or increase as necessary according to the requirements of the physical space as long as the distance between the listener and the two mono-left systems is the same between The listener and the two mono systems would become an isosceles triangle, which would not cause any significant impact on the expected result.

### Assigning Signals to Mono Systems

As mentioned throughout the present invention, a trisonic audio is made up of 3 audio signals, which, as mentioned above, we will identify as X, Y, Z.

It is important to understand that these 4 mono audio playback systems used in this playback mode reproduce the trisonic audio together, i.e., these 4 mono systems play together the 3 audio signals X, Y, Z;

Where, the left lateral mono audio playback system is set to receive and play the X audio signal, the left central mono audio playback system is set to receive and play the Z audio signal, the right lateral mono audio playback system is set to receive and play the Y audio signal and the right central mono audio playback system is also configured to receive and play the Z audio signal, as shown in FIG. 21.

### Dynamic Spatial Panning Effect

As mentioned above, the dynamic playback system of this playback mode can reproduce both the X2, Y2, Z2 signals of one trisonic audio mode and the X3, Y3, Z3 signals of another trisonic audio mode, however, the acoustic result, which we call the dynamic spatial panning effect, It will have different acoustic results depending on the trisonic audio mode to be played.

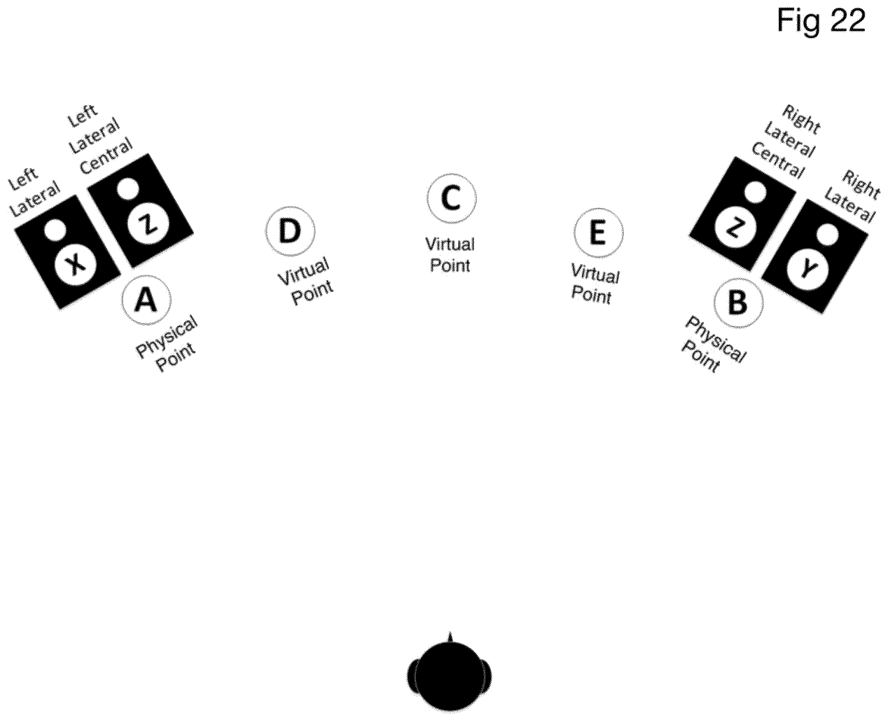

It is important to understand that this dynamic spatial panning effect occurs during the appreciation of sounds in acoustic space, that is to say, during the appreciation of sounds corresponding to signals X, Y, Z; Where this effect consists of the total, balanced and homogeneous appreciation of the 5 main panning points of a stereophonic mixture A, D, C, E, B in the horizontal acoustic space formed by the placement of the 4 mono systems corresponding to the dynamic playback system of the present reproduction mode, as shown in FIG. 22.

It should be noted that 2 of the said 5 panning points can be considered as physical panning points and 3 of the said 5 panning points can be considered as virtual panning points.

It is important to note that such dynamic spatial panning effect will result in the correct manner regardless of whether such X, Y, Z signals were generated with the magnetic collision system of the present invention or with the electrical collision system of the present invention.

It should be noted that each of the aforementioned X, Y, Z signals are composed of a specific percentage of each of the 5 main panning points that we call panning values, so this dynamic spatial panning effect is due to the interaction between these values when these sounds are emitted in the acoustic space.

It should be noted that the interaction process described below to create the dynamic spatial panning effect requires the removal and/or incorporation of the pan point values that make up each of the X, Y, Z audio signals, where such removal and/or incorporation only occurs between the values of the same letter, so, for example, the percentage or panning point value of A from signal X can be added, subtracted, or maintained only with the percentage or panning point value of A from signal Y, signal Z, or any other signal with which the interaction is taking place, and so on, the same with the other panning points D, C, E, B.

Dynamic spatial panning effect with X2, Y2, Z2 signals from a trisonic audio

In an exemplary but non-limiting manner, the signals X2, Y2, Z2 of a trisonic audio interact in the acoustic space to achieve the dynamic spatial panning effect as follows;

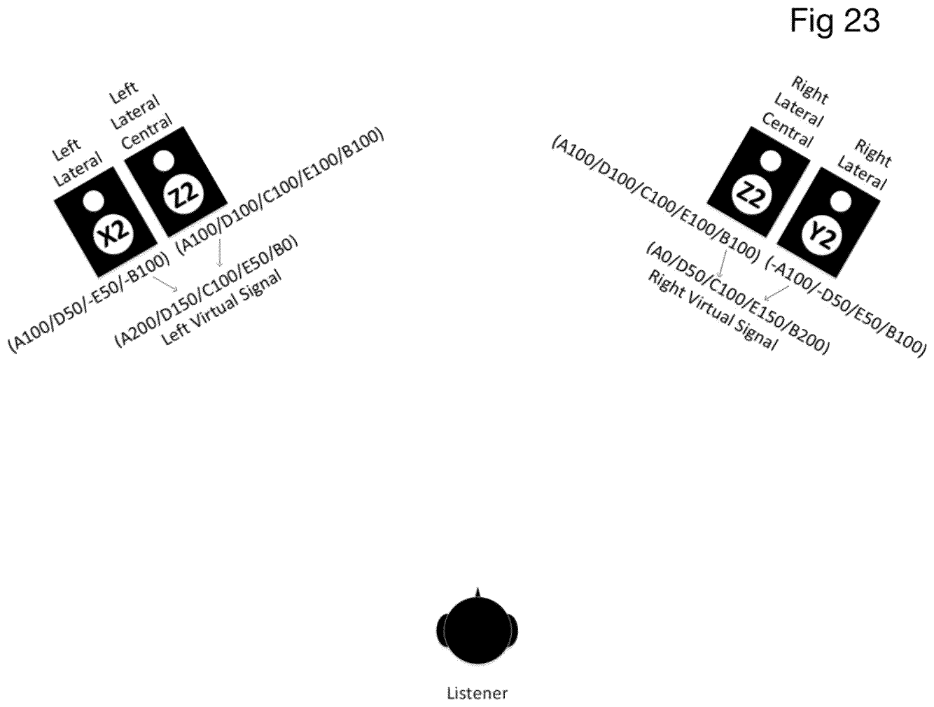

The X2 audio signal emitted by the left lateral mono audio playback system interacts with the Z2 audio signal emitted by the left central mono playback system, therefore; the values of X2 (A100/D50/−E50/−B100) interact with the values of Z2 (A100/D100/C100/E100/B100) resulting in the values (A200/D150/C100/E50/B0), where such values can be thought of as a left virtual audio signal, as shown in FIG. 23.

It should be noted that these resulting panning values (A200/D150/C100/E50/B0) are perceived in the middle of the said mono systems placed on the left side of the acoustic space, therefore, it seems as if both mono systems, together, reproduce or emit the left virtual audio signal (A200/D150/C100/E50/B0).

From the above described it can be understood that;

The A100 value emitted by the left lateral central mono system interacts in the acoustic space with the A100 value emitted by the left lateral mono system, thus creating the new A200 value that is perceived from the left virtual signal, the D100 value emitted by the left lateral central mono system interacts in the acoustic space with the D50 value emitted by the left lateral mono system, thus creating the new D150 value that is perceived from said left virtual signal, the C100 value emitted by the left lateral central mono system is maintained Because the left lateral mono system does not emit any value of C, thus creating the new value C100 that is perceived from said left virtual signal, the value E100 emitted by the left lateral central mono system interacts in the acoustic space with the value −E50 emitted by the left lateral mono system, thus creating the new value E50 that is perceived from said left virtual signal, the value B100 emitted by the left lateral central mono system interacts in the acoustic space with the value −B100 emitted by the left lateral mono system, thus creating the new B0 value that is perceived from said left virtual signal.

The Y2 audio signal emitted by the right lateral mono playback system interacts with the Z2 audio signal emitted by the right central mono playback system, therefore; the values of Y2 (−A100/−D50/E50/B100) interact with the values of Z2 (A100/D100/C100/E100/B100) resulting in the values (A0/D50/C100/E150/B200), where such values can be thought of as a right virtual audio signal, as shown in FIG. 23.

It should be noted that these resulting panning values (A0/D50/C100/E150/B200) are perceived in the middle of the mono systems placed on the right side of the acoustic space, therefore, it seems as if both mono systems, together, reproduce or emit the right virtual audio signal (A0/D50/C100/E150/B200).

From the above described it can be understood that;

The value A100 emitted by the right lateral central mono system interacts in the acoustic space with the −A100 value emitted by the right lateral mono system, thus creating the new A0 value that is perceived from the right virtual signal, the D100 value emitted by the right lateral central mono system interacts in the acoustic space with the −D50 value emitted by the right lateral mono system, thus creating the new value D50 that is perceived from the said right virtual signal, the value C100 emitted by the right lateral central mono system is maintained because the right lateral mono system does not emit any value of C, thus creating the new value C100 that is perceived from the said right virtual signal, the E100 value emitted by the right lateral central mono system interacts in the acoustic space with the E50 value emitted by the lateral right mono system, thus creating the new E150 value that is perceived from the right virtual signal, the B100 value emitted by the right lateral central mono system interacts in the acoustic space with the B100 value emitted by the right lateral mono system, thus creating the new value B200 that is perceived from the said right virtual signal.

Subsequently, said left virtual audio signal resulting from the interaction between the signals emitted by the two left mono systems interacts with said right virtual audio signal resulting from the interaction between the signals emitted by the two right mono systems, therefore; The values of the left virtual audio signal (A200/D150/C100/E50/B0) interact with the values of the right virtual audio signal (A0/D50/C100/E150/B200) resulting in the values (A200/D200/C200/E200/B200), where these values represent the acoustic result perceived by the listener.

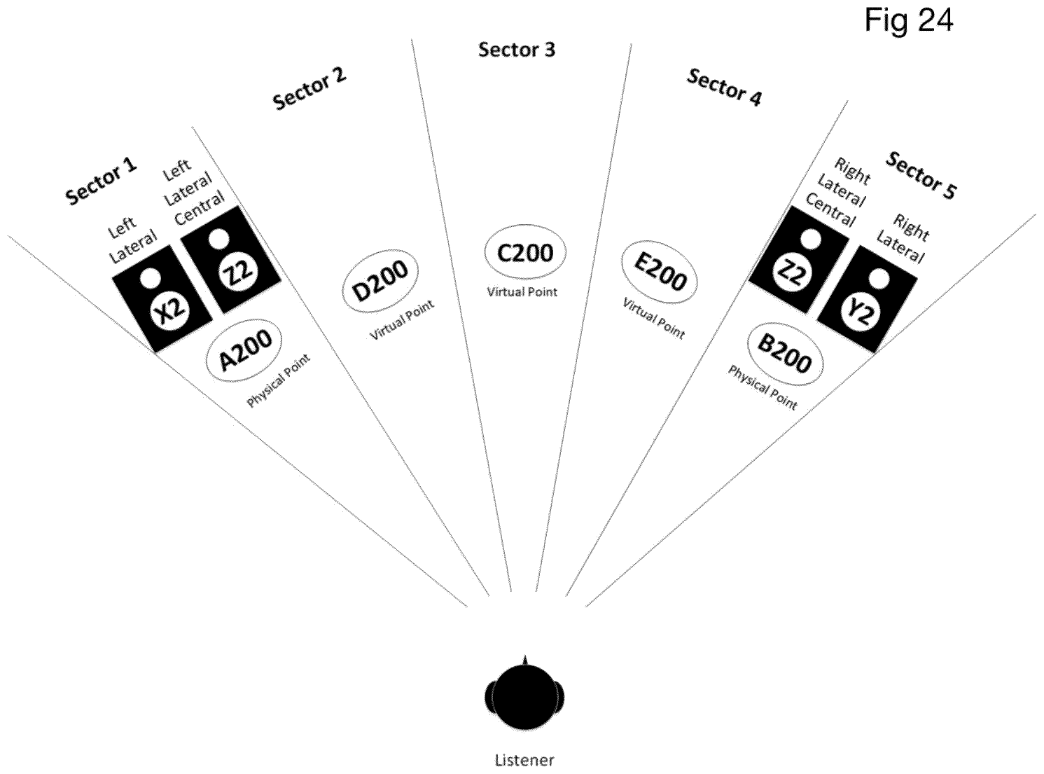

It should be noted that these resulting panning values (A200/D200/C200/E200/B200) are perceived in an equidistant, balanced and homogeneous manner throughout the horizontal acoustic space between the mono systems placed on the left side and the mono systems placed on the right, an expert in the field can understand that the exact location of the perception of these panning points A, D, C, E, B is due to the interaction of their corresponding values between the left and right virtual signals, so it is possible to perceive individually and separately each of the aforementioned pan points A, D, C, E, B in the acoustic space, where each pan point has its respective values (A200/D200/C200/E200/B200), as shown in FIG. 24.

In order to improve the understanding of the above described, the horizontal acoustic space between the mono systems placed on the left side and the mono systems placed on the right side can be divided into sectors, being 5 sectors, one for each point, in such a way that point A200, which can be considered as a physical point of panning, can be perceived in sector 1. point D200, which can be considered as a virtual panning point can be perceived in sector 2, point C200, which can be considered as virtual panning point can be perceived in sector 3, point E200, which can be considered as virtual panning point can be perceived in sector 4, point B200, which can be considered as the physical panning point, can be perceived in sector 5, as shown in FIG. 24.

From the above described it can be understood that;

The value A200 that is perceived from the left virtual signal interacts in the acoustic space with the value A0 that is perceived from the right virtual signal, thus creating the new value A200, which can be perceived in sector 1 of the acoustic space, the value D150 that is perceived from the left virtual signal interacts in the acoustic space with the value D50 that is perceived from the right virtual signal, thus creating the new value D200, which can be perceived in sector 2 of the acoustic space, the value C100 that is perceived from the left virtual signal interacts in the acoustic space with the value C100 that is perceived from the right virtual signal, thus creating the new value C200, which can be perceived in sector 3 of the acoustic space, the value E50 that is perceived from the left virtual signal interacts in the acoustic space with the value E150 that is perceived from the right virtual signal, thus creating the new value E200, which can be perceived in sector 4 of the acoustic space, the value B0 that is perceived from the left virtual signal interacts in the acoustic space with the value B200 that is perceived from the right virtual signal, thus creating the new value B200, which can be perceived in sector 5 of the acoustic space.

It should be noted that the way in which the interaction between the audio signals X2 and Z2 is described to generate the left virtual audio signal, as well as the way in which the interaction between the audio signals Y2 and Z2 is described to generate the right virtual audio signal, as well as how the interaction between the left virtual signal and the right virtual signal is described to give the location of the 5 main pan points A, D, C, E and B in the acoustic space, are shown in an exemplary but non-limiting way, in addition, it must also be considered that said interactions are described in relation to the listener's perception and the interpretation of the brain when said listener is positioned at the maximum point of appreciation also known as a sweet spot of the present reproduction mode.

Dynamic spatial panning effect with X3, Y3, Z3 signals from a trisonic audio

In an exemplary but non-limiting manner, the signals X3, Y3, Z3 of a trisonic audio interact in the acoustic space to achieve the dynamic spatial panning effect as follows;

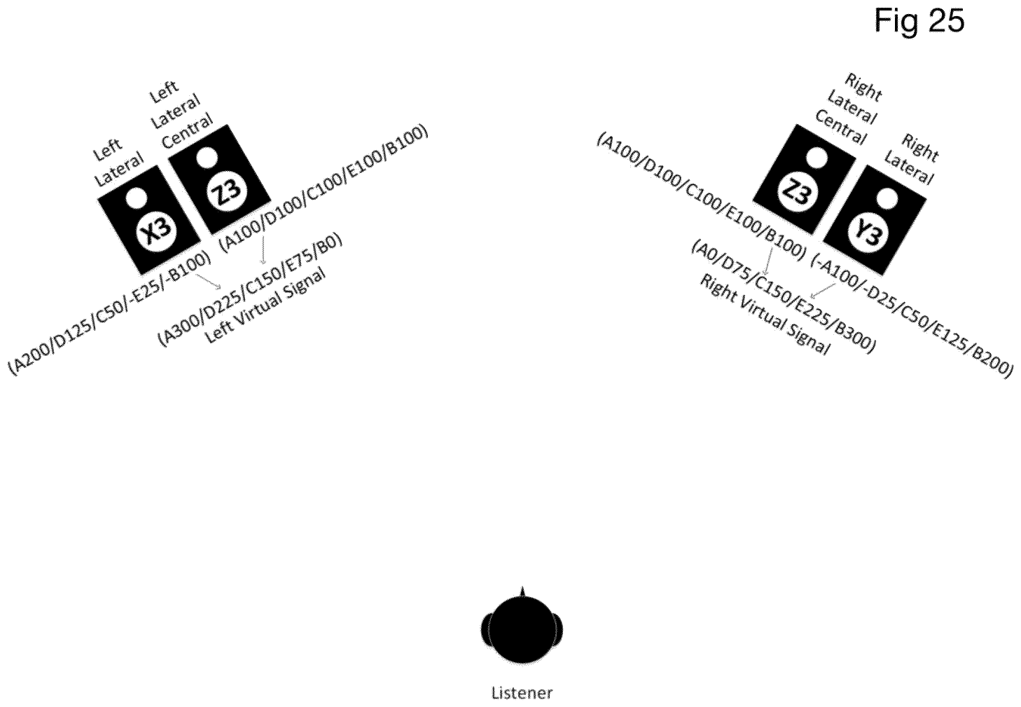

The X3 audio signal emitted by the left lateral mono audio playback system interacts with the Z3 audio signal emitted by the left lateral central mono playback system, therefore; the X3 values (A200/D125/C50/−E25/−B100) interact with the Z3 values (A100/D100/C100/E100/B100) resulting in the values (A300/D225/C150/E75/B0), where these values can be thought of as a left virtual audio signal, as shown in FIG. 25.

It should be noted that these resulting panning values (A300/D225/C150/E75/B0) are perceived in the middle of the said mono systems placed on the left side of the acoustic space, therefore, it seems as if both mono systems, together, reproduce or emit the left virtual audio signal (A300/D225/C150/E75/B0).

From the above described it can be understood that;

The A100 value emitted by the left lateral central mono system interacts in the acoustic space with the A200 value emitted by the left lateral mono system, thus creating the new A300 value that is perceived from the left virtual signal, the D100 value emitted by the left lateral central mono system interacts in the acoustic space with the D125 value emitted by the left lateral mono system, thus creating the new D225 value that is perceived from said left virtual signal, the C100 value emitted by the left lateral central mono system interacts in the acoustic space with the value C50 emitted by the left lateral mono system, thus creating the new value C150 that is perceived from said left virtual signal, the value E100 emitted by the left lateral central mono system interacts in the acoustic space with the value −E25 emitted by the left lateral mono system, thus creating the new value E75 that is perceived from said left virtual signal, the value B100 emitted by the left lateral central mono system interacts in the acoustic space with the value −B100 emitted by the left lateral mono system, thus creating the new B0 value that is perceived from said left virtual signal.

The Y3 audio signal emitted by the right lateral mono audio playback system interacts with the Z3 audio signal emitted by the right lateral central mono audio playback system, therefore; the values of Y3 (−A100/−D25/C50/E125/B200) interact with the values of Z3 (A100/D100/C100/E100/B100) resulting in the values (A0/D75/C150/E225/B300), where said values can be considered as a right virtual audio signal, as shown in FIG. 25.

It should be noted that said resulting panning values (A0/D75/C150/E225/B300) are perceived in the middle of said mono systems placed in the right part of the acoustic space, therefore, it seems as if both mono systems, together, play or output said right virtual audio signal (A0/D75/C150/E225/B300).

From the above described it can be understood that;

The A100 value emitted by the right lateral central mono system interacts in the acoustic space with the −A100 value emitted by the right lateral mono system, thus creating the new A0 value that is perceived from the right virtual signal, the D100 value emitted by the right lateral central mono system interacts in the acoustic space with the value-D25 emitted by the right lateral mono system, thus creating the new value D75 that is perceived from said right virtual signal, the value C100 emitted by the right lateral central mono system interacts in the acoustic space with the C50 value emitted by the right lateral mono system, thus creating the new C150 value that is perceived from said right virtual signal, the E100 value emitted by the right lateral central mono system interacts in the acoustic space with the value E125 emitted by the right lateral mono system, thus creating the new value E225 that is perceived from said right virtual signal, the value B100 emitted by the right lateral central mono system interacts in the acoustic space with the value B200 emitted by the right lateral mono system, thus creating the new B300 value that is perceived from said right virtual signal.

Subsequently, said left virtual audio signal resulting from the interaction between the signals emitted by the two left mono systems interacts with said right virtual audio signal resulting from the interaction between the signals emitted by the two right mono systems, therefore; The values of the left virtual audio signal (A300/D225/C150/E75/B0) interact with the values of the right virtual audio signal (A0/D75/C150/E225/B300) resulting in the values (A300/D300/C300/E300/B300), where these values represent the acoustic result perceived by the listener.

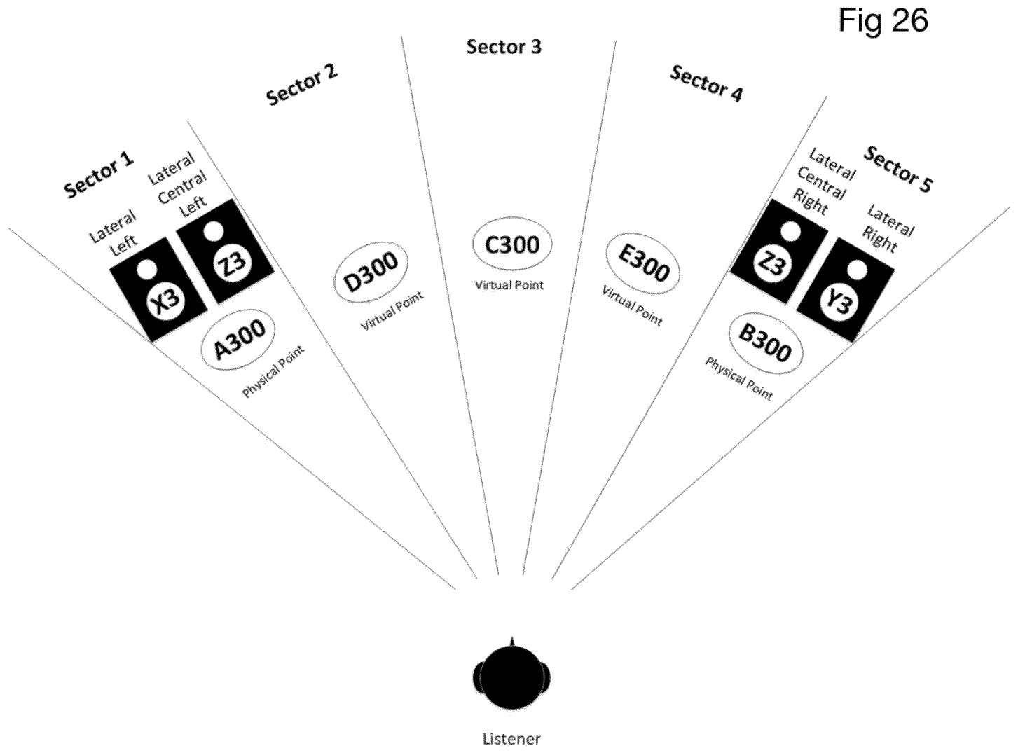

It should be noted that these resulting panning values (A300/D300/C300/E300/B300) are perceived in an equidistant, balanced and homogeneous manner throughout the horizontal acoustic space between the mono systems placed on the left side and the mono systems placed on the right side, a person skilled in the art can understand that said exact location of the perception of said panning points A, D, C, E, B is due to the interaction of their corresponding values between the left and right virtual signals, Therefore, it is possible to perceive each of the said panning points A, D, C, E, B individually and separately in the acoustic space, where each panning point has its respective values (A300/D300/C300/E300/B300), as shown in FIG. 26. In order to improve the understanding of the above described, the horizontal acoustic space existing between the mono systems placed on the left side and the mono systems placed on the right side can be divided into sectors, with 5 sectors, one for each point, in such a way, so that point A300, which can be considered as a physical panning point can be perceived in sector 1, point D300, which can be considered as a virtual panning point can be perceived in sector 2, point C300, which can be considered as a virtual panning point can be perceived in sector 3, point E300, which can be considered as a virtual panning point can be perceived in sector 4, point B300, which can be considered as physical panning point can be perceived in sector 5, as shown in FIG. 26.

From the above described it can be understood that;

The value A300 that is perceived from the left virtual signal interacts in the acoustic space with the value A0 that is perceived from the right virtual signal, thus creating the new value A300, which can be perceived in sector 1 of the acoustic space, the value D225 that is perceived from the left virtual signal interacts in the acoustic space with the value D75 that is perceived from the right virtual signal, thus creating the new value D300, which can be perceived in sector 2 of the acoustic space, the value C150 that is perceived from the left virtual signal interacts in the acoustic space with the value C150 that is perceived from the right virtual signal, thus creating the new value C300, which can be perceived in sector 3 of the acoustic space, the value E75 that is perceived from the left virtual signal interacts in the acoustic space with the value E225 that is perceived from the right virtual signal, thus creating the new value E300, which can be perceived in sector 4 of the acoustic space, the value B0 that is perceived from the left virtual signal interacts in the acoustic space with the value B300 that is perceived from the right virtual signal, thus creating the new value B300, which can be perceived in sector 5 of the acoustic space.

It should be noted that the way in which the interaction between the audio signals X3 and Z3 is described to generate the left virtual audio signal, as well as the way in which the interaction between the audio signals Y3 and Z3 is described to generate the right virtual audio signal, as well as how the interaction between the left virtual signal and the right virtual signal is described to give the location of the 5 main pan points A, D, C, E and B in the acoustic space, are shown in an exemplary but non-limiting way, in addition, it must also be considered that said interactions are described in relation to the listener's perception and the interpretation of the brain when said listener is positioned at the maximum point of appreciation also known as a sweet spot of the present reproduction mode.

On the other hand, it is important to understand that such a dynamic playback system of the present mode could be replicated “n” times on different planes in relation to the listener or in any other possible configuration to simultaneously reproduce any type of multichannel audio composed of “n” number of channel pairs or signals of type L and R.

### Exemplary Modality 3—Quadraphonic Playback System

### Specifications and Placement of Playback Equipment

The quadraphonic playback system described below is composed by at least four mono audio playback systems capable of reproducing or transmitting a full range of high, mid and bass frequencies that could range from 10 Hz to 20 KHz, In addition, it is clear to understand that the characteristics of such at least four mono audio reproduction systems, such as their size, power, decibel calibration, etc., in a preferred mode may be the same, or present certain variations, provided that the signals emitted exhibit the characteristics that allow the objective acoustic result.

As mentioned above, the quadraphonic playback system of this modality is composed of at least four mono audio playback systems, which, in a preferred modality, are strategically placed in the acoustic space and in relation to the listener;

Where, in a preferred modality, two mono audio playback systems are placed on the left side in relation to the listener, which we name as the left lateral mono system and left frontal central mono system, in addition, two mono audio reproduction systems are placed on the right side in relation to the listener, which we name as the right lateral mono system and right frontal central mono system.

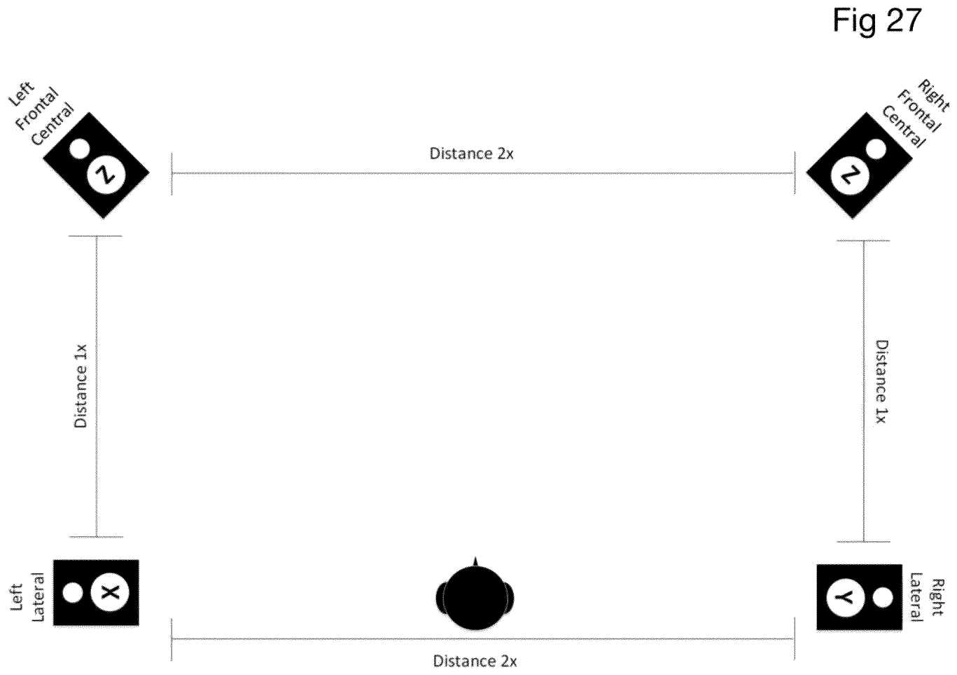

In a preferred modality, the distance between the left lateral mono system in relation to the listener would be the same distance between the right lateral mono system in relation to the listener, and these mono systems would be positioned in a straight line in such a way that the listener is right in the middle of both, in addition, in a preferred modality these mono systems would be in aligned orientation towards the listener's head, as shown in FIG. 27.

In a preferred modality, the distance between the left lateral mono system in relation to the left frontal central mono system would be the same distance between the right lateral mono system and the right frontal central mono system, where the said left frontal central mono system and right frontal central mono system would be placed at the front of the acoustic space in relation to the listener in such a way that a rectangle can be formed considering the four mono systems as the 4 vertices of said rectangle, in addition, these central front left mono system and central front right monkey system would be in aligned orientation towards the listener's head, as shown in FIG. 27.

In addition, in a preferred mode, the height of these four mono audio playback systems would be the same and the optimal height would be delimited by the listener's head, however, a subject matter expert may understand that this height may vary if the necessary adjustments are made so that the orientation angle of these four mono systems is oriented towards the listener's head.

It is clear to understand that all of the above described is necessary for the listener to enjoy the maximum point of appreciation, also known as the sweet spot, however, the distance between the left frontal central mono system in relation to the right frontal central mono system can decrease or increase as necessary according to the requirements of the physical space. This, without the need to make any modification in the placement of the left lateral mono system or in the placement of the right lateral mono system, so that this rectangle would become an isosceles trapezoid, which would not cause any significant impact on the expected result.

### Assigning Signals to Mono Systems

As mentioned throughout the present invention, a trisonic audio is made up of 3 audio signals, which, as mentioned above, we will identify as X, Y, Z.

It is important to understand that these 4 mono audio playback systems used in this playback mode reproduce the trisonic audio together, i.e., these 4 mono systems play together the 3 audio signals X, Y, Z;

Where, the left lateral mono audio playback system is set to receive and play the X audio signal, the left frontal central mono audio playback system is set to receive and play the Z audio signal, the right lateral mono audio playback system is configured to receive and play the Y audio signal and the right frontal central mono audio playback system is also configured to receive and play the Z audio signal, as shown in FIG. 27.

### Quadraphonic Spatial Panning Effect

As mentioned above, the quadraphonic playback system of the present playback mode can reproduce both the X2, Y2, Z2 signals of one trisonic audio mode and the X3, Y3, Z3 signals of another trisonic audio mode, however, the acoustic result, which we call the quadraphonic spatial panning effect, It will have different acoustic results depending on the trisonic audio mode to be played.

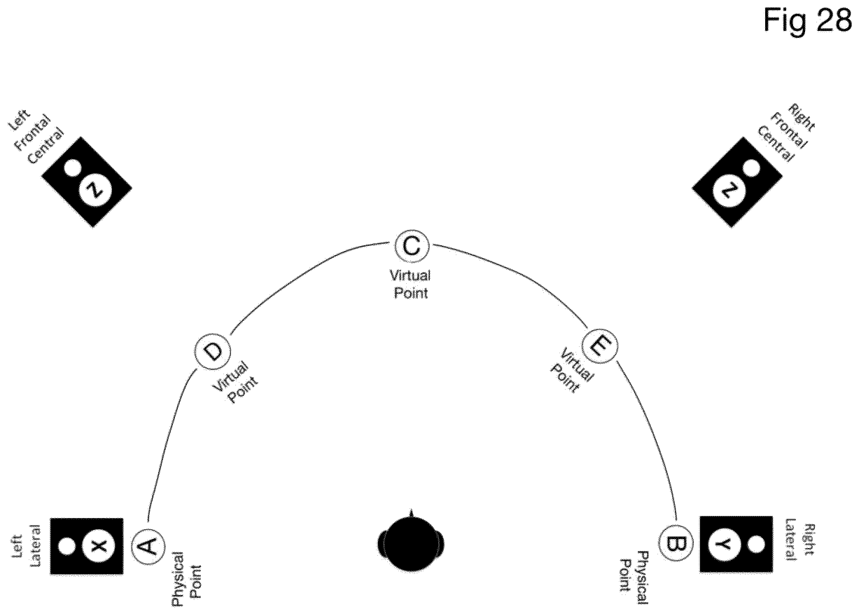

It is important to understand that this quadraphonic spatial panning effect occurs during the appreciation of sounds in acoustic space, i.e., during the appreciation of sounds corresponding to X, Y, Z signals; Where this effect consists of the total, balanced and homogeneous appreciation of the 5 main panning points of a stereophonic mixture A, D, C, E, B in the acoustic space formed by the placement of the 4 mono systems corresponding to the quadraphonic playback system of the present playback modality, which forms a kind of semicircle or horseshoe taking as a reference the points of perception of the virtual signals, the left lateral mono system and the right lateral mono system, as shown in FIG. 28.

It should be noted that 2 of the said 5 panning points can be considered as physical panning points and 3 of the said 5 panning points can be considered as virtual panning points.

It is important to note that such quadraphonic spatial panning effect will result in the correct manner regardless of whether such X, Y, Z signals were generated with the magnetic collision system of the present invention or with the electrical collision system of the present invention.

It should be noted that each of the aforementioned X, Y, Z signals are composed of a specific percentage of each of the 5 main panning points that we call as panning values, so this quadraphonic spatial panning effect is due to the interaction between these values when these sounds are emitted in the acoustic space.

It should be noted that the interaction process described below to create the quadraphonic spatial panning effect requires the elimination and/or incorporation of the pan point values that make up each of the X, Y, Z audio signals, where such removal and/or incorporation only occurs between the values of the same letter, so, for example, the percentage or panning point value of A for signal X can be added, subtracted, or maintained only with the percentage or panning point value of A for signal Y, signal Z, or any other signal with which the interaction is taking place, and so on, the same with the other panning points D, C, E, B.

Quadraphonic spatial panning effect with X2, Y2, Z2 signals from a trisonic audio

As mentioned above, the Z2 audio signal must be emitted by both the left frontal central mono system and the right frontal central mono system, unlike the quadraphonic playback system mode, this Z2 signal must be divided into two equal parts so that these mono systems emit the necessary panning values (A50/D50/C50/E50/50) for this quadraphonic spatial panning effect to occur the right way.

Exemplarily but not limited to, the X2, Y2, Z2 signals of a trisonic audio interact in the acoustic space to achieve the quadraphonic spatial panning effect as follows;

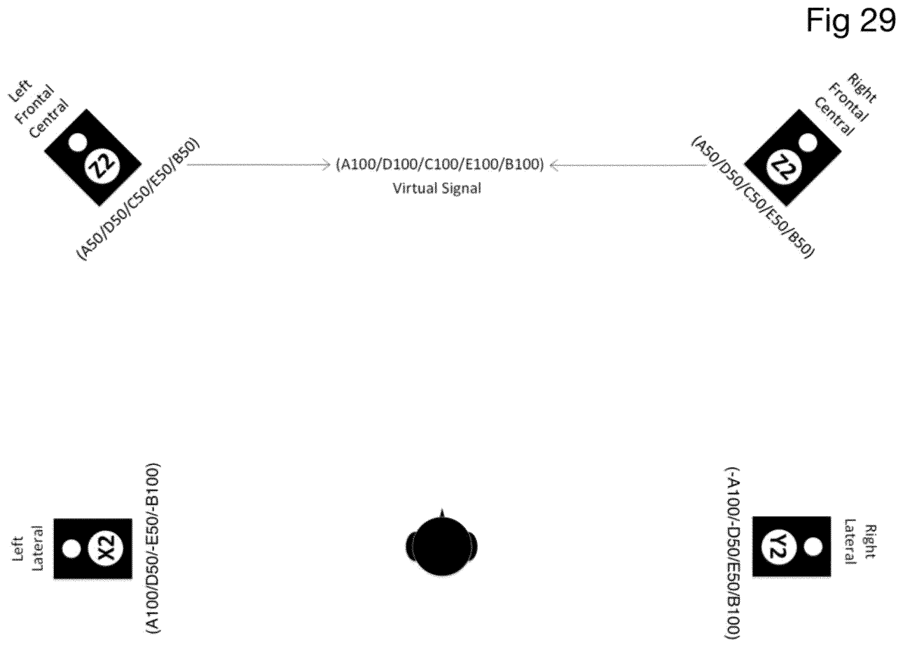

The Z2 audio signal emitted by the left frontal central mono audio playback system interacts with the Z2 audio signal emitted by the right frontal central mono audio playback system, therefore; the Z2 values (A50/D50/C50/E50/B50) interact with the Z2 values (A50/D50/C50/E50/E50/50) resulting in the values (A100/D100/C100/E100/B100), where such values can be thought of as a virtual audio signal, as shown in FIG. 29.

It should be noted that these resulting panning values (A100/D100/C100/E100/100) are perceived in the middle of the said mono systems placed in the left front and right front part of the acoustic space, therefore, it seems as if there is another mono system just half the distance between said left frontal central mono system and said right frontal central mono system, which appears to reproduce or emit such a virtual audio signal (A100/D100/C100/E100/B100, as shown in FIG. 29.

From the above described it can be understood that;

The A50 value emitted by the left frontal central mono system interacts in the acoustic space with the A50 value emitted by the right frontal central mono system, thus creating the new A100 value that is perceived from the virtual signal, the D50 value emitted by the left frontal central mono system interacts in the acoustic space with the D50 value emitted by the right frontal central mono system, thus creating the new D100 value that is perceived from said virtual signal, the C50 value emitted by the left frontal central mono system interacts in the acoustic space with the value C50 emitted by the right frontal central mono system, thus creating the new value C100 that is perceived from said virtual signal, the E50 value emitted by the left frontal central mono system interacts in the acoustic space with the value E50 emitted by the right frontal central mono system, thus creating the new value E100 that is perceived from said virtual signal, the B50 value emitted by the left frontal central mono system interacts in the acoustic space with the B50 value emitted by the right frontal central mono system, thus creating the new B100 value that is perceived from said virtual signal.

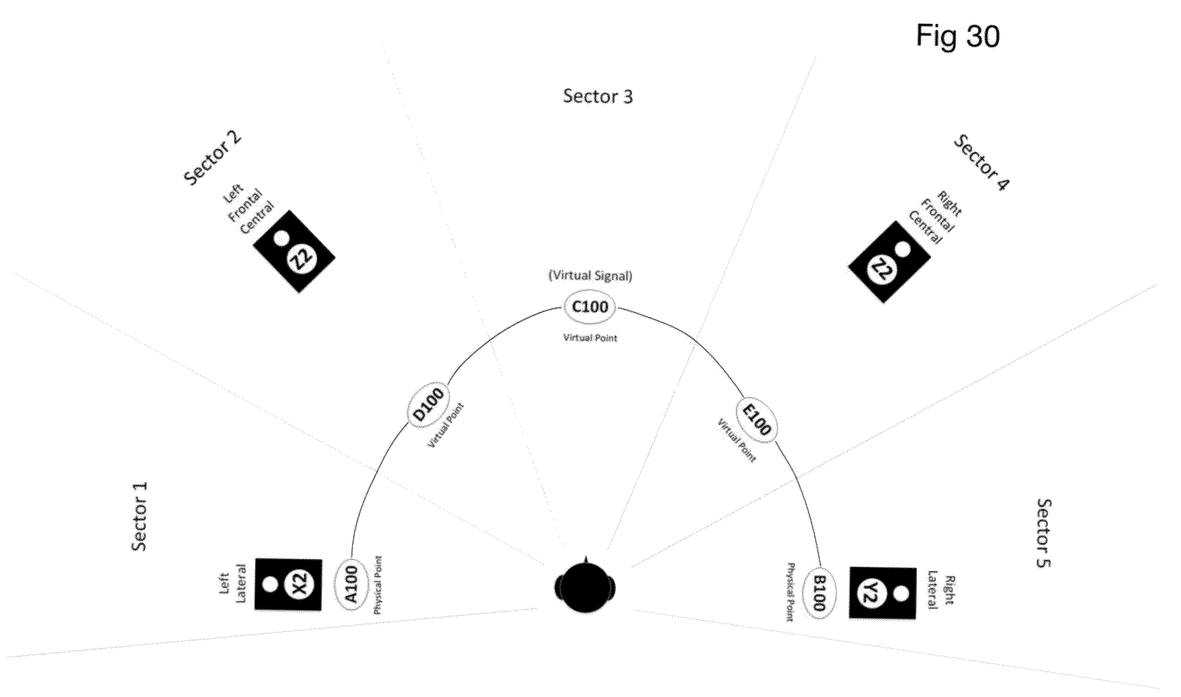

Subsequently, the resulting virtual audio signal interacts with both the X2 audio signal emitted by the left lateral mono system and the Y2 audio signal emitted by the right lateral mono system, therefore, using the same FIG. 29 as a reference; the values of the virtual audio signal (A100/D100/C100/E100/B100) interact with both the values of the X2 audio signal (A100/D50/−E50/−B100) and the values of the Y2 audio signal (−A100/−D50/E50/B100) resulting in the values (A100/D100/C100/E100/B100), where these values represent the acoustic result perceived by the listener, as shown in FIG. 30.

It should be noted that these resulting panning values (A100/D100/C100/E100/B100) are perceived in an equidistant, balanced and homogeneous manner throughout the acoustic space, which forms a kind of semicircle or horseshoe taking as a reference the points of perception of the virtual signals, the left lateral mono system and the right lateral mono system. A subject matter expert may understand that the exact location of the perception of such panning points A, D, C, E, B is due to the interaction of their corresponding values between the virtual audio signal and the X2 audio signal, as well as between the virtual audio signal and the audio signal Y2, therefore, it is possible to perceive individually and separately each of the aforementioned panning points A, D, C, E, B in the acoustic space, where each panning point has its respective values (A100/D100/C100/E100/B100), as shown in FIG. 30.

In order to improve the understanding of the above described, the acoustic space in the shape of an isosceles triangle can be divided into sectors, being 5 sectors, one for each point, in such a way that point A100, which can be considered as a physical point of panning, can be perceived in sector 1, point D100, which can be considered as a virtual panning point can be perceived in sector 2, point C100, which can be considered as virtual panning point can be perceived in sector 3, point E100, which can be considered as virtual panning point can be perceived in sector 4, point B100, which can be considered as the physical panning point, can be perceived in sector 5, as shown in FIG. 30.

From the above described it can be understood that;

The A100 value that is perceived from the virtual signal interacts in the acoustic space with the −A100 value emitted by the right lateral mono system, which causes these values to cancel each other out, therefore the A100 value of the left lateral mono system does not interact with any other value, maintaining this A100 value, which can be perceived in sector 1 of the acoustic space.

The D100 value that is perceived from the virtual signal interacts in the acoustic space with the −D50 value emitted by the right lateral mono system, which causes the virtual signal to remain with the D50 value, which interacts with the D50 value emitted by the left lateral mono system, thus creating the new D100 value, which can be perceived in sector 2 of the acoustic space.

The C100 value that is perceived from the virtual signal does not interact in the acoustic space with any value, because the right lateral mono system does not contain any value of C, in the same way, the left lateral mono system does not contain any value of C, therefore the C100 value that is perceived from the virtual signal can be perceived in sector 3 of the acoustic space.

The E100 value that is perceived from the virtual signal interacts in the acoustic space with the −E50 value emitted by the left lateral mono system, which causes the virtual signal to remain with the E50 value, which interacts with the E50 value emitted by the right lateral mono system, thus creating the new E100 value, which can be perceived in sector 4 of the acoustic space.

The value B100 that is perceived from the virtual signal interacts in the acoustic space with the value −B100 emitted by the left lateral mono system, which causes these values to cancel each other, therefore the B100 value of the right lateral mono system does not interact with any other value, maintaining this value B100, which can be perceived in sector 5 of the acoustic space.

It should be noted that the way in which the interaction between the front left Z2 audio signal and the front right Z2 audio signal is described to generate the virtual audio signal, as well as the way in which the interaction between the virtual audio signal and the X2 and Y2 audio signals is described to give the location of the 5 main pan points A, D, C, E and B in the acoustic space, are shown in an exemplary but not limitative way, in addition, it should also be considered that these interactions are described in relation to the perception of the listener and the interpretation of the brain when said listener is positioned at the maximum point of appreciation also known as the sweet spot of the present playback mode.

Quadraphonic spatial panning effect with X3, Y3, Z3 signals from a trisonic audio

As mentioned above, the Z3 audio signal must be emitted by both the left frontal central mono system and the right frontal central mono system, unlike the quadraphonic playback system mode, this Z3 signal must be divided into two equal parts so that these mono systems emit the necessary panning values (A50/D50/C50/E50/B50) for this quadraphonic spatial panning effect to happen correctly.

In an exemplary but non-limiting manner, the signals X3, Y3, Z3 of a trisonic audio interact in the acoustic space to achieve the quadraphonic spatial panning effect as follows;

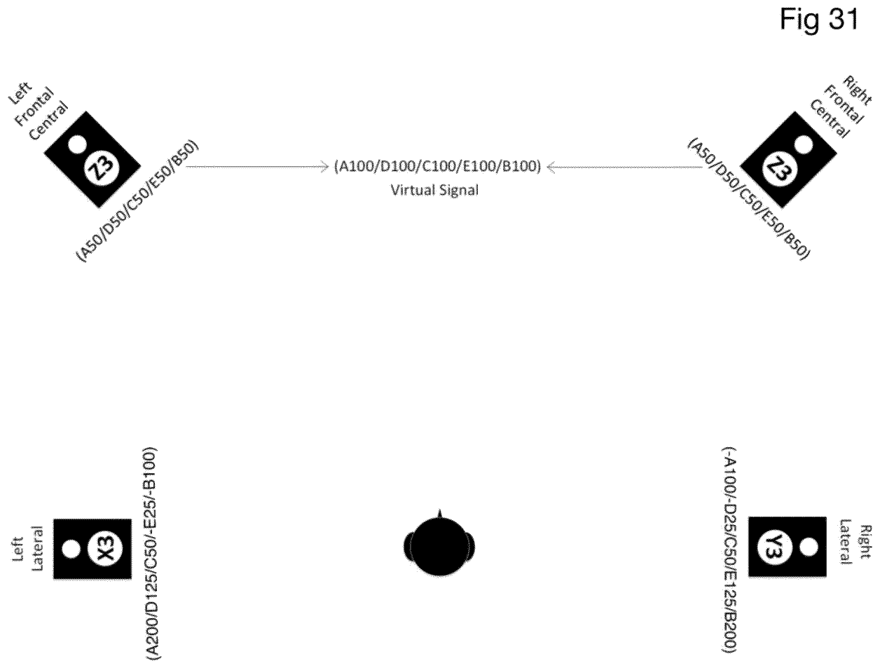

The Z3 audio signal emitted by the left frontal central mono audio playback system interacts with the Z3 audio signal emitted by the right frontal central mono audio playback system, therefore; the Z3 values (A50/D50/C50/E50/B50) interact with the Z3 values (A50/D50/C50/E50/50) resulting in the values (A100/D100/C100/E100/B100), where such values can be thought of as a virtual audio signal, as shown in FIG. 31.

It should be noted that these resulting panning values (A100/D100/C100/E100/100) are perceived in the middle of the said mono systems placed in the left front and right front part of the acoustic space, therefore, it seems as if there is another mono system just half the distance between said left frontal central mono system and said right frontal central mono system, which appears to reproduce or emit such a virtual audio signal (A100/D100/C100/E100/B100) as shown in FIG. 31.

From the above described it can be understood that;

The A50 value emitted by the left frontal central mono system interacts in the acoustic space with the A50 value emitted by the right frontal central mono system, thus creating the new A100 value that is perceived from the virtual signal, the D50 value emitted by the left frontal central mono system interacts in the acoustic space with the D50 value emitted by the right frontal central mono system, thus creating the new D100 value that is perceived from said virtual signal, the C50 value emitted by the left frontal central mono system interacts in the acoustic space with the value C50 emitted by the right frontal central mono system, thus creating the new value C100 that is perceived from said virtual signal, the E50 value emitted by the left frontal central mono system interacts in the acoustic space with the value E50 emitted by the right frontal central mono system, thus creating the new value E100 that is perceived from said virtual signal, the B50 value emitted by the left frontal central mono system interacts in the acoustic space with the B50 value emitted by the right frontal central mono system, thus creating the new B100 value that is perceived from said virtual signal.

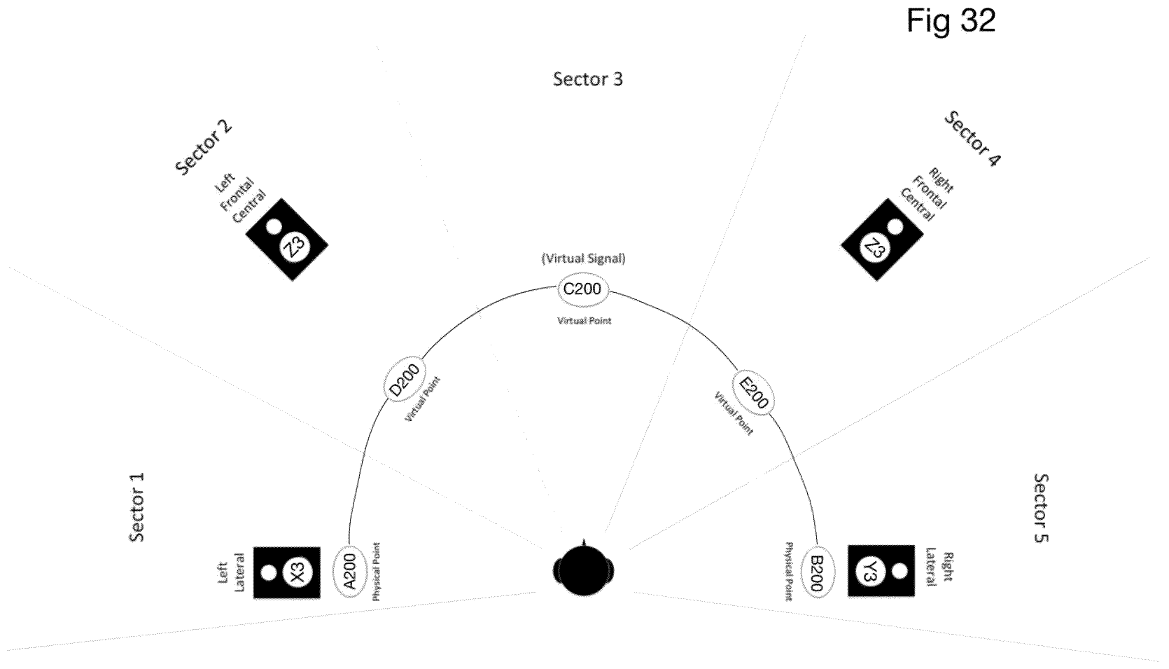

Subsequently, the resulting virtual audio signal interacts with both the X3 audio signal emitted by the left lateral mono system and the Y3 audio signal emitted by the right lateral mono system, therefore using the same FIG. 31 as a reference; the values of the virtual audio signal (A100/D100/C100/E100/B100) interact with both the values of the X3 audio signal (A200/D125/C50/−E25/−B100) and the values of the Y3 audio signal (−A100/−D25/C50/E125/B200) resulting in the values (A200/D200/C200/E200/B200), where these values represent the acoustic result perceived by the listener, as shown in FIG. 32.

It should be noted that these resulting panning values (A200/D200/C200/E200/B200) are perceived in an equidistant, balanced and homogeneous way throughout the acoustic space, which forms a kind of semicircle or horseshoe taking as a reference the points of perception of the virtual signals, the left lateral mono system and the right lateral mono system. A subject matter expert may understand that the exact location of the perception of such panning points A, D, C, E, B is due to the interaction of their corresponding values between the virtual audio signal and the X3 audio signal, as well as between the virtual audio signal and the audio signal Y3, therefore, it is possible to perceive individually and separately each of the said panning points A, D, C, E, B in the acoustic space, where each panning point has its respective values (A200/D200/C200/E200/B200), as shown in FIG. 32.

In order to improve the understanding of the above described, the acoustic space in the shape of an isosceles triangle can be divided into sectors, being 5 sectors, one for each point, in such a way that point A200, which can be considered as a physical point of panning, can be perceived in sector 1, point D200, which can be considered as a virtual panning point can be perceived in sector 2, point C200, which can be considered as virtual panning point can be perceived in sector 3, point E200, which can be considered as virtual panning point can be perceived in sector 4, point B200, which can be considered as the physical panning point, can be perceived in sector 5, as shown in FIG. 32.

From the above described it can be understood that;

The A100 value that is perceived from the virtual signal interacts in the acoustic space with the −A100 value emitted by the right lateral mono system, which causes these values to cancel each other, therefore the A200 value of the left lateral mono system does not interact with any other value, maintaining this A200 value, which can be perceived in sector 1 of the acoustic space.

The perceived value D100 of the virtual signal interacts in the acoustic space with the value −D25 emitted by the right lateral mono system, which causes the virtual signal to remain with the D75 value, which interacts with the D125 value emitted by the left lateral mono system, thus creating the new D200 value, which can be perceived in sector 2 of the acoustic space.

The C100 value that is perceived from the virtual signal interacts in the acoustic space with the C50 value emitted by the right lateral mono system and at the same time, the C100 value that is perceived from the virtual signal interacts in the acoustic space with the C50 value that is emitted by the left lateral mono system, thus creating the new C200 value, which can be perceived in sector 3 of the acoustic space.

The E100 value that is perceived from the virtual signal interacts in the acoustic space with the −E25 value emitted by the left lateral mono system, which causes the virtual signal to remain with the E75 value, which interacts with the E125 value emitted by the right lateral mono system, thus creating the new E200 value, which can be perceived in sector 4 of the acoustic space.

The value B100 that is perceived from the virtual signal interacts in the acoustic space with the value −B100 emitted by the left lateral mono system, which causes these values to cancel each other, therefore the B200 value of the right lateral mono system does not interact with any other value, maintaining this value B200, which can be perceived in sector 5 of the acoustic space.

It should be noted that the way in which the interaction between the front left Z3 audio signal and the front right Z3 audio signal is described to generate the virtual audio signal, as well as the way in which the interaction between the virtual audio signal and the X3 and Y3 audio signals is described to give the location to the 5 main pan points A, D, C, E and B in the acoustic space, are shown in an exemplary but not limitative way, in addition, it should also be considered that these interactions are described in relation to the perception of the listener and the interpretation of the brain when said listener is positioned at the maximum point of appreciation also known as the sweet spot of the present mode of reproduction.

On the other hand, it is important to understand that such a quadraphonic playback system of the present modality could be replicated “n” times on different planes in relation to the listener or in any other possible configuration to simultaneously reproduce any type of multichannel audio composed of “n” number of channel pairs or signals of type L and R.

### Exemplary Mode 4—Auricular Playback System

### Specifications and Placement of Playback Equipment

The auricular playback system described below consists of two auriculars comprising at least two auricular mono systems in each of the said two auriculars, where such auricular mono systems are capable of reproducing or transmitting a full range of high, mid and low frequencies, from 10 Hz to 20 KHz, In addition, it is clear to understand that the characteristics of these four auricular mono systems, such as their size, power, decibel calibration, etc., in a preferred mode these characteristics may be the same, or present certain variations, provided that the signals emitted present the characteristics that allow the objective acoustic result.

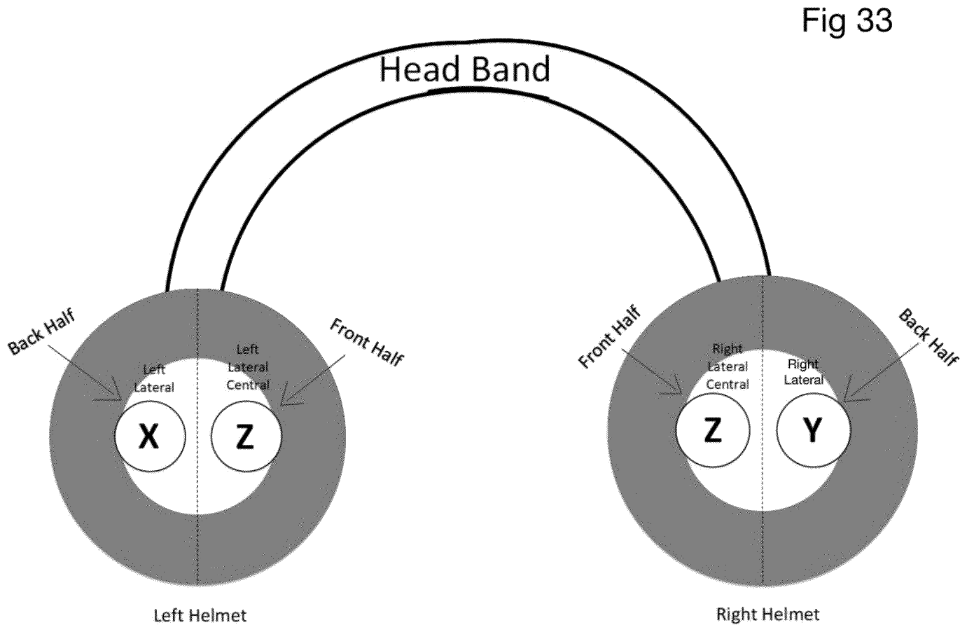

For example, in a preferred modality, the distribution of these four auricular mono systems within the said pair of over-ear headphones or headphones can be described, in which these headphones are divided into two symmetrical parts that we name as the back half and the front half, as shown in FIG. 33.

Where, the left helmet contains two of the four aforementioned auricular mono systems, which we name as the left lateral auricular mono system and the left lateral central auricular mono systems, where these auricular mono systems are placed next to each other in a horizontal line in relation to the listener's head. In addition, the left lateral auricular mono system is placed on the back half of the left helmet and the left lateral central auricular mono system is placed on the front half of the same left helmet, as shown in FIG. 33.

In the same way, the right helmet contains the other two of the four auricular mono systems, which we name as the right lateral auricular mono system and the right lateral central auricular mono system, it should be noted that these auricular mono systems are also placed next to each other in a horizontal line in relation to the listener's head. In addition, the right lateral auricular mono system is placed on the back half of the right helmet and the right lateral central auricular mono system is placed on the front half of the same right helmet, as shown in FIG. 33.

It is important to understand that all of the above described corresponds only to an exemplary modality of an over-ear or headphone type auricular playback system, however, such above description may also correspond to an in-ear auricular playback system or any other type of headphones with compatible characteristics.

### Assigning Signals to Auricular Mono Systems

As mentioned throughout the present invention, a trisonic audio is made up of 3 audio signals, which, as mentioned above, we will identify as X, Y, Z.

It is important to understand that these 4 auricular mono playback systems used in this playback mode reproduce the trisonic audio together, i.e., these 4 auricular mono playback systems reproduce the 3 X, Y, Z audio signals together;

Where, the left lateral auricular mono system is configured to receive and play the X audio signal, the left lateral central auricular mono system is configured to receive and play the Z audio signal, the right lateral auricular mono system is configured to receive and play the Y audio signal and the right lateral central auricular mono system is also configured to receive and play the Z audio signal, as shown in FIG. 33.

### Auricular Spatial Panning Effect

As mentioned above, the Auricular playback system of this playback mode can reproduce both the X2, Y2, Z2 signals of one trisonic audio mode and the X3, Y3, Z3 signals of another trisonic audio mode, however, the perceived result in the simulation of the acoustic space, which we call the Headset spatial panning effect, will have different results depending on the trisonic audio mode to be played.

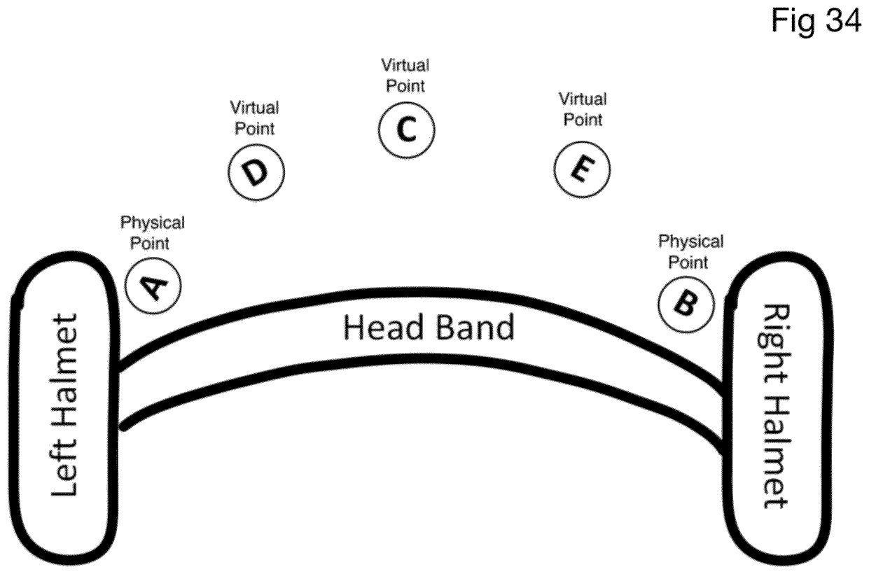

It is important to understand that this auricular spatial panning effect occurs during the appreciation of sounds in the simulation of acoustic space created by means of the aforementioned two over-ear headphones, also known as headsets, that is, during the appreciation of the sounds corresponding to the X, Y, Z signals; Where this effect consists in the total, balanced and homogeneous appreciation of the 5 main panning points of a stereophonic mixture A, D, C, E, B in the simulation of the horizontal acoustic space created by means of the said two over-ear headphones corresponding to the auricular playback system of the present playback mode, as shown in FIG. 34.

It should be noted that 2 of the said 5 panning points can be considered as physical panning points and 3 of the said 5 panning points will be interpreted as virtual panning points.

An expert in the field can understand that when a person listens to audio through headphones of any kind, the brain picks up both the corresponding sounds of the signal or signals it perceives in the left ear and the corresponding sounds of the signal or signals it perceives in the right ear, resulting in the simulation of an acoustic space where the location of the 5 main panning points A, D, C, E, B can be identified.

It is important to note that such auricular spatial panning effect will result in the correct manner regardless of whether such X, Y, Z signals were generated with the magnetic collision system of the present invention or with the electrical collision system of the present invention.

It should be noted that each of the aforementioned X, Y, Z signals are composed of a specific percentage of each of the said 5 main panning points that we name as panning values, so that this effect of auricular spatial panning is due to the interaction between these values when these sounds are emitted through the said headphones of this playback mode.

It should be noted that the interaction process described below to create the auricular spatial panning effect requires the removal and/or incorporation of the pan point values that make up each of the X, Y, Z audio signals, where such removal and/or incorporation only occurs between the values of the same letter, so, for example, the percentage or panning point value of A for signal X can be added, subtracted, or maintained only with the percentage or panning point value of A for signal Y, signal Z, or any other signal with which the interaction is taking place, and so on, the same with the other panning points D, C, E, B.

Auricular spatial panning effect with X2, Y2, Z2 of a trisonic audio

Exemplarily but not limited to, the X2, Y2, Z2 signals of a trisonic audio interact in the simulation of the acoustic space created by means of the headphones to achieve the effect of auricular spatial panning as follows;

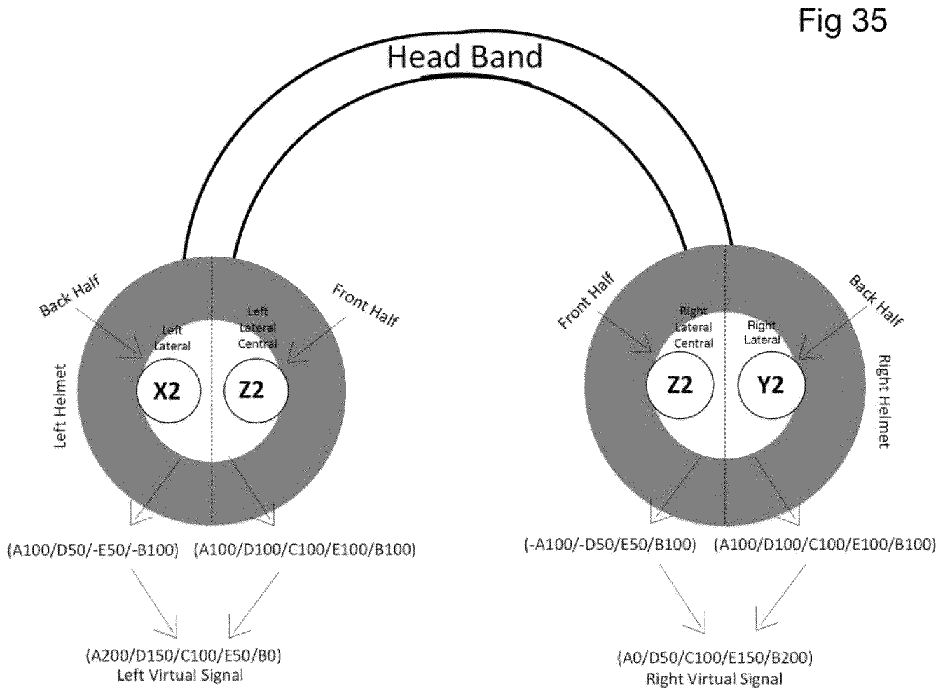

The X2 audio signal emitted by the left lateral auricular mono system interacts with the Z2 audio signal emitted by the left lateral central auricular mono system, therefore; the values of X2 (A100/D50/−E50/−B100) interact with the values of Z2 (A100/D100/C100/E100/B100) resulting in the values (A200/D150/C100/E50/B0), where these values can be thought of as a virtual audio signal left, as shown in FIG. 35.

It should be noted that these resulting panning values (A200/D150/C100/E50/B0) are perceived in the middle of the said auricular mono systems that are inside the left helmet, therefore, it seems as if both auricular mono systems, together, reproduce or emit said left virtual audio signal (A200/D150/C100/E50/B0).

From the above described it can be understood that;

The A100 value emitted by the left lateral central auricular mono system interacts inside the left helmet with the A100 value emitted by the left lateral auricular mono system, thus creating the new A200 value that is perceived from the left virtual signal, the D100 value emitted by the left lateral central auricular mono system interacts inside the left helmet with the D50 value emitted by the left lateral auricular mono system, thus creating the new value D150 that is perceived from the said left virtual signal, the value C100 emitted by the left lateral central auricular mono system is maintained because the left lateral auricular mono system does not emit any value of C, thus creating the new value C100 that is perceived from the said left virtual signal, the E100 value emitted by the left lateral central auricular mono system interacts inside the left helmet with the value −E50 emitted by the left lateral auricular mono system, thus creating the new E50 value that is perceived from the left virtual signal, the B100 value emitted by the left lateral central auricular mono system interacts inside the left helmet with the −B100 value emitted by the left lateral auricular mono system, thus creating the new B0 value that is perceived from the said left virtual signal.

The audio signal Y2 emitted by the right lateral auricular mono system interacts with the audio signal Z2 emitted by the right lateral central auricular mono system, therefore; the values of Y2 (−A100/−D50/E50/B100) interact with the values of Z2 (A100/D100/C100/E100/B100) resulting in the values (A0/D50/C100/E150/B200), where such values can be thought of as a right virtual audio signal, as shown in FIG. 35.

It should be noted that these resulting pan values (A0/D50/C100/E150/B200) are perceived in the middle of the said auricular mono systems that are inside the right headset, therefore, it seems as if both auricular mono systems, together, reproduce or emit said right virtual audio signal (A0/D50/C100/E150/B200).

From the above described it can be understood that;

The A100 value emitted by the right lateral central auricular mono system interacts inside the right helmet with the −A100 value emitted by the right lateral auricular mono system, thus creating the new A0 value that is perceived from the right virtual signal, the D100 value emitted by the right lateral central auricular mono system interacts inside the right helmet with the −D50 value emitted by the right lateral auricular mono system, thus creating the new value D50 that is perceived from the said right virtual signal, the value C100 emitted by the right lateral central auricular mono system is maintained because the right lateral auricular mono system does not emit any value of C, thus creating the new value C100 that is perceived from the said right virtual signal, the E100 value emitted by the right lateral central auricular mono system interacts inside the right helmet with the value E50 emitted by the right lateral auricular mono system, thus creating the new E150 value that is perceived from the right virtual signal, the B100 value emitted by the right lateral central auricular mono system interacts inside the right helmet with the B100 value emitted by the right lateral auricular mono system, thus creating the new B200 value that is perceived from the said right virtual signal.

Subsequently, the said left virtual audio signal resulting from the interaction between the signals emitted by the two left auricular mono systems interacts with the said right virtual audio signal resulting from the interaction between the signals emitted by the two right auricular mono systems, therefore; the values of the left virtual audio signal (A200/D150/C100/E50/B0) interact with the values of the right virtual audio signal (A0/D50/C100/E150/B200) resulting in the values (A200/D200/C200/E200/B200), where these values represent the result in the simulation of the acoustic space perceived by the listener.

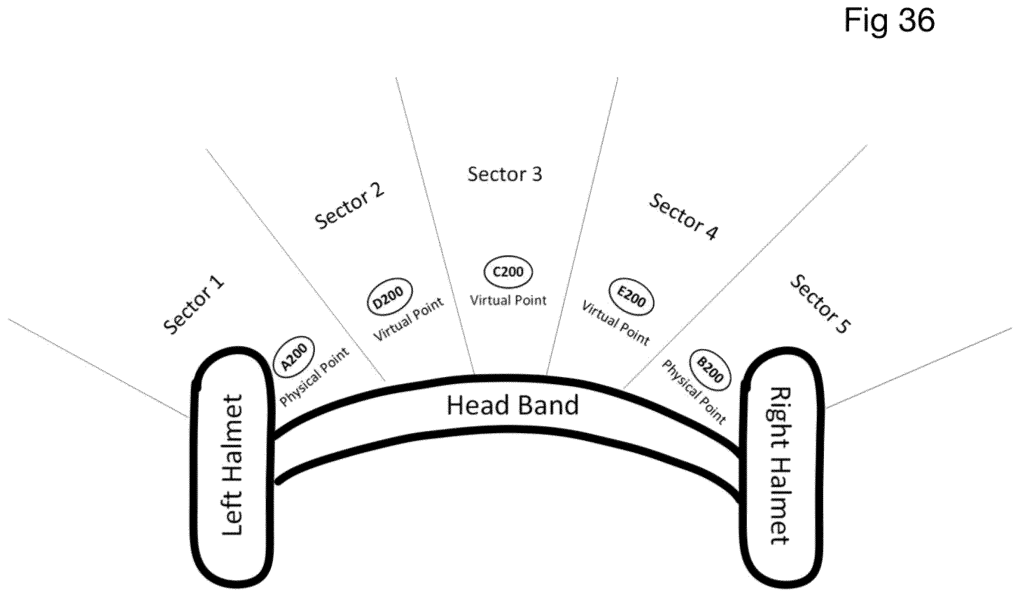

It should be noted that these resulting panning values (A200/D200/C200/E200/B200) are perceived in an equidistant, balanced and homogeneous way in the simulation of the entire horizontal acoustic space between the auricular mono systems of the left helmet and the auricular mono systems of the right helmet. An expert in the field can understand that the exact location of the perception of these panning points A, D, C, E, B is due to the interaction of their corresponding values between the left and right virtual signals, therefore, it is possible to perceive individually and separately each of the said panning points A, D, C, E, B in this simulation of the acoustic space created by means of the headphones, where each pan point has its respective values (A200/D200/C200/E200/B200), as shown in FIG. 36.

In order to improve the understanding of the above described, the simulation of the acoustic space between the auricular mono systems of the left helmet and the auricular mono systems of the right helmet can be divided into sectors, being 5 sectors, one for each point, in such a way that point A200, which can be considered as a physical point of panning, can be perceived in sector 1, point D200, which can be considered as a virtual panning point can be perceived in sector 2, point C200, which can be considered as a virtual panning point can be perceived in sector 3, point E200, which can be considered as virtual panning point can be perceived in sector 4, point B200, which can be considered as the physical panning point, can be perceived in sector 5, as shown in FIG. 36.

From the above described it can be understood that;

The A200 value perceived from the left virtual signal interacts in the simulation of the acoustic space created by the headphones with the A0 value perceived from the right virtual signal, thus creating the new A200 value, which can be perceived in sector 1 of the simulation of the acoustic space, the D150 value perceived from the left virtual signal interacts in the simulation of the acoustic space created by the headphones with the D50 value perceived from the right virtual signal, thus creating the new D200 value, which can be perceived in sector 2 of the simulation of the acoustic space, the C100 value that is perceived from the left virtual signal interacts in the simulation of the acoustic space created by means of the headphones with the C100 value that is perceived from the right virtual signal, thus creating the new C200 value, which can be perceived in sector 3 of the simulation of the acoustic space, the E50 value perceived from the left virtual signal interacts in the simulation of the acoustic space created by the headphones with the E150 value perceived from the right virtual signal, thus creating the new E200 value, which can be perceived in sector 4 of the simulation of the acoustic space, the value B0 that is perceived from the left virtual signal interacts in the simulation of the acoustic space created by means of the headphones with the value B200 that is perceived from the right virtual signal, thus creating the new value B200, which can be perceived in sector 5 of the simulation of the acoustic space.

It should be noted that the way in which the interaction between the audio signals X2 and Z2 is described to generate the left virtual audio signal, as well as the way in which the interaction between the audio signals Y2 and Z2 is described to generate the right virtual audio signal, as well as how the interaction between the left virtual signal and the right virtual signal is described to give the location of the 5 main pan points A, D, C, E and B in the simulation of the acoustic space, are shown in an exemplary but non-limiting manner, in addition, it must also be considered that said interactions are described in relation to the listener's perception and the interpretation of the brain when said listener is using the headphones of this reproduction mode.

Auricular spatial panning effect with X3, Y3, Z3 of a trisonic audio

Exemplarily but not limited to, the X3, Y3, Z3 signals of a trisonic audio interact in the simulation of the acoustic space created by means of the headphones to achieve the effect of atrial spatial panning as follows;

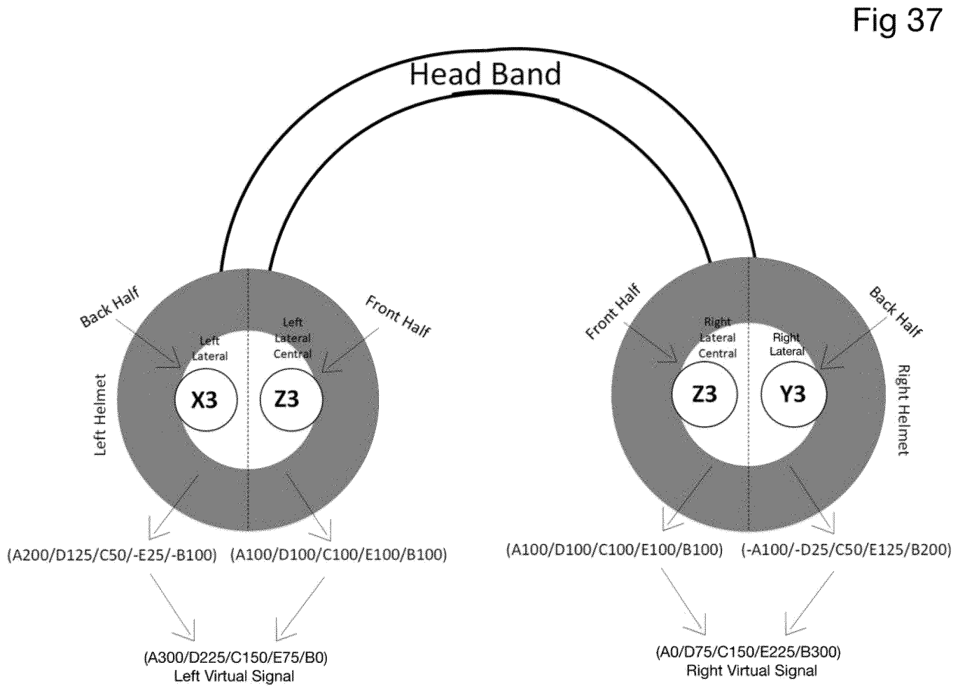

The X3 audio signal emitted by the left lateral auricular mono system interacts with the Z3 audio signal emitted by the left lateral central auricular mono system, therefore; the X3 values (A200/D125/C50/−E25/−B100) interact with the Z3 values (A100/D100/C100/E100/B100) resulting in the values (A300/D225/C150/E75/B0), where such values can be thought of as a virtual audio signal left, as shown in FIG. 37.

It should be noted that these resulting pan values (A300/D225/C150/E75/B0) are perceived in the middle of the said auricular mono systems that are inside the left helmet, therefore, it seems as if both auricular mono systems, together, reproduce or emit said left virtual audio signal (A300/D225/C150/E75/B0).

From the above described it can be understood that;

The A100 value emitted by the left lateral central auricular mono system interacts inside the left helmet with the A200 value emitted by the left lateral auricular mono system, thus creating the new A300 value that is perceived from the left virtual signal, the D100 value emitted by the left lateral central auricular mono system interacts inside the left helmet with the D125 value emitted by the left lateral auricular mono system, thus creating the new value D225 that is perceived from the said left virtual signal, the C100 value emitted by the left lateral central auricular mono system interacts inside the left helmet with the C50 value emitted by the left lateral auricular mono system, thus creating the new C150 value that is perceived from the said left virtual signal, the E100 value emitted by the left lateral central auricular mono system interacts inside the left helmet with the −E25 value emitted by the left lateral auricular mono system, thus creating the new E75 value that is perceived from the left virtual signal, the B100 value emitted by the left lateral central auricular mono system interacts inside the left helmet with the −B100 value emitted by the left lateral auricular mono system, thus creating the new value B0 that is perceived from the said left virtual signal.

The audio signal Y3 emitted by the right lateral auricular mono system interacts with the Z3 audio signal emitted by the right lateral central auricular mono system, therefore; the values of Y3 (−A100/−D25/C50/E125/B200) interact with the values of Z3 (A100/D100/C100/E100/B100) resulting in the values (A0/D75/C150/E225/B300), where such values can be thought of as a right virtual audio signal, as shown in FIG. 37.

It should be noted that these resulting pan values (A0/D75/C150/E225/B300) are perceived in the middle of the said auricular mono systems that are inside the right headcup, therefore, it seems as if both auricular mono systems, together, reproduce or emit said right virtual audio signal (A0/D75/C150/E225/B300).

From the above described it can be understood that;

The A100 value emitted by the right lateral central auricular mono system interacts inside the right helmet with the −A100 value emitted by the right lateral auricular mono system, thus creating the new A0 value that is perceived from the right virtual signal, the D100 value emitted by the right lateral central auricular mono system interacts inside the right helmet with the −D25 value emitted by the right lateral auricular mono system, thus creating the new D75 value that is perceived from the said right virtual signal, the C100 value emitted by the right lateral central auricular mono system interacts inside the right helmet with the C50 value emitted by the right lateral auricular mono system, thus creating the new C150 value that is perceived from the said right virtual signal, the E100 value emitted by the right lateral central auricular mono system interacts inside the right helmet with the E125 value emitted by the right lateral auricular mono system, thus creating the new E225 value that is perceived from the right virtual signal, the B100 value emitted by the right lateral central auricular mono system interacts inside the right helmet with the B200 value emitted by the right lateral auricular mono system, thus creating the new B300 value that is perceived from the said right virtual signal.

Subsequently, the said left virtual audio signal resulting from the interaction between the signals emitted by the two left auricular mono systems interacts with the right virtual audio signal resulting from the interaction between the signals emitted by the two right auricular mono systems, therefore; the values of the left virtual audio signal (A300/D225/C150/E75/B0) interact with the values of the right virtual audio signal (A0/D75/C150/E225/B300) resulting in the values (A300/D300/C300/E300/B300), where these values represent the result in the simulation of the acoustic space perceived by the listener.

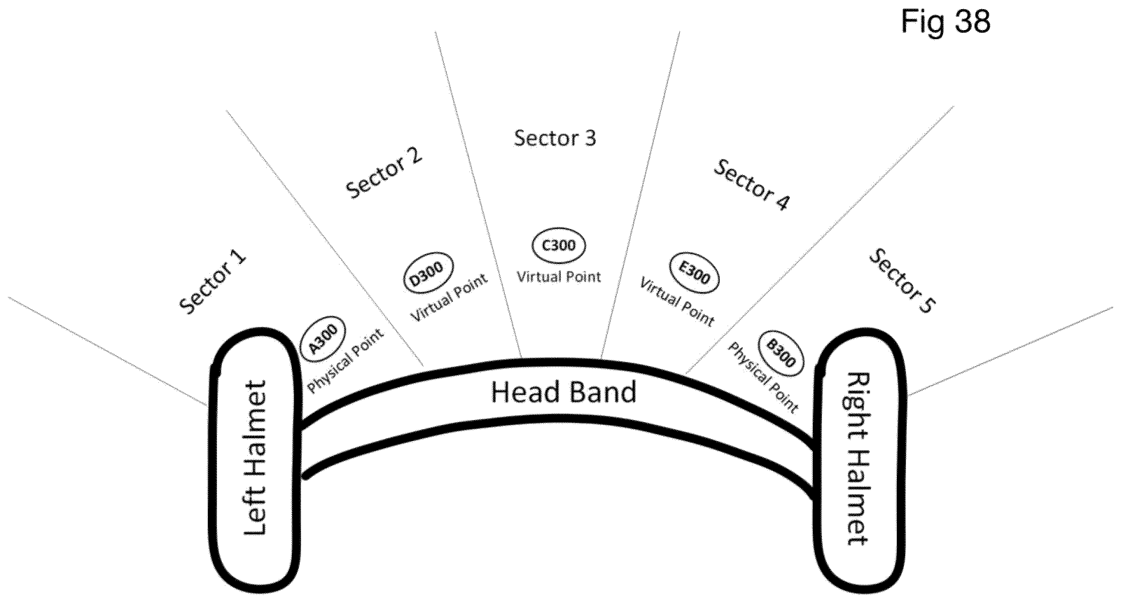

It should be noted that these resulting panning values (A300/D300/C300/E300/B300) are perceived in an equidistant, balanced and homogeneous way in the simulation of the entire horizontal acoustic space between the auricular mono systems of the left helmet and the auricular mono systems of the right helmet. An expert in the field can understand that the exact location of the perception of these panning points A, D, C, E, B is due to the interaction of their corresponding values between the left and right virtual signals, therefore, it is possible to perceive individually and separately each of the said panning points A, D, C, E, B in this simulation of the acoustic space created by means of the headphones, where each pan point has its respective values (A300/D300/C300/E300/B300), as shown in FIG. 38.

In order to improve the understanding of the above described, the simulation of the existing acoustic space between the auricular mono systems of the left helmet and the auricular mono systems of the right helmet can be divided into sectors, being 5 sectors, one for each point, in such a way that point A300, which can be considered as a physical point of panning, can be perceived in sector 1, point D300, which can be considered as a virtual panning point can be perceived in sector 2, point C300, which can be considered as virtual panning point can be perceived in sector 3, point E300, which can be considered as virtual panning point can be perceived in sector 4, point B300, which can be considered as the physical panning point, can be seen in sector 5, as shown in FIG. 38.

From the above described it can be understood that;

The A300 value perceived from the left virtual signal interacts in the acoustic space simulation created by the headphones with the A0 value perceived from the right virtual signal, thus creating the new A300 value, which can be perceived in sector 1 of said acoustic space simulation, the D225 value perceived from the left virtual signal interacts in the acoustic space simulation created by means of the headphones with the D75 value perceived from the right virtual signal, thus creating the new value D300, which can be perceived in sector 2 of said simulation of the acoustic space, the value C150 that is perceived from the left virtual signal interacts in the simulation of the acoustic space created through the headphones with the value C150 that is perceived from the right virtual signal, thus creating the new value C300, which can be perceived in sector 3 of said simulation of the acoustic space, the value E75 that is perceived from the left virtual signal interacts in the simulation of the acoustic space created by means of the headphones with the value E225 that is perceived from the right virtual signal, thus creating the new value E300, which can be perceived in sector 4 of said simulation of the acoustic space, the value B0 that is perceived from the virtual signal left interacts in the acoustic space simulation created through the headphones with the B300 value that is perceived from the right virtual signal, thus creating the new B300 value, which can be perceived in sector 5 of said acoustic space simulation.

It should be noted that the way in which the interaction between the audio signals X3 and Z3 is described to generate the left virtual audio signal, as well as the way in which the interaction between the audio signals Y3 and Z3 is described to generate the right virtual audio signal, as well as how the interaction between the left virtual signal and the right virtual signal is described to give the location of the 5 main pan points A, D, C, E and B in the simulation of the acoustic space, are shown in an exemplary but non-limiting manner, in addition, it must also be considered that said interactions are described in relation to the listener's perception and the interpretation of the brain when said listener is using the headphones of this reproduction mode.

On the other hand, it is important to understand that such an auricular playback system of the present modality could be replicated “n” times on different planes in relation to the listener or in any other possible configuration to simultaneously reproduce any type of multichannel audio composed of “n” number of channel pairs or signals of type L and R.

### Exemplary Mode 5—Vector Playback System

It is important to understand that there is an important difference in relation to the previous playback modes, that is, the previous playback modes reproduce a trisonic audio, which is composed of 3 audio signals that we call X, Y, Z, where said trisonic audio was generated from a stereophonic audio, which is composed of 2 channels or audio signals known as L and R, where such generation of trisonic audio was made through the magnetic collision system or through the electrical collision system of the present invention.

However, the present modality of the vector playback system aims at the simultaneous reproduction of two trisonic audios generated from a vector audio.

It is worth mentioning that “vector audio” should be understood as the three-dimensional panning acoustic effect produced by 4 channels or audio signals that in this description, are identified as V1, V2, V3, V4 signals.

The channels or signals of a vector audio are generated by using a 4-channel vector panning method which creates an audio image within a panoramic field bounded by X and Y axes, where the audio image is structured by 8 stereophonic panning lines that in turn allow sounds to be placed at least 25 panning points, resulting in 4 channels or signals of a vector audio with different pan value information on each channel or signal.

According to the vector playback system of this modality, a vector audio is a multichannel audio composed of 4 channels or audio signals, which can be considered as 2 pairs of channels or signals, where the first pair would be composed of channels or signals V1 and V2 and the second pair would be composed of channels or signals V3 and V4.

As mentioned above, in order to carry out the vector playback system of this modality, it is necessary to generate a first trisonic audio from the channels or signals V1 and V2 coming from said vector audio, which is done through the magnetic collision system or through the electrical collision system of the present invention. In the same way, it is necessary to generate a second trisonic audio from the channels or signals V3 and V4 coming from the same vector audio, which is done through a second magnetic collision system or through a second electrical collision system.

Therefore, the first trisonic audio is generated from channels or signals V1 and V2, where the first trisonic audio is composed of 3 audio signals, which, in order to improve the understanding of the present modality, we will identify as upper X, upper Y and upper Z.

The second trisonic audio is generated from channels or signals V3 and V4, where the second trisonic audio is composed of 3 audio signals, which, in order to improve the understanding of this modality, we will identify as lower X, lower Y and lower Z.

It is important to understand that for the generation of the lower X, lower Y and lower Z signals of the second trisonic audio, none of the corresponding upper X, upper Y and upper Z signals of the first trisonic audio are used and vice versa, i.e. for the generation of the upper X, upper Y and upper Z signals of the second trisonic audio, none of the corresponding lower X, lower Y and lower Z signals of the first trisonic audio are used.

### Specifications and Placement of Playback Equipment

The vector playback system described below consists of six mono audio playback systems capable of reproducing or transmitting a full range of high, mid and bass frequencies ranging from 10 Hz to 20 KHz, and it is clear to understand that the characteristics of these six mono audio playback systems, such as its size, wattage, decibel calibration, etc., In a preferred modality, these characteristics may be the same, or present certain variations, provided that the signals emitted have the characteristics that allow the objective acoustic result.

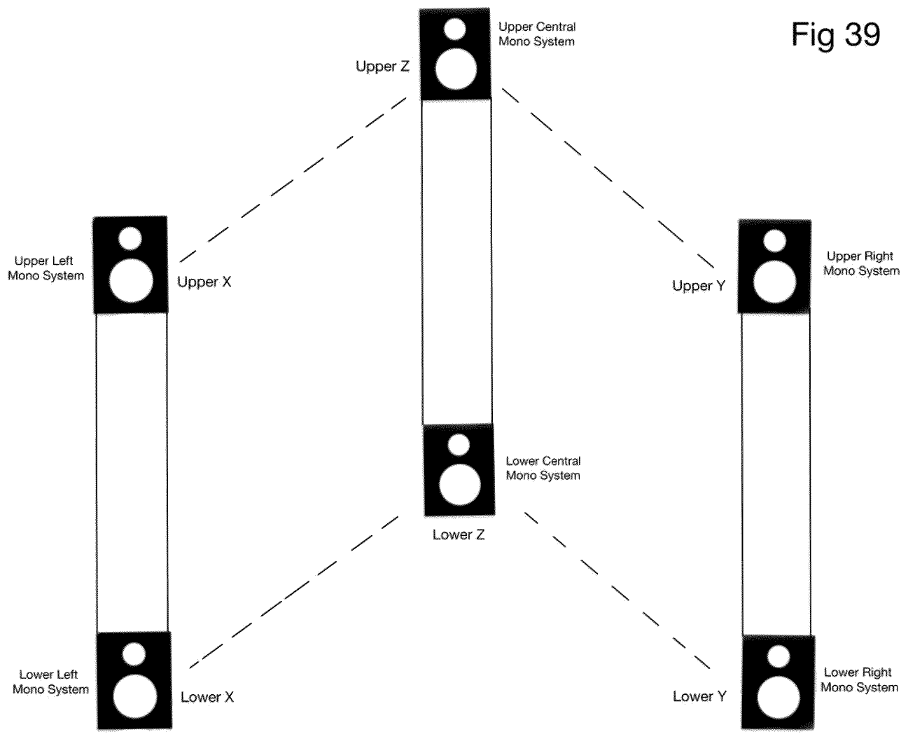

As mentioned above, in a preferred mode, the vector playback system is composed of six mono audio playback systems, which are strategically placed in the acoustic space and in relation to the listener;

Where, in a preferred mode, three mono audio playback systems are placed at the top in relation to the listener, which we name as upper central mono system, upper left mono system and upper right mono system, in addition, in a preferred modality three other mono audio playback systems are placed at the bottom in relation to the listener, which we name as the lower central mono system, the lower left mono system, and the lower mono monkey system, as shown in FIG. 39.

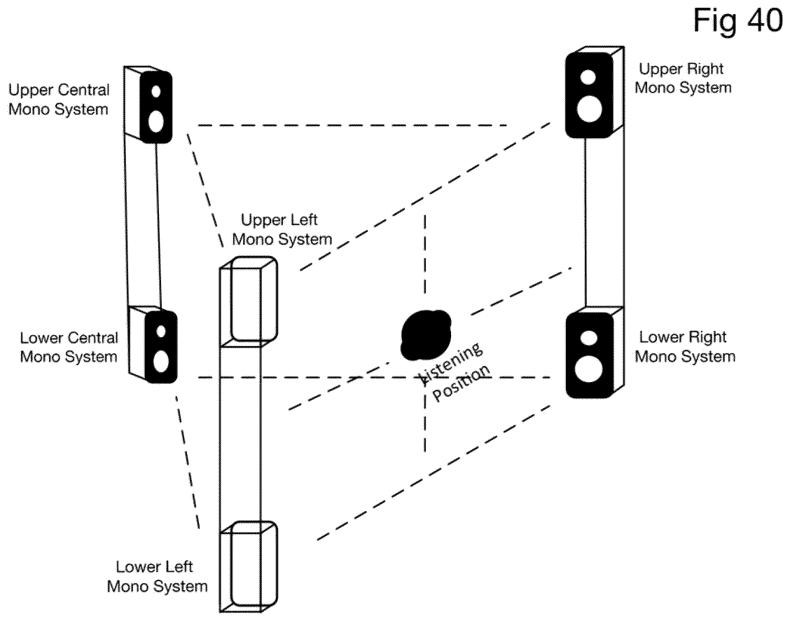

Therefore, the mono audio playback system identified as lower left mono system is placed on the left side in relation to the listener at a floor level, the mono audio playback system identified as lower right mono system is placed on the right side in relation to the listener on a floor level. It is important to note that in a preferred mode, the distance between the position of the listener and the lower left mono system would be the same between the position of the listener and the lower right mono system, and this will depend on the panoramic amplitude that you want to perceive and the space available to install said vector playback system. In a preferred mode, the mono audio playback system identified as the lower central mono system is arranged in front of the listener and at floor level, it is important to note that the distance between the listener and the lower central mono system would be the same between the listener and the left and right mono systems. In addition, the mono audio playback system, identified as the upper left mono system, is positioned vertically aligned with the lower left mono system and at a height delimited by twice the distance between the listener's head and the floor. The mono audio playback system identified as the upper left mono system is placed vertically aligned in relation to the lower left mono system and at a height delimited by twice the distance between the listener's head and the ground. The audio playback system identified as the upper right mono system is placed vertically aligned in relation to the lower right mono system and at a height delimited by twice the distance between the listener's head and the ground. The mono audio playback system identified as the upper central mono system is positioned vertically aligned in relation to the lower central mono system and at a height limited by twice the distance between the listener's head and the ground, as shown in FIG. 40.

It is important to mention that these 6 mono audio playback systems lower left, lower right, lower center, upper left, upper right and upper center have the same distance in relation to the listener's head and these 6 mono audio playback systems must be oriented towards the listener's head, as shown in FIG. 40.

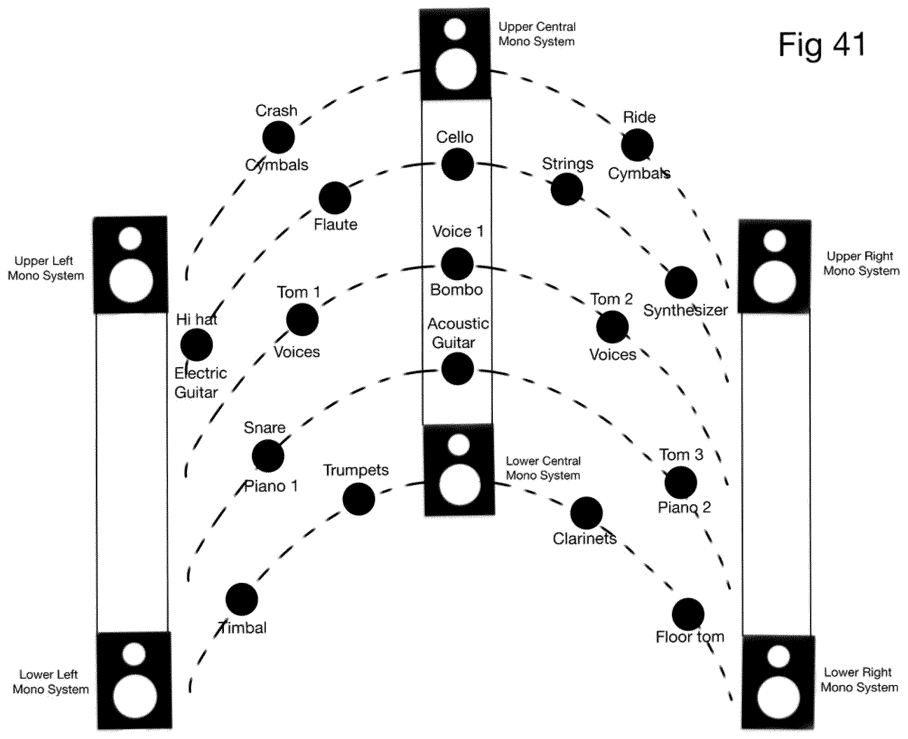

FIG. 41 shows, by way of example and without limitation to it, that the present modality, which uses 6 mono audio playback systems, creates a curve in the panoramic field that can be seen in front of the listener; where this panoramic field surrounds the listener in a similar way to a panoramic semicircle, which generates an acoustic effect of depth and amplitude in both the horizontal plane and the vertical plane which we call the vector three-dimensional panning acoustic effect, thus offering “an immersive experience” that enhances and expands the possibilities and intentions of the music producer to show a better result in the acoustic space.

### Assigning Signals to Mono Systems

As mentioned above, this playback mode simultaneously plays 2 trisonic audios, where, the first trisonic audio is composed of 3 audio signals, which we identify as upper X, upper Y, and upper Z, where, similarly, the second trisonic audio is composed of 3 audio signals, which we identify as lower X, lower Y, and lower Z.

It is important to understand that these 6 mono audio playback systems used in this playback mode reproduce together said first and second trisonic audio, that is, these 6 mono systems reproduce together the 6 audio signals upper X, upper Y, upper Z, lower X, lower Y and lower Z;

Where, as shown in FIG. 39, the upper left mono audio playback system is configured to receive and play the upper X audio signal, the upper right mono audio playback system is configured to receive and play the upper Y audio signal, the upper central mono audio playback system is configured to receive and play the upper Z audio signal, the lower left mono audio playback system is configured to receive and play the lower X audio signal, the lower right mono audio playback system is configured to receive and play the lower Y audio signal, and the lower central mono audio playback system is configured to receive and play the lower Z audio signal.

The five trisonic audio playback systems referred to above have the sole purpose of illustrating by way of example the form, interaction, arrangement, and in general, the manner in which the trisonic audio generation system of the present invention can reproduce the resulting audio signal(s) through different audio playback systems, whereas, a person with knowledge within the field to which the present invention pertains shall understand that such trisonic audio playback systems are not necessarily limited to those set forth in such examples in the modalities of this description. In addition, it must be understood that the trisonic audio generation system of the present invention can be embedded in any trisonic audio playback system to function directly, where the embedded trisonic audio generation system is either of the magnetic collision system and/or the electrical collision system that have been previously described within this application.

### Experimental Results

Each example included in this chapter is presented with the aim of illustrating the practical applicability of the invention, demonstrating its usefulness and novelty. The experimental results obtained are presented in detail, supporting the inventive step and providing tangible evidence of the benefits and technical advantages that derive from the application of the invention in various specific situations and scenarios.

It should be noted that these experimental examples are not intended to limit the extent or scope of the claims, but rather to serve as practical illustrations that reinforce the technical and scientific rationale for the invention presented in this document. The information provided in this chapter, supported by experimental results, seeks to consolidate the position of the invention in terms of innovation and practical application.

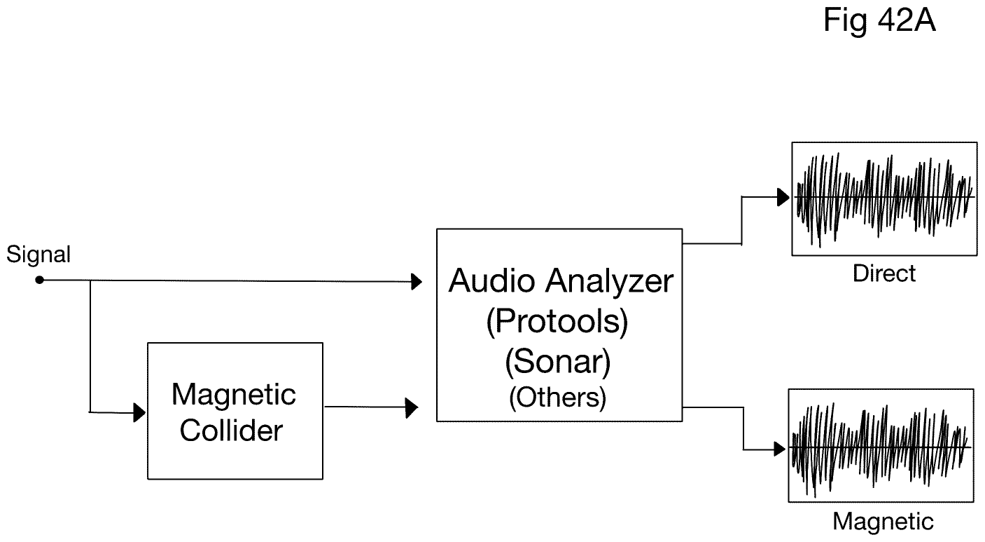

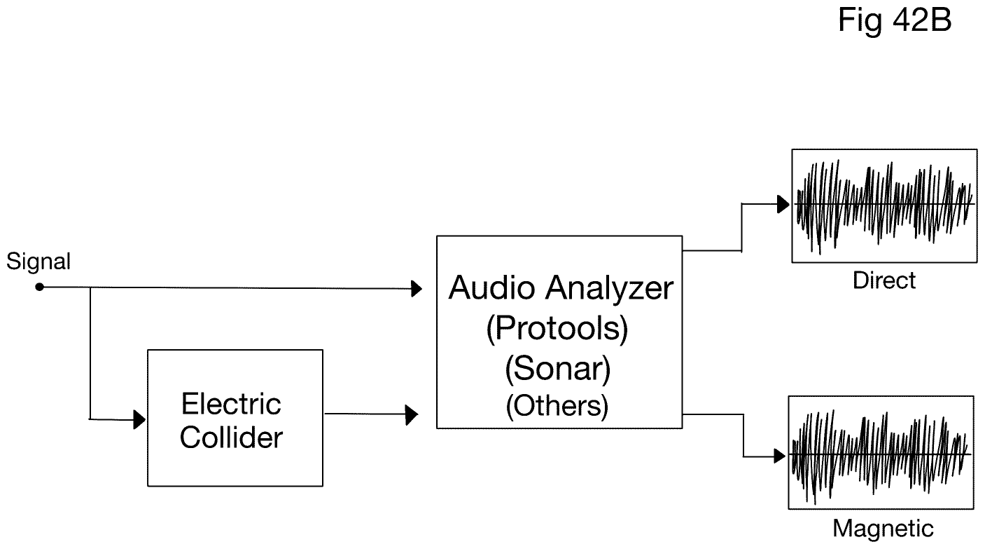

To verify that there is no delay in the processing of an audio signal using the magnetic and/or electrical collision system according to the present invention, an audio analysis equipment was prepared, comprising: i) a direct audio input to a first channel of a professional recording system, wherein said professional recording system comprises audio signal analysis software (Protools/Sonar or similar); and ii) a bypass of said audio input connected at one end to the input of the magnetic collision system and its output connected to the input of a second channel of the professional recording system. See FIG. 42A.

Once the audio analysis equipment was assembled, an audio signal was injected into the audio analysis equipment and the initial detection point of the audio input was detected on both channels.

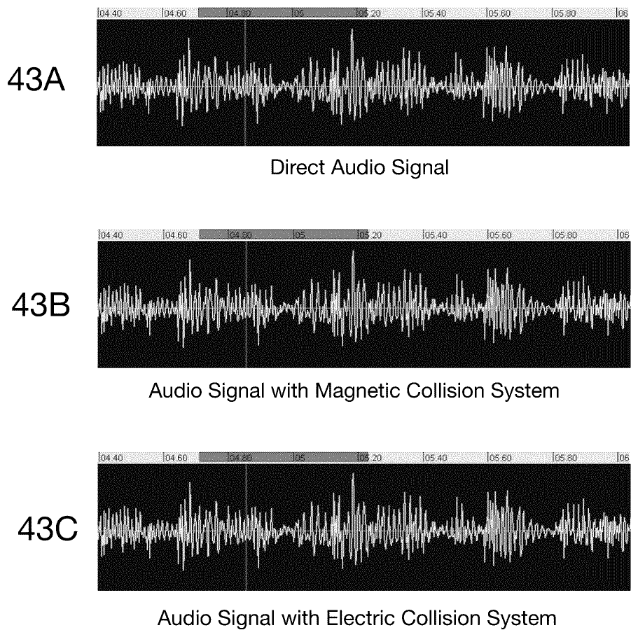

FIG. 43A shows a graphical representation showing the initial point of detection of audio input injected directly into the first channel of the professional recording system (without the use of the collision system from this invention).

FIG. 43B shows a graphical representation showing the initial point of detection of the audio input injected into the second channel of the professional recording system, which corresponds to the bypass used by the magnetic collision system according to one of the modalities of the present invention.

As can be seen, the initial detection point of the audio input in FIGS. 43A and 43B did not show any displacement, which shows that the processing performed by the magnetic collision system does not generate any delay compared to the initial detection point of the signal that was directly injected (without the use of the collision system of the present invention).

On the other hand, an audio analysis equipment was prepared comprising: i) a direct audio input to a first channel of a professional recording system, where said professional recording system includes an audio signal analysis software (Protools/Sonar or similar); and (ii) a bypass of such audio input connected at one end to the input of the electrical collision system and the output of the electrical collision system, connected to the input of a second channel of the professional recording system. See FIG. 42B.

Once the audio analysis equipment was assembled, an audio signal was injected into the audio analysis equipment and the initial detection point of the audio input was detected on both channels.

FIG. 43C shows a graphical representation showing the initial point of detection of the audio input injected into the second channel of the professional recording system, which corresponds to the bypass used by the electrical collision system according to one of the modalities of the present invention.

As can be seen, the initial detection point of the audio input in FIGS. 43A and 43C did not show any displacement, which shows that the processing performed by the electrical collision system does not generate any delay compared to the initial detection point of the signal that was directly injected (without the use of the collision system of the present invention).

As could be verified, the generation of the trisonic audio signal, using the system according to the present invention, advantageously proceeds without any latency, meaning that the input time of the signal to be processed/converted and the output time of said processed/converted signal into a trisonic audio signal, where it can be observed that said processing and/or conversion is carried out immediately. Based on the above, it will be clear to a person with ordinary skill in the field to which the invention belongs that the use of the system, as described within the present application, results in a signal characterized by the input and output times being, advantageously, equal.

Many modifications and other modalities of the invention will come to the mind of an expert in the art to which the invention belongs, who has the benefit of the teachings presented in the above descriptions and associated drawings. Therefore, it should be understood that the invention should not be limited to the specific and exemplary modalities described, but that modifications and other modalities are intended to fall within the scope of the attached claims. Although specific terms are used here, they are used only in a generic and descriptive sense and not for limitative purposes. Likewise, it must be understood that the materials with which the different components comprising the invention described in this document can be manufactured, the geometries, dimensions, arrangements and other elements may vary without departing from the scope and spirit of the invention and therefore, the modalities referred to should not be considered limiting.

In this regard, it should be understood that the system as described in this application is not necessarily limited to the use set out herein and that, therefore, such a system can be extrapolated to any other audio generation application; Furthermore, the system in accordance with the present invention is not limited to the use of channels or signals of stereophonic, multi-channel or trisonic audio such as those used in accordance with a preferred mode of the invention, on the contrary, the system may use and/or interact with different signals without limitation to those set forth in this description.

1. A collision system for the generation of trisonic audio signals with zero latency, comprising:
at least one coil subsystem, where said coil subsystem comprises:
i) At least one first coil configured to receive a first audio signal containing its own pan point value information;
ii) At least one second coil configured to receive a second audio signal containing its own pan point value information; and
iii) At least a third coil configured to receive a signal resulting from the collision between the audio signals of the at least one first coil, and the at least one second coil, and where such resulting signal contains its own information resulting from the panning point values.

2. The collision system according to claim 1, wherein such system is a magnetic collision system comprising at least a first coil subsystem, wherein the at least one first coil is configured to generate a first magnetic field by the circulation of a first electric current corresponding to that first audio signal; where the at least one second coil is configured to generate a second magnetic field by circulating a second electric current corresponding to that second audio signal; and where said at least one third coil is configured to capture a third magnetic field resulting from the magnetic collision between the first and second magnetic fields generated by the at least first and at least second coils and convert said third magnetic field into an electric current.

3. The collision system according to claim 2, where the first audio signal and the second audio signal contain information on panning point values that are different from each other, and where the first and second magnetic fields contain different information from each other.

4. The collision system according to claim 2, where the electric currents circulating through at least one first coil and at least one second coil are pre-treated electric currents independent of each other; said two pre-treated electric currents corresponding to two audio signals; and where such two audio signals contain information different from each other.

5. The collision system according to claim 2, wherein the third receiving coil is configured to pick up the third magnetic field resulting from the magnetic collision between the first magnetic field and the second magnetic field; and where the resulting third magnetic field contains information different from the information contained in the first magnetic field and the second magnetic field.

6. The collision system according to claim 2, wherein the third receiving coil is configured to convert said third magnetic field into a resultant electric current; and where the resulting electric current corresponds to one of the three signals of a trisonic audio.

7. The collision system according to claim 2, where the at least one first generating coil, the at least one second generating coil, and the at least one third receiving coil are arranged on a core, the third coil being located between the first and second coils; and where such a core is a bar with a cross-section that has a geometry selected from the group comprising areas of circular, square, rectangular, oval, polygonal, regular, irregular, a straight bar, a U-shaped, E-shaped, Y-shaped, T-shaped, open or closed structure, or any combination thereof.

8. The collision system according to claim 2, where said at least one coil subsystem is a first coil subsystem wherein:
a. the first coil is a generating coil that is configured to receive and circulate a pre-treated electric current corresponding to the LEFT or L channel or signal comprising the pan point values [A100/D75/C50/E25/B0] of a stereophonic audio, and convert this electric current into a first magnetic field with its corresponding information;
b. the second coil is a generating coil that is configured to receive and circulate a pre-treated electric current corresponding to the channel or signal RIGHT or R at 180° comprising the panning point values [−A0/−D25/−C50/−E75/−B100] of a stereophonic audio, and convert this electric current into a second magnetic field with its corresponding information; and
c. the third coil is a receiving coil that is configured to capture the third magnetic field resulting from the magnetic collision between the first magnetic field and the second magnetic field, and convert the third magnetic field into a resulting electric current X2 comprising the pan point values [A100/D50/−E50/−B100], where the resulting electric current X2 corresponds to one of the signals of a trisonic audio.

9. The collision system according to claim 2, where said at least one coil subsystem is a second coil subsystem wherein:
a. the first coil is a generating coil that is configured to receive and circulate a pre-treated electric current corresponding to the RIGHT or R channel or signal comprising the pan point values [A0/D25/C50/E75/B100] of a stereophonic audio, and convert this electric current into a first magnetic field with its corresponding information;
b. the second coil is a generating coil that is configured to receive and circulate a pre-treated electric current corresponding to the LEFT or L channel or signal at 180° comprising the pan point values [−A100/−D75/−C50/−E25/−B0] of a stereophonic audio, and convert this electric current into a second magnetic field with its corresponding information; and
c. the third coil is a receiving coil that is configured to capture the third magnetic field resulting from the magnetic collision between the first magnetic field and the second magnetic field, and convert the third magnetic field into a resultant electric current Y2 comprising the panning point values [−A100/−D50/E50/B100], where the resulting electric current Y2 corresponds to one of the signals of a trisonic audio.

10. The collision system according to claim 2, where said at least one coil subsystem is a third coil subsystem wherein:
a. the first coil is a generating coil that is configured to receive and circulate a pre-treated electric current corresponding to the LEFT or L channel or signal comprising the pan point values [A100/D75/C50/E25/B0] of a stereophonic audio, and convert this electric current into a first magnetic field with its corresponding information;
b. the second coil is a generating coil that is configured to receive and circulate a pre-treated electric current corresponding to the RIGHT or R channel or signal comprising the pan point values [A0/D25/C50/E75/B100] of a stereophonic audio, and convert this electric current into a second magnetic field with its corresponding information; and
c. the third coil is a receiving coil that is configured to capture the third magnetic field resulting from the magnetic collision between the first magnetic field and the second magnetic field, and convert the third magnetic field into a resultant electric current Z2 comprising the panning point values [A100/D100/C100/E100/B100], where the resulting electric current Z2 corresponds to one of the signals of a trisonic audio.

11. The collision system according to claim 2, where at least one coil subsystem is a fourth coil subsystem wherein:
a. the first coil is a generating coil that is configured to receive and circulate a pre-treated electric current corresponding to the LEFT or L channel or signal comprising the pan point values [A100/D75/C50/E25/B0] of a stereophonic audio, and convert this electric current into a first magnetic field with its corresponding information;
b. the second coil is a generator that is configured to receive and circulate a pre-treated electric current corresponding to the channel or signal X2 comprising the pan point values [A100/D50/−E50/−B100] of a trisonic audio, and to convert this electric current into a second magnetic field with its corresponding information; and
c. the third coil is a receiving coil that is configured to capture the third magnetic field resulting from the magnetic collision between the first magnetic field and the second magnetic field, and convert the third magnetic field into a resulting electric current X3 comprising the pan point values [A200/D125/C50/−E25/−B100], where the resulting electric current X3 corresponds to one of the signals of a trisonic audio.

12. The collision system according to claim 2, where said at least one coil subsystem is a fifth coil subsystem wherein:
a. the first coil is a generating coil that is configured to receive and circulate a pre-treated electric current corresponding to the RIGHT or R channel or signal comprising the pan point values [A0/D25/C50/E75/B100] of a stereophonic audio, and convert this electric current into a first magnetic field with its corresponding information;
b. the second coil is a generating coil that is configured to receive and circulate a pre-treated electric current corresponding to the channel or signal Y2 comprising the pan point values [−A100/−D50/E50/B100] of a trisonic audio, and convert this electric current into a second magnetic field with its corresponding information; and
c. the third coil is a receiving coil that is configured to capture the third magnetic field resulting from the magnetic collision between the first magnetic field and the second magnetic field, and convert the third magnetic field into a resulting electric current Y3 comprising the panning point values [−A100/−D25/C50/E125/B200], where the resulting electric current Y3 corresponds to one of the signals of a trisonic audio.

13. The collision system according to claim 2, where said at least one coil subsystem is a sixth coil subsystem where:
a. the first coil is a generating coil that is configured to receive and circulate a pre-treated electric current corresponding to the channel or signal X3 comprising the pan point values [A200/D125/C50/−E25/−B100] of a trisonic audio, and convert this electric current into a first magnetic field with its corresponding information;
b. the second coil is a generating coil that is configured to receive and circulate a pre-treated electric current corresponding to channel or signal Y3 comprising the pan point values [−A100/−D25/C50/E125/B200] of a trisonic audio, and convert this electric current into a second magnetic field with its corresponding information; and
c. the third coil is a receiving coil that is configured to pick up the third magnetic field resulting from the magnetic collision between the first magnetic field and the second magnetic field, and convert the third magnetic field into a resulting electric current Z3 comprising the pan point values [A100/D100/C100/E100/B100], where the resulting electric current Z3 corresponds to one of the signals of a trisonic audio.

14. The collision system according to claim 1, wherein such system is an electrical collision system comprising at least one first coil subsystem, wherein such at least one first coil is configured to generate a first electric current by capturing a first magnetic field corresponding to such first audio signal; where the at least one second coil is configured to generate a second electric current by capturing a second magnetic field corresponding to that second audio signal; and where said the at least one third coil is configured to circulate a third electric current resulting from the electrical collision between the first and second electric currents generated by the at least first and the at least second coils and convert said third electric current into a magnetic field.

15. The collision system according to claim 14, where the first audio signal and the second audio signal contain information on the values of panoramic points that are different from each other, and where the first and second electric currents contain information that is different from each other.

16. The collision system according to claim 14, where the magnetic fields captured by the at least one first coil and the at least one second coil correspond to pre-treated electric currents; these pre-treated electric currents corresponding to two audio signals; and where these two audio signals contain different information from each other.

17. The collision system according to claim 14, wherein the third crashing coil is configured to circulate the third electric current resulting from the electrical collision between the first electric current and the second electric current; and where the resulting third electric current contains information different from the information contained in the first electric current and the second electric current.

18. The collision system according to claim 14, wherein the third crashing coil is configured to convert said third electric current into a resulting magnetic field; and where the resulting magnetic field corresponds to one of the three signals of a trisonic audio.

19. The collision system according to claim 14, where the at least one first generating coil, the at least one second generating coil, and the at least one third crashing coil are arranged on a core, the third coil being located between the first and second coils; and where such a core is a bar with a cross-section that has a geometry selected from the group comprising areas of circular, square, rectangular, oval, polygonal, regular, irregular, a straight bar, a U-shaped, E-shaped, Y-shaped, T-shaped, open or closed structure, or any combination thereof.

20. The collision system according to claim 14, where said at least one coil subsystem is a first coil subsystem wherein:
a. the first coil is a generating coil that is configured to receive and capture a magnetic field obtained from a pre-treated electric current corresponding to the LEFT or L channel or signal comprising the pan point values [A100/D75/C50/E25/B0] of a stereophonic audio, and convert this magnetic field into a first electric current with its corresponding information;
b. the second coil is a generating coil that is configured to receive and capture a magnetic field obtained from a pre-treated electric current corresponding to the RIGHT or R channel or signal at 180° comprising the values of pan points [−A0/−D25/−C50/−E75/−B100] of a stereophonic audio, and convert this magnetic field into a second electric current with its corresponding information; and
c. the third coil is a crashing coil which is configured to circulate the third electric current resulting from the electrical collision between the first electric current and the second electric current, and convert the third electric current into a resulting magnetic field X2 comprising the values of pan points [A100/D50/−E50/−B100], wherein the resulting magnetic field X2 corresponds to one of the signals of a trisonic audio.

21. The collision system according to claim 14, where said at least one coil subsystem is a second coil subsystem where:
a. the first coil is a generating coil that is configured to receive and capture a magnetic field obtained from a pre-treated electric current corresponding to the RIGHT or R channel or signal comprising the pan point values [A0/D25/C50/E75/B100] of a stereophonic audio, and convert this magnetic field into a first electric current with its corresponding information;
b. the second coil is a generating coil that is configured to receive and capture a magnetic field obtained from a pre-treated electric current corresponding to the channel or signal LEFT or L at 180° comprising the values of panning points [−A100/−D75/−C50/−E25/−B0] of a stereophonic audio, and convert this magnetic field into a second electric current with its corresponding information; and
c. the third coil is a crashing coil which is configured to circulate the third electric current resulting from the electrical collision between the first electric current and the second electric current, and convert the third electric current into a resulting magnetic field Y2 comprising the values of pan points [−A100/−D50/E50/B100], where the resulting magnetic field Y2 corresponds to one of the signals of a trisonic audio.

22. The collision system according to claim 14, where said at least one coil subsystem is a third coil subsystem where:
a. the first coil is a generating coil that is configured to receive and capture a magnetic field obtained from a pre-treated electric current corresponding to the LEFT or L channel or signal comprising the pan point values [A100/D75/C50/E25/B0] of a stereophonic audio, and convert this magnetic field into a first electric current with its corresponding information;
b. the second coil is a generating coil that is configured to receive and capture a magnetic field obtained from a pre-treated electric current corresponding to the RIGHT or R channel or signal comprising the pan point values [A0/D25/C50/E75/B100] of a stereophonic audio, and convert this magnetic field into a second electric current with its corresponding information; and
c. the third coil is a crashing coil which is configured to circulate the third electric current resulting from the electrical collision between the first electric current and the second electric current, and convert the third electric current into a resulting magnetic field Z2 comprising the values of pan points [A100/D100/C100/E100/B100], where the resulting magnetic field Z2 corresponds to one of the signals of a trisonic audio.

23. The collision system according to claim 14, where said at least one coil subsystem is a fourth coil subsystem wherein:
a. the first coil is a generating coil that is configured to receive and capture a magnetic field obtained from a pre-treated electric current corresponding to the LEFT or L channel or signal comprising the pan point values [A100/D75/C50/E25/B0] of a stereophonic audio, and convert that magnetic field into a first electric current with its corresponding information;
b. the second coil is a generating coil that is configured to receive and capture a magnetic field obtained from a pre-treated electric current corresponding to channel or signal X2 comprising the pan point values [A100/D50/−E50/−B100] of a trisonic audio, and convert this magnetic field into a second electric current with its corresponding information; and
c. the third coil is a crashing coil which is configured to circulate the third electric current resulting from the electrical collision between the first electric current and the second electric current, and convert the third electric current into a resulting magnetic field X3 comprising the values of panning points [A200/D125/C50/−E25/−B100], where the resulting magnetic field X3 corresponds to one of the signals of a trisonic audio.

24. The collision system according to claim 14, where said at least one coil subsystem is a fifth coil subsystem where:
a. the first coil is a generating coil that is configured to receive and capture a magnetic field obtained from a pre-treated electric current corresponding to the RIGHT or R channel or signal comprising the pan point values [A0/D25/C50/E75/B100] of a stereophonic audio, and to convert that magnetic field into a first electric current with its corresponding information;
b. the second coil is a generating coil that is configured to receive and capture a magnetic field obtained from a pre-treated electric current corresponding to the channel or signal Y2 comprising the values of panning points [−A100/−D50/E50/B100] of a trisonic audio, and convert this magnetic field into a second electric current with its corresponding information; and
c. the third coil is a crashing coil which is configured to circulate the third electric current resulting from the electrical collision between the first electric current and the second electric current, and convert the third electric current into a resulting magnetic field Y3 comprising the values of panning points [−A100/−D25/C50/E125/B200], where the resulting magnetic field Y3 corresponds to one of the signals of a trisonic audio.

25. The collision system according to claim 14, where said at least one coil subsystem is a sixth coil subsystem wherein:
a. the first coil is a generating coil that is configured to receive a magnetic field obtained from a pre-treated electric current corresponding to the channel or signal X3 comprising the pan point values [A200/D125/C50/−E25/−B100] of a trisonic audio, and convert this magnetic field into a first electric current with its corresponding information;
b. the second coil is a generating coil that is configured to receive and capture a magnetic field obtained from a pre-treated electric current corresponding to channel or signal Y3 comprising the pan point values [−A100/−D25/C50/E125/B200] of a trisonic audio, and convert this magnetic field into a second electric current with its corresponding information; and
c. the third coil is a crashing coil which is configured to circulate the third electric current resulting from the electrical collision between the first electric current and the second electric current and convert the third electric current into a resulting magnetic field Z3 comprising the values of pan points [A100/D100/C100/E100/B100], where the resulting magnetic field Z3 corresponds to one of the signals of a trisonic audio.

26. The collision system according to claim 1, wherein such system is configured to operate functionally with at least one processing subsystem.

27. The collision system in accordance with claim 26, wherein the processing subsystem is configured to:
i) perform a specific pre-treatment of the input audio signals to establish the pan point values of those input audio signals that are introduced or directed to the first and second coils;
ii) receive a resulting electric current from the third coil;
iii) perform a final treatment of the resulting electric current from the third coil; and
iv) direct said finally treated electrical current to a playback system for the emission of trisonic audio.

28. The collision system according to claim 27, wherein such pre-treatment is performed prior to its introduction into the coil subsystem; and such pretreatment is performed differently for each coil subsystem.

29. The collision system according to claim 27, where such final treatment of the resulting electric current from the third coil is performed prior to directing the resulting electric current to a trisonic audio playback system.

30. The collision system according to claim 26, wherein such collision system operating functionally with the processing subsystem is further configured to operate functionally with at least one trisonic audio playback system.

31. An audio playback system comprising a system in accordance with claim 30; where such trisonic audio playback system is selected from a group comprising at least one triangular playback system, at least one dynamic playback system, at least one quadraphonic playback system, at least one auricular playback system; at least one vector playback system, or any combination thereof.

32. The audio playback system according to claim 31, wherein said playback system is a triangular playback system, comprising three mono audio playback systems configured to play or transmit a full range of high, mid and low frequencies ranging from 10 Hz to 20 KHz;
wherein said 3 mono audio playback systems are arranged, one on the front in relation to the listener, one on the left side in relation to the listener and one on the right side in relation to the listener;
where, the distance between the listener and each of said three mono audio playback systems is the same;
wherein, said three mono audio playback systems are in aligned orientation towards the listener's head;
wherein the left mono audio playback system is configured to receive and play audio signal X;
the right mono audio playback system is configured to receive and play the audio signal Y; and
the front right mono audio playback system is configured to receive and play the audio signal Z.

33. The playback system in accordance with claim 32, where such audio signal X is an audio signal X2, where said audio signal Y is an audio signal Y2, and where such audio signal Z is an audio signal Z2;
where an audio signal Z2 emitted by the front mono audio playback system interacts at the same time with an audio signal X2 emitted by the left mono audio playback system and with an audio signal Y2 emitted by the right mono audio playback system, where the values of Z2 [A100/D100/C100/E100/B100] interact at the same time with the values of X2 [A100/D50/−E50/−B100)] and with the values of Y2 [−A100/−D50/E50/B100], resulting in the values [A100/D100/C100/E100/B100)], where these values represent a first acoustic result perceived by the listener.

34. The playback system in accordance with claim 32, where such audio signal X is an X3 audio signal, where such audio signal Y is an audio signal Y3, and where such audio signal Z is a Z3 audio signal;
where an audio Z3 signal emitted by the front mono audio playback system interacts at the same time with an audio signal X3 emitted by the left mono audio playback system and with an audio signal Y3 emitted by the right mono audio playback system, where the values of Z3 [A100/D100/C100/E100/B100] interact at the same time with the values of X3 [A200/D125/C50/−E25/−B100] and with the values of Y3 [−A100/−D25/C50/E125/B200], resulting in the values [A200/D200/C200/E200/B200], where these values represent a second acoustic result perceived by the listener.

35. The audio playback system according to claim 31, wherein said playback system is a dynamic playback system, comprising four mono audio playback systems configured to play or transmit a full range of high, mid and low frequencies ranging from 10 Hz to 20 KHz;
wherein a first pair of said four mono audio playback systems (left lateral mono system and left central lateral mono system), are arranged on the left side in relation to the listener;
wherein, a second pair of said four mono audio playback systems (right lateral mono system and right central mono system) are arranged on the right side in relation to the listener;
wherein, the distance between the listener and the first pair of said four mono audio playback systems is the same distance between the listener and the second pair of said four mono audio playback systems;
wherein, the first pair of said four mono audio playback systems are arranged together and in aligned orientation towards the listener's head, and the second pair of said four mono audio playback systems are arranged together and in aligned orientation towards the listener's head;
wherein, the left lateral mono audio playback system is configured to receive and play audio signal X;
the left central mono audio playback system is configured to receive and play the audio signal Z;
the right lateral mono audio playback system is configured to receive and play the audio signal Y; and
the right central mono audio playback system is configured to receive and play the audio signal Z.

36. The playback system in accordance with claim 35, where such audio signal X is an X2 audio signal, where such audio signal Y is an audio signal Y2, and where such audio signal Z is an audio signal Z2;
where an audio signal X2 emitted by the left lateral mono audio playback system interacts with an audio signal Z2 emitted by the left frontal central mono audio playback system, where the values of X2 [A100/D50/−E50/−B100] interact with the values of Z2 [A100/D100/C100/E100/B100] resulting in the values [A200/D150/C100/E50/B0], generating a virtual audio signal left;
an audio signal Y2 emitted by the right lateral mono audio playback system interacts with an audio signal Z2 emitted by the right central mono audio playback system, where the values of Y2 [−A100/−D50/E50/B100] interact with the Z2 values [A100/D100/C100/E100/B100] resulting in the values [A0/D50/C100/E150/B200] generating a right virtual audio signal;
and where the left virtual audio signal interacts with the right virtual audio signal resulting in the values [A200/D200/C200/E200/B200], where these values represent a first acoustic result perceived by the listener.

37. The playback system in accordance with claim 35, where such audio signal X is an X3 audio signal, where such audio signal Y is an audio signal Y3, and where such audio signal Z is a Z3 audio signal;
where an audio signal X3 emitted by the left lateral mono audio playback system interacts with an audio signal Z3 emitted by the left central mono audio playback system, where the values of X3 [A200/D125/C50/−E25/−B100] interact with the values of Z3 [A100/D100/C100/E100/B100] resulting in the values [A300/D225/C150/E75/B0], generating a virtual audio signal left;
an audio signal Y3 emitted by the right lateral mono audio playback system interacts with an audio signal Z3 emitted by the right central mono audio playback system, where the values of Y3 [−A100/−D25/C50/E125/B200] interact with the values of Z3 [A100/D100/C100/E100/B100] resulting in the values [A0/D75/C150/E225/B300] generating a right virtual audio signal;
and where the left virtual audio signal interacts with the right virtual audio signal resulting in the values [A300/D300/C300/E300/B300], where these values represent a second acoustic result perceived by the listener.

38. The playback system according to claim 31, wherein said playback system is a quadraphonic playback system, comprising four mono audio playback systems configured to play or transmit a full range of high, mid and low frequencies ranging from 10 Hz to 20 KHz;
wherein a first pair of said four mono audio playback systems (left lateral mono system and left frontal central mono system), are arranged on the left side in relation to the listener;
wherein, a second pair of said four mono audio playback systems (right lateral mono system and right frontal central mono system) are arranged on the right side in relation to the listener;
where, the distance between the listener and the left lateral mono system is the same distance between the listener and the right lateral mono system,
where, said left lateral mono systems are arranged in a straight line in such a way that the listener is right in the middle of both;
wherein, said left lateral systems are arranged in an aligned orientation towards the listener's head;
where, the distance between the left lateral mono system in relation to the left frontal central mono system is the same distance between the right lateral mono system and the right frontal central mono system;
wherein, said left frontal central mono system and right frontal central mono system are arranged in the front part of the acoustic space and in a straight line in relation to their corresponding lateral mono systems;
wherein, said left frontal central mono system and right frontal central mono system are arranged in an aligned orientation towards the listener's head;
wherein, the left lateral mono audio playback system is configured to receive and play audio signal X;
the left frontal central mono audio playback system is configured to receive and play the audio signal Z;
the right lateral mono audio playback system is configured to receive and play the audio signal Y; and
the right frontal central mono audio playback system is configured to receive and play the audio signal Z.

39. The playback system in accordance with claim 38, where such audio signal X is an audio signal X2, where such audio signal Y is an audio signal Y2, and where such audio signal Z is an audio signal Z2;
wherein an audio signal Z2 is divided into equal parts, wherein a divided audio signal Z2 and output by the left frontal central mono audio playback system interacts with a split audio signal Z2 and output by the right frontal central mono audio playback system, where the values of Z2 [A50/D50/C50/E50/B50] interact with the values of Z2 [A50/D50/C50/E50/50] resulting in the values [A100/D100/C100/E100/B100], generating a virtual audio signal;
where such virtual audio signal interacts with both an X2 audio signal emitted by the left lateral mono system and a Y2 audio signal emitted by the right lateral mono system, where the values of that virtual audio signal [A100/D100/C100/E100/B100] interact with both the values of that X2 audio signal [A100/D50/−E50/−B100] and the values of that audio signal Y2 [−A100/−D50/E50/B100] resulting in the values [A100/D100/C100/E100/B100], where these values represent a first acoustic result perceived by the listener.

40. The playback system in accordance with claim 38, where said audio signal X is an X3 audio signal, where said audio signal Y is an audio signal Y3, and where said audio signal Z is a Z3 audio signal;
wherein a Z3 audio signal is divided into equal parts, wherein a Z3 audio signal divided and output by the left frontal central mono audio playback system interacts with a Z3 audio signal split and output by the right frontal central mono audio playback system, where the values of Z3 [A50/D50/C50/E50/B50] interact with the values of Z3 [A50/D50/C50/E50/50] resulting in the values [A100/D100/C100/E100/B100], generating a virtual audio signal;
where such virtual audio signal interacts with both an X3 audio signal emitted by the left lateral mono system and a Y3 audio signal emitted by the right lateral mono system, where the values of such virtual audio signal [A100/D100/C100/E100/B100] interact with both the values of that X3 audio signal [A200/D125/C50/−E25/−B100] as with the values of that audio signal Y3 [−A100/−D25/C50/E125/B200] resulting in the values [A200/D200/C200/E200/B200], where these values represent a second acoustic result perceived by the listener.

41. The audio playback system according to claim 31, wherein said playback system is an auricular playback system, comprising two auriculars (left auricular and right auricular), where each of said two auriculars comprises two auricular mono audio playback systems configured to reproduce or transmit a full range of high, mid and low frequencies ranging from 10 Hz to 20 KHz;
wherein the left earphone comprises two auricular mono audio playback systems (left lateral auricular mono system and left lateral central auricular mono system), which are arranged side by side;
wherein, the left lateral auricular mono system is arranged in the rear part of said left headphone in relation to the listener;
wherein, the left lateral central auricular mono system is arranged in the front part of said left headphone in relation to the listener;
wherein the right earphone comprises two auricular mono audio playback systems (right lateral auricular mono system and right lateral central auricular mono system), which are arranged side by side;
wherein, the right lateral auricular mono system is arranged in the rear part of said right earphone in relation to the listener;
wherein, the right lateral central auricular mono system is arranged in the front part of said right earphone in relation to the listener;
wherein, the left lateral auricular mono system is configured to receive and play audio signal X;
the left lateral central auricular mono system is configured to receive and play the audio signal Z;
the right lateral auricular mono system is configured to receive and play the audio signal Y; and
the right lateral central auricular mono system is configured to receive and play the audio signal Z.

42. The playback system in accordance with claim 41, where such audio signal X is an X2 audio signal, where such audio signal Y is an audio signal Y2, and where such audio signal Z is a Z2 audio signal;
where an X2 audio signal emitted by the left lateral auricular mono system interacts with a Z2 audio signal emitted by the left lateral central auricular mono system, where the values of X2 [A100/D50/−E50/−B100] interact with the values of Z2 [A100/D100/C100/E100/B100] resulting in the values [A200/D150/C100/E50/B0], generating a virtual audio signal left;
a Y2 audio signal emitted by the right lateral auricular mono system interacts with a Z2 audio signal emitted by the right lateral central auricular mono system, where the values of Y2 [−A100/−D50/E50/B100] interact with the values of Z2 [A100/D100/C100/E100/B100] resulting in the values [A0/D50/C100/E150/B200], generating a right virtual audio signal;
and where the left virtual audio signal interacts with the right virtual audio signal resulting in the values [A200/D200/C200/E200/B200], where these values represent a first result in the simulation of the acoustic space perceived by the listener.

43. The playback system in accordance with claim 41, where said audio signal X is an X3 audio signal, where said audio signal Y is an audio signal Y3, and where said audio signal Z is a Z3 audio signal;
where an X3 audio signal emitted by the left lateral auricular mono system interacts with a Z3 audio signal emitted by the left lateral central auricular mono system, where the values of X3 [A200/D125/C50/−E25/−B100] interact with the values of Z3 [A100/D100/C100/E100/B100] resulting in the values [A300/D225/C150/E75/B0], generating a virtual audio signal left;
wherein a Y3 audio signal emitted by the right lateral auricular mono system interacts with a Z3 audio signal emitted by the right lateral central auricular mono system, where the values of Y3 [−A100/−D25/C50/E125/B200] interact with the values of Z3 [A100/D100/C100/E100/B100] resulting in the values [A0/D75/C150/E225/B300] generating a virtual audio signal right;
and where the left virtual audio signal interacts with the right virtual audio signal resulting in the values [A300/D300/C300/E300/B300], where these values represent a second result in the simulation of the acoustic space perceived by the listener.

44. The audio playback system according to claim 31, wherein such playback system is a vector playback system, comprising six mono audio playback systems configured to reproduce or transmit a full range of high, mid and low frequencies ranging from 10 Hz to 20 KHz;
where three of the said six mono audio playback systems (upper central mono system, upper left mono system, and upper right mono system) are arranged at the top in relation to the listener;
whereas, the other three of the said six mono audio reproduction systems (lower central mono system, lower left mono system and lower right mono system) are arranged at the bottom in relation to the listener;
where, the lower left mono system is arranged on the left side in relation to the listener, the lower right mono system is arranged on the right side in relation to the listener, and the lower central mono system is arranged in front in relation to the listener;
where, the distance between the listener and each lower mono system is the same;
wherein, the upper left mono system is arranged on the left side in relation to the listener, vertically aligned in relation to the lower left mono system and at a height delimited in such a way that the listener's head is at a height bounded by half the distance between the lower left mono system and the upper left mono system;
where, the upper right mono system is arranged on the right side in relation to the listener, vertically aligned in relation to the lower right mono system and at a height delimited in such a way that the listener's head is at a height bounded by half the distance between the lower right mono system and the upper right mono system;
wherein, the upper central mono system is arranged in front of the listener, vertically aligned in relation to the lower central mono system and at a height delimited in such a way that the listener's head is at a height delimited by half the distance between the lower central mono system and the upper central mono system;
where, the distance between the listener and each higher mono system is the same;
where, the upper left mono audio playback system is configured to receive and play back the upper X audio signal;
the upper right mono audio playback system is configured to receive and play the upper Y audio signal;
the upper central mono audio playback system is configured to receive and play the upper Z audio signal;
the lower left mono audio playback system is configured to receive and play the lower X audio signal;
the lower right mono audio playback system is configured to receive and play back the lower Y audio signal; and
the lower center mono audio playback system is configured to receive and play back the lower Z audio signal.

45. A method for generating signals from a trisonic audio and reproducing them with zero latency, the method comprising:
a. feeding at least two audio signals with different information into a processing subsystem;
b. performing a pre-treatment of these at least two audio signals by generating at least two pre-treated audio signals;
c. directing such at least two pre-treated audio signals to a collision system in accordance with claim 1, to generate a resulting trisonic audio signal,
d. perform a final treatment of the resulting trisonic audio signal by means of the processing subsystem; and
e. directing the trisonic audio signal resulting from step d. to at least one trisonic audio playback system.

46. The method according to claim 45, where such a collision system is a magnetic collision system comprising at least one first coil subsystem, wherein such at least one first coil is configured to generate a first magnetic field by the circulation of a first electric current corresponding to that first audio signal; where said the at least second coil is configured to generate a second magnetic field by circulating a second electric current corresponding to that second audio signal; and where said the at least third coil is configured to capture a third magnetic field resulting from the magnetic collision between the first and second magnetic fields generated by the at least first and the at least second coils and convert said third magnetic field into an electric current.

47. The method according to claim 46, where said at least one coil subsystem is a first coil subsystem where:
a. the first coil is a generating coil that is configured to receive and circulate a pre-treated electric current corresponding to the LEFT or L channel or signal comprising the pan point values [A100/D75/C50/E25/B0] of a stereophonic audio, and convert this electric current into a first magnetic field with its corresponding information;
b. the second coil is a generating coil that is configured to receive and circulate a pre-treated electric current corresponding to the channel or signal RIGHT or R a 180° comprising the panning point values [−A0/−D25/−C50/−E75/−B100] of a stereophonic audio, and convert this electric current into a second magnetic field with its corresponding information; and
c. the third coil is a receiving coil that is configured to capture the third magnetic field resulting from the magnetic collision between the first magnetic field and the second magnetic field, and convert the third magnetic field into a resulting electric current X2 comprising the pan point values [A100/D50/−E50/−B100], where the resulting electric current X2 corresponds to one of the signals of a trisonic audio.

48. The method according to claim 46, where said at least one coil subsystem is a second coil subsystem where:
a. the first coil is a generating coil that is configured to receive and circulate a pre-treated electric current corresponding to the RIGHT or R channel or signal comprising the pan point values [A0/D25/C50/E75/B100] of a stereophonic audio, and convert this electric current into a first magnetic field with its corresponding information;
b. the second coil is a generating coil that is configured to receive and circulate a pre-treated electric current corresponding to the LEFT or L channel or signal at 180° comprising the pan point values [−A100/−D75/−C50/−E25/−B0] of a stereophonic audio, and convert this electric current into a second magnetic field with its corresponding information; and
c. the third coil is a receiving coil that is configured to capture the third magnetic field resulting from the magnetic collision between the first magnetic field and the second magnetic field, and convert the third magnetic field into a resultant electric current Y2 comprising the panning point values [−A100/−D50/E50/B100], where the resulting electric current Y2 corresponds to one of the signals of a trisonic audio.

49. The method according to claim 46, where at least one coil subsystem is a third coil subsystem where:
a. the first coil is a generating coil that is configured to receive and circulate a pre-treated electric current corresponding to the LEFT or L channel or signal comprising the pan point values [A100/D75/C50/E25/B0] of a stereophonic audio, and convert this electric current into a first magnetic field with its corresponding information;
b. the second coil is a generating coil that is configured to receive and circulate a pre-treated electric current corresponding to the RIGHT or R channel or signal comprising the pan point values [A0/D25/C50/E75/B100] of a stereophonic audio, and convert this electric current into a second magnetic field with its corresponding information; and
c. the third coil is a receiving coil that is configured to capture the third magnetic field resulting from the magnetic collision between the first magnetic field and the second magnetic field, and convert the third magnetic field into a resultant electric current Z2 comprising the panning point values [A100/D100/C100/E100/B100], where the resulting electric current Z2 corresponds to one of the signals of a trisonic audio.

50. The method according to claim 46, where said at least one coil subsystem is a fourth coil subsystem where:
a. the first coil is a generating coil that is configured to receive and circulate a pre-treated electric current corresponding to the LEFT or L channel or signal comprising the pan point values [A100/D75/C50/E25/B0] of a stereophonic audio, and convert this electric current into a first magnetic field with its corresponding information;
b. the second coil is a generating coil that is configured to receive and circulate a pre-treated electric current corresponding to the channel or signal X2 comprising the pan point values [A100/D50/−E50/−B100] of a trisonic audio, and convert this electric current into a second magnetic field with its corresponding information; and
c. the third coil is a receiving coil that is configured to capture the third magnetic field resulting from the magnetic collision between the first magnetic field and the second magnetic field, and convert the third magnetic field into a resulting electric current X3 comprising the pan point values [A200/D125/C50/−E25/−B100], where the resulting electric current X3 corresponds to one of the signals of a trisonic audio.

51. The method according to claim 46, where said at least one coil subsystem is a fifth coil subsystem where:
a. the first coil is a generating coil that is configured to receive and circulate a pre-treated electric current corresponding to the RIGHT or R channel or signal comprising the pan point values [A0/D25/C50/E75/B100] of a stereophonic audio, and convert this electric current into a first magnetic field with its corresponding information;
b. the second coil is a generating coil that is configured to receive and circulate a pre-treated electric current corresponding to the channel or signal Y2 comprising the pan point values [−A100/−D50/E50/B100] of a trisonic audio, and convert this electric current into a second magnetic field with its corresponding information; and
c. the third coil is a receiving coil (15c) that is configured to capture the third magnetic field resulting from the magnetic collision between the first magnetic field and the second magnetic field, and convert the third magnetic field into a resulting electric current Y3 comprising the panning point values [−A100/−D25/C50/E125/B200], where the resulting electric current Y3 corresponds to one of the signals of a trisonic audio.

52. The method according to claim 46, where said at least one coil subsystem is a sixth coil subsystem where:
a. the first coil is a generating coil that is configured to receive and circulate a pre-treated electric current corresponding to the channel or signal X3 comprising the pan point values [A200/D125/C50/−E25/−B100] of a trisonic audio, and convert this electric current into a first magnetic field with its corresponding information;
b. the second coil is a generating coil that is configured to receive and circulate a pre-treated electric current corresponding to channel or signal Y3 comprising the pan point values [−A100/−D25/C50/E125/B200] of a trisonic audio, and convert this electric current into a second magnetic field with its corresponding information; and
c. the third coil is a receiving coil that is configured to pick up the third magnetic field resulting from the magnetic collision between the first magnetic field and the second magnetic field, and convert the third magnetic field into a resulting electric current Z3 comprising the pan point values [A100/D100/C100/E100/B100], where the resulting electric current Z3 corresponds to one of the signals of a trisonic audio.

53. The method according to claim 45, wherein such a collision system is an electrical collision system comprising at least one first coil subsystem, wherein such at least one first coil is configured to generate a first electric current by capturing a first magnetic field corresponding to that first audio signal; where the at least one second coil is configured to generate a second electric current by capturing a second magnetic field corresponding to that second audio signal; and where said at least a third coil is configured to circulate a third electric current resulting from the electrical collision between the first and second electric currents generated by the at least first and the at least second coils and convert said third electric current into a magnetic field.

54. The method according to claim 53, where said at least one coil subsystem is a first coil subsystem where:
a. the first coil is a generating coil that is configured to receive and capture a magnetic field obtained from a pre-treated electric current corresponding to the LEFT or L channel or signal comprising the pan point values [A100/D75/C50/E25/B0] of a stereophonic audio, and convert this magnetic field into a first electric current with its corresponding information;
b. the second coil is a generating coil that is configured to receive and capture a magnetic field obtained from a pre-treated electric current corresponding to the RIGHT or R channel or signal at 180° comprising the values of pan points [−A0/−D25/−C50/−E75/−B100] of a stereophonic audio, and convert this magnetic field into a second electric current with its corresponding information; and
c. the third coil is a crashing coil which is configured to circulate the third electric current resulting from the electrical collision between the first electric current and the second electric current, and convert the third electric current into a resulting magnetic field X2 comprising the values of pan points [A100/D50/−E50/−B100], where the resulting magnetic field X2 corresponds to one of the signals of a trisonic audio.

55. The method according to claim 53, where said at least one coil subsystem is a second coil subsystem where:
a. the first coil is a generating coil that is configured to receive and capture a magnetic field obtained from a pre-treated electric current corresponding to the RIGHT or R channel or signal comprising the pan point values [A0/D25/C50/E75/B100] of a stereophonic audio, and convert this magnetic field into a first electric current with its corresponding information;
b. the second coil is a generating coil that is configured to receive and capture a magnetic field obtained from a pre-treated electric current corresponding to the channel or signal LEFT or L at 180° comprising the values of panning points [−A100/−D75/−C50/−E25/−B0] of a stereophonic audio, and convert this magnetic field into a second electric current with its corresponding information; and
c. the third coil is a crashing coil which is configured to circulate the third electric current resulting from the electrical collision between the first electric current and the second electric current, and convert the third electric current into a resulting magnetic field Y2 comprising the values of pan points [−A100/−D50/E50/B100], where the resulting magnetic field Y2 corresponds to one of the signals of a trisonic audio.

56. The method according to claim 53, where said at least one coil subsystem is a third coil subsystem where:
a. the first coil is a generating coil that is configured to receive and capture a magnetic field obtained from a pre-treated electric current corresponding to the LEFT or L channel or signal comprising the pan point values [A100/D75/C50/E25/B0] of a stereophonic audio, and convert this magnetic field into a first electric current with its corresponding information;
b. the second coil is a generating coil that is configured to receive and capture a magnetic field obtained from a pre-treated electric current corresponding to the RIGHT or R channel or signal comprising the pan point values [A0/D25/C50/E75/B100] of a stereophonic audio, and convert this magnetic field into a second electric current with its corresponding information; and
c. the third coil is a crashing coil which is configured to circulate the third electric current resulting from the electrical collision between the first electric current and the second electric current, and convert the third electric current into a resulting magnetic field Z2 comprising the values of pan points [A100/D100/C100/E100/B100], where the resulting magnetic field Z2 corresponds to one of the signals of a trisonic audio.

57. The method according to claim 53, where at least one coil subsystem is a fourth coil subsystem where:
a. the first coil is a generating coil that is configured to receive and capture a magnetic field obtained from a pre-treated electric current corresponding to the LEFT or L channel or signal comprising the pan point values [A100/D75/C50/E25/B0] of a stereophonic audio, and convert that magnetic field into a first electric current with its corresponding information;
b. the second coil is a generating coil that is configured to receive and capture a magnetic field obtained from a pre-treated electric current corresponding to channel or signal X2 comprising the pan point values [A100/D50/−E50/−B100] of a trisonic audio, and convert this magnetic field into a second electric current with its corresponding information; and
c. the third coil is a crashing coil which is configured to circulate the third electric current resulting from the electrical collision between the first electric current and the second electric current, and convert the third electric current into a resulting magnetic field X3 comprising the values of panning points [A200/D125/C50/−E25/−B100], where the resulting magnetic field X3 corresponds to one of the signals of a trisonic audio.

58. The method according to claim 53, where said at least one coil subsystem is a fifth coil subsystem where:
a. the first coil is a generating coil that is configured to receive and capture a magnetic field obtained from a pre-treated electric current corresponding to the RIGHT or R channel or signal comprising the pan point values [A0/D25/C50/E75/B100] of a stereophonic audio, and convert that magnetic field into a first electric current with its corresponding information;
b. the second coil is a generating coil that is configured to receive and capture a magnetic field obtained from a pre-treated electric current corresponding to the channel or signal Y2 comprising the values of panning points [−A100/−D50/E50/B100] of a trisonic audio, and convert this magnetic field into a second electric current with its corresponding information; and
c. the third coil is a crashing coil which is configured to circulate the third electric current resulting from the electrical collision between the first electric current and the second electric current, and convert the third electric current into a resulting magnetic field Y3 comprising the values of panning points [−A100/−D25/C50/E125/B200], where the resulting magnetic field Y3 corresponds to one of the signals of a trisonic audio.

59. The method according to claim 53, where said at least one coil subsystem is a sixth coil subsystem where:
a. the first coil is a generating coil that is configured to receive a magnetic field obtained from a pre-treated electric current corresponding to the channel or signal X3 comprising the pan point values [A200/D125/C50/−E25/−B100] of a trisonic audio, and convert this magnetic field into a first electric current with its corresponding information;
b. the second coil is a generating coil that is configured to receive and capture a magnetic field obtained from a pre-treated electric current corresponding to channel or signal Y3 comprising the pan point values [−A100/−D25/C50/E125/B200] of a trisonic audio, and convert this magnetic field into a second electric current with its corresponding information; and
c. the third coil is a crashing coil which is configured to circulate the third electric current resulting from the electrical collision between the first electric current and the second electric current, and convert the third electric current into a resulting magnetic field Z3 comprising the values of pan points [A100/D100/C100/E100/B100], where the resulting magnetic field Z3 corresponds to one of the signals of a trisonic audio.

60. The collision system according to claim 1, wherein each coil subsystem comprises from three y to “n” number of coils configured to generate from one y to “n” number of collisions generating from one and to “n” number of channels or signals of a trisonic audio.

61. The collision system according to claim 1, where such a collision system can be applied simultaneously from one to “n” times to receive input signals, in pairs, from a multi-channel audio.
